(19) United States
(12) Patent Application Publication
(10) Pub. No.: US 2011/0181740 A1
(43) Pub. Date: Jul. 28, 2011

(54) IMAGE BLUR CORRECTION DEVICE, IMAGING LENS UNIT, AND CAMERA UNIT

(76) Inventors: Hiroyuki Watanabe, Tokyo (JP); Agnieszka Kurabe, Tokyo (JP)

(21) Appl. No.: 13/121,548

(22) PCT Filed: Sep. 28, 2009
(86) PCT No.: PCT/JP2009/066726

§ 371 Date: Mar. 29, 2011

(30) Foreign Application Priority Data
Sep. 30, 2008 (JP) 2008-255362
Nov. 28, 2008 (JP) 2008-305590
Nov. 28, 2008 (JP) 2008-305614
Jun. 30, 2009 (JP) 2009-155329

(51) Int. Cl. H04N 5/228

(52) U.S. Cl. 348/208.2; 348/E05.031

(57) ABSTRACT

An image blur correction device according to the present invention includes an a base (100), a movable holding member (120), a support mechanism configured to movably support the movable holding member within a plane vertical to an optical axis of the lens, a driving means for driving the movable holding member within the plane, a position detecting means, and a return means for returning the movable holding member to a pause position in a pause state, the driving means includes a drive magnet (131, 141) fixed to one of the base and the movable holding member and a coil (132, 142) fixed to the other of the base and the movable holding member at a position where the coil faces the drive magnet, and the return means includes a return member (171, 172) consisting of a magnetic material or a magnet fixed to the other of the base and the movable holding member so as to face the drive magnet to form a magnetic force flow for returning to the pause position. As a result, simplification of the structure and a reduction in size and thickness of the device can be achieved, and a lens for correction can be automatically centered.

### TECHNICAL FIELD

The present invention relates to an image blur correction device (image stabilization device) mounted in, e.g., a lens body tube or a shutter unit in a digital camera, and to an imaging lens unit and a camera unit including this image blur correction device, and more particularly to a small and thin image blur correction device applied to a camera unit mounted in a personal digital assistance such as a mobile phone, and to an imaging lens unit and a camera unit.

### BACKGROUND ART

As a conventional image blur correction device (image stabilization device), there is known an image blur correction device including: a substantially rectangular base having an opening portion at the center; a first guide shaft provided on a front surface of the base; a first movable member supported to be reciprocable along the first guide shaft; a second guide shaft directed to a 90-degree direction with respect to the first guide shaft and provided on a front surface of the first movable member; a second movable member supported to be reciprocable along the second guide shaft and configured to hold a lens; a first drive device configured to reciprocate the first movable member and the second movable member together in a direction of the first guide shaft; and a second drive device configured to reciprocate the second movable member in a direction of the second guide shaft, the image blur correction device adopting a voice coil motor including a coil and a magnet as each of the first drive device and the second drive device (see, e.g., Patent Document 1: Japanese Unexamined Patent Application Publication No. 2007-286318, Patent Document 2: Specification in U.S. Patent Application Laid-open Disclosure No. US2007/0242938A1, and others).

However, this device adopts a double configuration that the first movable member and the second movable member are aligned in an optical axis direction, thus leading to an increase in size of the device in the optical axis direction. Further, although the second drive device drives the second movable member alone, the first drive device must drive not only the first movable member but also the second movable member and the second guide shaft at the same time, larger drive force must be generated as compared with a situation where the first movable member alone is driven, thereby resulting in an increase in size of the first drive device. Furthermore, since a drive load of the first drive device is different from a drive load of the second drive device, drive control for positioning the lens within a plane vertical to the optical axis is not easy.

Moreover, as another image blur correction device (image stabilization device), there is known an image blur correction device including: a substantially rectangular base having an opening portion; four elastic support members (wires) that are implanted in four corners of a front surface of the base and extend in an optical axis direction; a movable member coupled with ends of the four elastic support member to hold a lens; a first magnet and a first yoke provided to a movable member; a second magnet and a second yoke provided to the movable member; and a substantially rectangular fixed frame that is fixed to a member different from the base and arranged in front of the movable member to hold a first coil and a second coil, the first magnet, the first yoke, and the first coil constituting first driving means, the second magnet, the second yoke, and the second coil constituting second driving means, the first driving means being configured to drive the movable member in a first direction vertical to the optical axis, the second driving means being configured to drive the movable member in a second direction vertical to the optical axis and the first direction (see, e.g., Patent Document 3: Japanese Unexamined Patent Application Publication No. 2008-64846).

However, in this device, since the movable member is supported on the base by using the four elastic support members (the wires) extending in the optical axis direction and the fixed frame configured to hold the coils is supported in front of the movable member by the other member, the size of the device increases in the optical axis direction, and coupling portions of the four elastic support members are coupled rigidly rather than coupled in a link state, whereby the movable member (the lens) may be possibly not only moved in a plane direction vertical to the optical axis but also inclined with respect to the optical axis.

Additionally, although the base is coupled with the movable member, since the fixed frame holding the coils is not integrally coupled, the image blur correction device cannot be configured as a module, its handling is inconvenient, the first magnet and the second magnet of the movable member and the first coil and the second coil of the fixed frame cannot be positioned, respectively, with one member (e.g., the base) being determined as a reference, and assembling the device is troublesome. Further, since (the first magnet and the first yoke of) the first driving means and (the second magnet and the second yoke of) the second driving means are arranged on one side of the movable member alone with respect to the lens, the first driving means and the second driving means exercise drive force to one side of the movable member alone rather than both sides of the lens in a symmetric manner, and they tend to facilitate inclination of the movable member, i.e., inclination of the lens.

Furthermore, as still another image blur correction device (image stabilization device), there is known an image blur correction device including: a base; a movable member that holds a lens; three balls and coil springs as a support mechanism that supports the movable member to be movable with respect to the base; a driving means (a driving magnet, a coil, and a yoke) for driving the movable member in a direction vertical to an optical axis; a position detecting means (a magnet, and a hall element) for detecting a position of the movable member; a sensor base fixed to face the base so as to sandwich the movable member, wherein the driving magnet is provided to the base, the coil and the detection magnet are provided to the movable member, and the hall element is provided to the sensor base (see, e.g., Patent Document 4: Japanese Patent Publication No. 3969927 and Patent Document 5: Japanese Patent Publication No. 400178).

In this device, the three rolling balls are interposed between the movable member and the base, the coil springs exercise urging force so that the movable member can come into contact with the three balls to be constantly supported, the urging force of the coil springs function as resistance force, i.e., drive loads when driving the movable member, and hence the driving means must generate drive force competitive with the urging force of the coil springs. Moreover, the coil is fixed on one surface of the movable member, the detection magnet is fixed to the other surface of the movable member, and the yoke and the detection magnet are aligned in the optical axis direction of the lens. Therefore, a dimension of the movable body (the movable member having the coil and the detection magnet) increases in the optical axis direction, a thickness of the device in the optical axis direction increases, and reducing size and thickness of the device is difficult. It is to be noted that, when the detection magnet is arranged around the coil to suppress the increase in thickness in the optical axis direction, a diameter of the device in the direction vertical to the optical axis increases, and reducing the size of the device is likewise difficult.

Additionally, as yet another image blur correction device (image stabilization device), there is known an image blur correction device including: a base; a movable member holding a lens; a first driving means (a magnet, a coil, and a yoke) and a second driving means (a magnet, a coil, and a yoke) for driving the movable member in two directions vertical to an optical axis; two assist springs configured to return (perform centering) the movable member to a central position in a non-energized state (a pause state) that the coil is not energized; and others (see, e.g., Japanese Patent Publication No. 3869926).

In this device, since the assist springs are adopted as a return means for returning the movable member to the central position, arrangement spaces for the assist springs are required, thus resulting in an increase in diameter of the device.
Patent Document 1: Japanese Unexamined Patent Application Publication No. 2007-286318
Patent Document 2: Specification in U.S. Patent Application Laid-open Disclosure No. US2007/0242938A1
Patent Document 3: Japanese Unexamined Patent Application Publication No. 2008-64846
Patent Document 4: Japanese Patent Publication No. 3969927
Patent Document 5: Japanese Patent Publication No. 4006178
Patent Document 6: Japanese Patent Publication No. 3869926

### DISCLOSURE OF INVENTION

### Problem to be Solved by the Invention

In view of the above-described problems, it is an object of the present invention to provide an image blur correction device (image stabilization device) that can be mounted in a camera unit of, e.g., a mobile phone while achieving, e.g., simplification of the structure or a reduction in size and thickness of the device in an optical axis direction of a lens and a direction vertical to the optical axis direction, highly accurately correcting an image blur caused due to hand movement and others, preventing disconnection of electric connection wiring lines and others, and automatically returning (performing centering) a correction lens to a predetermined central position in a pause state, and to provide an imaging lens unit and a camera unit provided with this image blur correction device.

### Means for Solving Problem

An image blur correction device according to the present invention includes: a base having an opening portion; a movable holding member configured to hold a lens; a support mechanism configured to movably support the movable holding member within a plane vertical to an optical axis of the lens; a driving means for driving the movable holding member within a plane vertical to the optical axis; a position detecting means for detecting a position of the movable holding member; and a return means for returning the movable holding member to a predetermined pause position in a pause state, wherein the driving means includes: a drive magnet fixed to one of the base and the movable holding member; and a coil fixed to the other of the base and the movable holding member at a position where the coil faces the drive magnet, and the return means includes a return member that faces the drive magnet and consists of a magnetic material or a magnet fixed to the other of the base and the movable holding member to form a magnetic force flow for returning to the pause position.

According to this configuration, the movable holding member is movably supported by the support mechanism, and it is two-dimensionally moved within the plane vertical to the optical axis with respect to the base in this state by drive force generated by energization of the coil in cooperation with the driving magnet, thereby highly accurately correcting an image blur caused due to, e.g., hand movement. Here, in the pause state (a state that the coil is not energized), the movable holding member (the lens) is automatically returned (e.g., centered) to and stably held at the predetermined pause position (e.g., a position at which the optical axis of the lens coincides with the center of the opening portion of the base) by a magnetic attractive function between the return member of the return means and the drive magnet of the driving means. Therefore, drive control such as initialization is not required at the time of driving, and wobble and others of the movable holding member can be avoided in the pause state. Since the drive magnet of the driving means also serves as the magnet that produces a magnetic mutual function with the return member (the magnetic material or the magnet) as described above, simplification of the structure, a reduction in size of the device, and others can be achieved.

In the above-described configuration, it is possible to adopt a configuration that the return member is a return magnet that faces the drive magnet and generates magnetic force for returning to the pause position, and the position detecting means includes a magnetic sensor fixed to one of the base and the movable holding member at a position where the magnetic sensor faces the return magnet.

According to this configuration, since the magnetic sensor is fixed to one of the base and the movable holding member and the return magnet also functions to detect a position, simplification of the structure, a reduction in number of components and in size of the device, and others can be achieved as compared with an example where a dedicated magnet is provided. Further, when the magnetic sensor is directly fixed to the base or indirectly fixed to the base through a different member such as a cover member that is coupled and fixed to the base, wiring is easier than that in a case where the magnetic sensor is provided to the movable holding member, and disconnection and the like involved by movement can be avoided.

In the above-described configuration, it is possible to adopt a configuration that the drive magnet includes a driving part facing the coil and a holding part that is formed with a thickness smaller than that of the driving part and faces the return magnet.

According to this configuration, since a step is provided to the drive magnet to form the driving part requiring large magnetic force and a holding part requiring optimum attractive force in a return function without producing excessive resistance force at the time of driving, the movable holding member can be more smoothly driven, and the movable holding member can be smoothly positioned and held at the predetermined pause position at the time of pausing.

In the above-described configuration, it is possible to adopt a configuration that a thin plate-like yoke is arranged on a surface of the holding part of the drive magnet on a side where the drive magnet faces the return magnet.

According to this configuration, the magnetic attractive force between the return magnet and the holding part of the drive magnet can be adjusted, thus finely adjusting a mutual relationship between the drive force and the holding force.

In the above-described configuration, it is possible to adopt a configuration that the driving means includes: a first drive mechanism configured to drive the movable holding member in a first direction within the plane vertical to the optical axis; and a second drive mechanism, configured to drive the movable holding member in a second direction within the plane vertical to the optical axis, the first drive mechanism includes: a first drive magnet fixed to the base; and a first coil fixed to the movable holding member at a position where the first coil faces the first drive magnet, the second drive mechanism includes: a second drive magnet fixed to the base; and a second coil fixed to the movable holing member at a position where the second coil faces the second drive magnet, the return magnet includes: a first return magnet that faces the first drive magnet and is fixed to the movable holding member to generate magnetic force for returning to the pause position; and a second return magnet that faces the second drive magnet and is fixed to the movable holding member to generate magnetic force for returning to the pause position, and the magnetic sensor includes: a first magnetic sensor fixed to the base at a position where it faces the first return magnet; and a second magnetic sensor fixed to the base at a position where it faces the second return magnet.

According to this configuration, the movable holding member can be moved within the plane vertical to the optical axis by the first drive mechanism (the first drive magnet, the first coil) and the second drive mechanism (the second drive magnet, the second coil), and the movable holding member can be more smoothly positioned and held at the predetermined pause position by the magnetic attractive function of the first return magnet and the first drive magnet and the magnetic attractive function of the second return magnet and the second drive magnet.

In the above-described configuration, it is possible to adopt a configuration that the return member is arranged in such a manner that its center substantially coincides with the center of the drive magnet as seen from the optical axis direction when the movable holding member is placed at the pause position.

According to this configuration, since the center of the return member is arranged to substantially coincide with the center of the drive magnet as seen from the optical axis direction when the movable holding member is present at the pause position, the return member and the drive magnet can face each other at well balanced positions, the strong magnetic attractive function can be obtained between the return member and the drive magnet, and the movable holding member (the lens) is automatically returned (e.g., centered) to and stably held at the predetermined pause position (e.g., a position at which the optical axis of the lens coincides with the center of the opening portion of the base).

In the above-described configuration, it is possible to adopt a configuration that the return member is arranged to face the drive magnet to interpose the coil therebetween.

According to this configuration, the electromagnetic drive force produced between the drive magnet and the coil can be efficiently generated, and the size of the device can be reduced in the planar direction vertical to the optical axis.

In the above-described configuration (i.e., the configuration that the center of the return member substantially coincides with the center of the drive magnet as seen from the optical axis direction), it is possible to adopt a configuration that the return member is a return magnet that faces the drive magnet and generates magnetic force for returning to the pause position, and the position detecting means includes a magnetic sensor fixed to one of the base and the movable holding member at a position where the position detecting means faces the return magnet.

According to this configuration, since the return magnet also functions to detect a position in cooperation with the magnetic sensor, the structure can be simplified and a reduction in number of components or in size of the device can be achieved as compared with an example where a dedicated magnet is provided, and wiring is easier than that in an example where the magnetic sensor is provided to the movable holding member if the magnetic sensor is directly fixed to the base or indirectly fixed through a different member, e.g., the cover frame that is coupled and fixed to the fixed frame as the base, thereby avoiding, e.g., disconnection involved by movement.

In the above-described configuration, it is possible to adopt a configuration that the coil is formed into a substantially elliptic annular shape having a major axis and a minor axis as seen from the optical axis direction, and the return magnet is formed into a substantially rectangular shape having a wide side and a narrow side as seen from the optical axis direction and arranged in such a manner that the wide side becomes substantially parallel to the major axis of the coil.

According to this configuration, since the coil and the return magnet are aligned to extend in the same direction, force that prevents the movable holding member from rotating on the optical axis is exercised by the mutual function of the magnetic force of the return magnet and the magnetic force of the drive magnet at the time of driving (at the time of energizing the coil), a large moment that suppresses the rotation of the movable holding member can be obtained by forming the return magnet so as to have wide sides in a direction of a magnetizing border, and the movable holding member can be rapidly moved within the plane vertical to the optical axis and highly accurately positioned at a desired position.

In the above-described configuration, it is possible to adopt a configuration that the movable holding member is formed to define a cylindrical portion that holds the lens and two extending portions that extend from both sides with a predetermined width to sandwich the cylindrical portion, the coil is arranged in such a manner that the major axis forms an inclination angle of approximately 45 degrees with respect to an alignment direction of the cylindrical portion and the extending portions, and the return magnet is arranged in such a manner that the wide side forms an inclination angle of approximately 45 degrees with respect to the alignment direction of the cylindrical portion and the extending portions.

According to this configuration, since desired drive force can be assured while achieving a reduction in width and size of the device, an image blur caused due to hand movement and the like can be highly accurately corrected, and the device can be easily mounted in a camera unit of, e.g., a small mobile phone.

In the above-described configuration, it is possible to adopt a configuration that the driving means includes: a first drive mechanism configured to drive the movable holding member in a first direction within the plane vertical to the optical axis; and a second drive mechanism configured to drive the movable holding member in a second direction within the plane vertical to the optical axis, the first drive mechanism includes: a first drive magnet fixed to the base; and a first coil fixed to the movable holding member at a position where the first coil faces the first drive magnet, the second drive mechanism includes: a second drive magnet fixed to the base; and a second coil fixed to the movable holding member at a position where the second coil faces the second drive magnet, the return magnet includes: a first return magnet arranged in such a manner that its center substantially coincides with the center of the first drive magnet as seen from the optical axis direction; and a second return magnet arranged in such a manner that its center substantially coincides with the center of the second drive magnet as seen from the optical axis direction, and the magnetic sensor includes: a first magnetic sensor fixed to the base at a position where it faces the first return magnet; and a second magnetic sensor fixed to the base at a position where it faces the second return magnet.

According to this configuration, the movable holding member can be moved within the plane vertical to the optical axis by the first drive mechanism (the first drive magnet, the first coil) and the second drive mechanism (the second drive magnet, the second coil), and the movable holding member can be smoothly returned to, positioned, and held at the predetermined pause position by magnetic attractive and repulsive functions of the first return magnet and the first drive magnet and magnetic attractive and repulsive functions of the second return magnet and the second drive magnet.

In the above-described configuration, it is possible to adopt a configuration that the support mechanism includes: a plurality of convex portions provided to one of the base and the movable holding member; and a plurality of abutting surfaces that are provided to the other of the base and the movable holding member and abut on the convex portions.

According to this configuration, since the magnetic attractive force functions between the drive magnet and the return member, a plurality of convex portions and a plurality of abutting surface are closely held in the optical axis direction. That is, the movable holding member is movably supported within the plane vertical to the optical axis with respect to the base without being separated from the base by the simple support mechanism consisting of the plurality of convex portions and the plurality of abutting surfaces. As a result, simplification of the structure and a reduction in size of the device can be achieved.

In the above-described configuration, it is possible to adopt a configuration that the coil is fixed to the base, the drive magnet is fixed to the movable holding member at a position where it faces the coil, and the return member is arranged to face the drive magnet to interpose the coil therebetween and fixed to the base.

According to this configuration, since the coil that must be electrically wired is fixed to the base (that is immovable and does not move in the planar direction vertical to the optical axis), disconnection and others of the connection wiring line can be avoided, the magnetic attractive function can be obtained between the return member and the drive magnet, and the movable holding member (the lens) is automatically returned (e.g., centered) to and stably held at the predetermined pause position (e.g., a position at which the optical axis of the lens coincides with the center of the opening portion of the base). Further, since the return member is arranged to face the drive magnet with the coil interposed therebetween, the size of the device can be reduced in the planar direction vertical to the optical axis.

In the above-described configuration, it is possible to adopt a configuration that the position detecting means includes a magnetic sensor fixed to the base to face the drive magnet.

According to this configuration, since the magnetic sensor is fixed to the base, wiring is easier than that in a situation where the magnetic sensor is provided to the movable holding member, disconnection and others involved by movement can be avoided, and simplification of the structure, a reduction in number of components and in size of the device, and others can be achieved as compared with a situation where a dedicated magnet is provided because the drive magnet also functions to detect a position.

In the above-described configuration, it is possible to adopt a configuration that includes a flexible wiring board electrically connected to the coil and the magnetic sensor, wherein the flexible wiring board is arranged to be adjacent to the base on an opposite side of a side facing the movable holding member.

According to this configuration, since the flexible wiring board does not have to be moved in the planar direction vertical to the optical axis, i.e., the flexible wiring board does not have to be bent and arranged in the planar direction along which the movable holding member moves when the flexible wiring board is fixed to the base, an arrangement space can be narrowed, a size of the device can be reduced, and durability can be improved.

In the above-described configuration, it is possible to adopt a configuration that the driving means includes a plate-like yoke adjacently arranged to bend and fix the flexible wiring board.

According to this configuration, since magnetic efficiency can be improved in the magnetic circuit and the flexible wiring board can be bent and disposed by using the yoke, a dedicated attaching member is no longer required, and the flexible wiring board can be assuredly fixed while reducing the number of components.

In the above-described configuration, it is possible to adopt a configuration that the driving means includes: a first drive mechanism configured to drive the movable holding member in a first direction within the plane vertical to the optical axis; and a second drive mechanism configured to drive the movable holding member in a second direction within the plane vertical to the optical axis, the coil includes: a first coil included in the first drive mechanism; and a second coil included in the second drive mechanism, the drive magnet includes: a first drive magnet that is included in the first drive mechanism and faces the first coil; and a second drive magnet that is included in the second drive mechanism and faces the second coil, the return member includes: a first return magnet facing the first drive magnet; and a second return magnet facing the second drive magnet, and the magnetic sensor includes: a first magnetic sensor facing the first drive magnet; and a second magnetic sensor facing the second drive magnet.

According to this configuration, the movable holding member can be moved within the plane vertical to the optical axis by the first drive mechanism (the first drive magnet, the first coil) and the second drive mechanism (the second drive magnet, the second coil), and the movable holding member can be returned to, positioned, and held at the predetermined pause position by the magnetic attractive function of the first return magnet and the first drive magnet and the magnetic attractive function of the second return magnet and the second drive magnet.

In the above-described configuration, it is possible to adopt a configuration that the coil is formed into an annular shape to define an air core portion, and the return member is arranged in the air core portion of the coil.

According to this configuration, since the drive magnet of the driving means is also used as the magnet that magnetically and mutually functions with the return member and the return member is arranged in the air core portion of the coil, the structure can be simplified, the components can be put together, and the device can be reduced in thickness in the optical axis direction and reduced in size.

In the above-described configuration, it is possible to adopt a configuration that the driving means includes: a first drive mechanism configured to drive the movable holding member in a first direction within the plane vertical to the optical axis; and a second drive mechanism configured to drive the movable holding member in a second direction within the plane vertical to the optical axis, the coil includes: a first coil included in the first drive mechanism; and a second coil included in the second drive mechanism, the drive magnet includes: a first drive magnet that is included in the first drive mechanism and faces the first coil; and a second drive magnet that is included in the second drive mechanism and faces the second coil, and the return member includes: a first return magnet arranged in an air core portion of the first coil; and a second return magnet arranged in an air core portion of the second coil.

According to this configuration, the movable holding member can be moved within the plane vertical to the optical axis by the first drive mechanism (the first drive magnet, the first coil) and the second drive mechanism (the second drive magnet, the second coil), and the movable holding member can be returned to, positioned, and held at the predetermined pause position by the magnetic attractive function of the first return magnet and the first drive magnet and the magnetic attractive function of the second return magnet and the second drive magnet.

In the above-described configuration, it is possible to adopt a configuration that the position detecting means includes a magnetic sensor configured to output a position detection signal by relative movement between itself and a magnet, the magnetic sensor includes: a first magnetic sensor fixed to the base or the movable holding member to face the first drive magnet or the first return magnet; and a second magnetic sensor fixed to the base or the movable holding member to face the second drive magnet or the second return magnet.

According to this configuration, in a state where the first drive magnet and the second drive magnet are fixed to the movable holding member (or the base) and the first return magnet and the second return magnet are fixed to the base (or the movable holding member), the position detection signal is output based on relative movement between themselves and the first drive magnet and the second drive magnet when the first magnetic sensor and the second magnetic sensor are fixed to the base (or the movable holding member) and, on the other hand, the position detection signal is output based on relative movement between themselves and the first return magnet and the second return magnet when the first magnetic sensor and the second magnetic sensor are fixed to the movable holding member (or the base).

Here, since the drive magnet or the return magnet also functions as the magnet that cooperates with the magnetic sensor, simplification of the structure, a reduction in number of components and in size of the device, and others can be achieved as compared with a situation where the dedicated magnet for detection is provided.

In the above-described configuration, it is possible to adopt a configuration that the first coil and the first return magnet are formed to extend in a direction vertical to the first direction within the plane vertical to the optical axis, and the second coil and the second return magnet are formed to extend in a direction vertical to the second direction within the plane vertical to the optical axis.

According to this configuration, rotation of the movable holding member within the plane vertical to the optical axis (on the optical axis) can be regulated, and an image blur caused due to hand movement and others can be highly accurately corrected.

An imaging lens unit according to the present invention including a plurality lenses for imaging, wherein the imaging lens unit includes any one of the image blur correction devices having the above-described configurations.

According to this configuration, in the configuration that the plurality of imaging lenses are arranged in the optical axis direction, the correction lens held by the movable holding member is appropriately driven when the image blur correction device is included, thus smoothly and highly accurately correcting an image blur caused due to hand movement and others.

That is, the imaging lens unit having the image blur correcting function in addition to the plurality of imaging lenses can be provided.

A camera unit according to the present invention including an imaging element, wherein the camera unit includes any one of the image blur correction devices having the above-described configurations.

According to this configuration, in the camera unit including the imaging element, when the image blur correction device is included, the correction lens held by the movable holding member is appropriately driven, an image blur caused due to hand movement and the like can be smoothly and highly accurately corrected, and an excellent shot image can be acquired by the imaging element.

### Advantageous Effect of the Invention

According to the image blur correction device having the above configuration, it is possible to obtain the image blur correction device that can be mounted in the camera unit of, e.g., a mobile phone while achieving a reduction in thickness and in size of the device in the optical axis direction of the lens and the direction vertical to the optical axis, highly accurately correcting an image blur caused due to hand movement and the like, avoiding disconnection and others of the electrical connection wiring lines, and automatically returning (centering) the correction lens to the predetermined pause position in the pause state, and also possible to obtain the imaging lens unit and the camera unit including this image blur correction device.

### BRIEF DESCRIPTION OF DRAWINGS

FIG. 1 is a perspective view showing a personal digital assistance in which a camera unit having an image blur correction device according to the present invention incorporated therein is mounted;

FIG. 2 is a perspective view showing a camera unit including an image blur correction device according to a first embodiment of the present invention;

FIG. 3 is a system chart of the camera unit;

FIG. 4 is a cross-sectional view of the camera unit;

FIG. 5 is a perspective view of the image blur correction device;

FIG. 6 is an exploded perspective view of the image blur correction device;

FIG. 7 is a cross-sectional view of the image blur correction device;

FIG. 8 is a perspective view showing a part (a movable holding member, a first guide shaft, and a cylindrical member) of the image blur correction device;

FIG. 9 is a plan view of the image blur correction device;

FIG. 10A is a partial cross-sectional view of the image blur correction device taken along E1-E1 in FIG. 9;

FIG. 10B is a partial cross-sectional view of the image blur correction device taken along E2-E2 in FIG. 9;

FIG. 10C is a partial cross-sectional view of the image blur correction device taken along E3-E3 in FIG. 9;

FIG. 11 is a plan view in which a part (a cover member and a flexible wiring board) of the image blur correction device is omitted;

FIG. 12 is a schematic view showing a magnetic circuit (flows of magnetic field lines) in the image blur correction device;

FIG. 13A is a plan view for explaining an operation of the image blur correction device;

FIG. 13B is a plan view for explaining an operation of the image blur correction device;

FIG. 13C is a plan view for explaining an operation of the image blur correction device;

FIG. 14A is a plan view for explaining an operation of the image blur correction device;

FIG. 14B is a plan view for explaining an operation of the image blur correction device;

FIG. 14C is a plan view for explaining an operation of the image blur correction device;

FIG. 15 is a plan view showing a modification of the image blur correction device;

FIG. 16A is a partial cross-sectional view of the image blur correction device taken along E1-E1 in FIG. 15;

FIG. 16B is a partial cross-sectional view of the image blur correction device taken along E2-E2 in FIG. 15;

FIG. 16C is a partial cross-sectional view of the image blur correction device taken along E3-E3 in FIG. 15;

FIG. 17 is a plan view showing a modification of the image blur correction device;

FIG. 18A is a partial cross-sectional view of the image blur correction device taken along E1-E1 in FIG. 17;

FIG. 18B is a partial cross-sectional view of the image blur correction device taken along E2-E2 in FIG. 17;

FIG. 18C is a partial cross-sectional view of the image blur correction device taken along E3-E3 in FIG. 17;

FIG. 19 is a perspective view showing a camera unit including an image blur correction device according to a second embodiment of the present invention;

FIG. 20 is a cross-sectional view showing the inside of the camera unit depicted in FIG. 19;

FIG. 21 is a block diagram showing a control system of the image blur correction device depicted in FIG. 19;

FIG. 22 is a cross-sectional view of the camera unit depicted in FIG. 19;

FIG. 23 is a perspective view of the image blur correction device depicted in FIG. 19;

FIG. 24 is an exploded perspective view of the image blur correction device depicted in FIG. 19;

FIG. 25 is a cross-sectional view of the image blur correction device depicted in FIG. 19;

FIG. 26 is a partially enlarged cross-sectional view of the image blur correction device depicted in FIG. 25;

FIG. 27 is a perspective view showing a part (a movable holding member and others) of the image blur correction device depicted in FIG. 19;

FIG. 28 is a front view showing a part (the movable holding member and others) of the image blur correction device depicted in FIG. 19;

FIG. 29 is a rear view showing a part (the movable holding member and others) of the image blur correction device depicted in FIG. 19;

FIG. 30 is a rear view showing a part (a fixed frame and others) of the image blur correction device depicted in FIG. 19;

FIG. 31 is a plan view showing a part (the fixed frame, the movable holding member, and others) of the image blur correction device depicted in FIG. 19;

FIG. 32A is a plan view for explaining an operation of the image blur correction device depicted in FIG. 19;

FIG. 32B is a plan view for explaining an operation of the image blur correction device depicted in FIG. 19;

FIG. 32C is a plan view for explaining an operation of the image blur correction device depicted in FIG. 19;

FIG. 33A is a plan view for explaining an operation of the image blur correction device depicted in FIG. 19;

FIG. 33B is a plan view for explaining an operation of the image blur correction device depicted in FIG. 19;

FIG. 33C is a plan view for explaining an operation of the image blur correction device depicted in FIG. 19;

FIG. 34 is a perspective view showing a camera unit including an image blur correction according to a third embodiment of the present invention;

FIG. 35 is a plan view showing the inside of the camera unit depicted in FIG. 34;

FIG. 36 is a cross-sectional view of the camera unit depicted in FIG. 34;

FIG. 37 is a perspective view of the image blur correction device depicted in FIG. 34;

FIG. 38 is an exploded perspective view of the image blur correction device depicted in FIG. 34;

FIG. 39 is a cross-sectional view of the image blur correction device depicted in FIG. 34;

FIG. 40 is a perspective view showing a part (the movable holding member and others) of the image blur correction device depicted in FIG. 34;

FIG. 41 is a perspective view showing a part (the movable holding member and others) of the image blur correction device depicted in FIG. 34;

FIG. 42 is a front view showing a part (the base and others) of the image blur correction device depicted in FIG. 34;

FIG. 43 is a rear view showing a part (the base and others) of the image blur correction device depicted in FIG. 34;

FIG. 44 is a front view showing a part (the movable holding member, the base, and others) of the image blur correction device depicted in FIG. 34;

FIG. 45 is a rear view showing a part (the base, the movable holding member, and others) of the image blur correction device depicted in FIG. 34;

FIG. 46 is perspective views showing states before and after assembling when assembling a flexible wiring board and a yoke to the base of the image blur correction device depicted in FIG. 34;

FIG. 47A is a plan view for explaining an operation of the image blur correction device depicted in FIG. 34;

FIG. 47B is a plan view for explaining an operation of the image blur correction device depicted in FIG. 34;

FIG. 47C is a plan view for explaining an operation of the image blur correction device depicted in FIG. 34;

FIG. 48A is a plan view for explaining an operation of the image blur correction device depicted in FIG. 34;

FIG. 48B is a plan view for explaining an operation of the image blur correction device depicted in FIG. 34;

FIG. 48C is a plan view for explaining an operation of the image blur correction device depicted in FIG. 34;

FIG. 49 is a plan view showing the inside of a camera unit including an image blur correction device according to a fourth embodiment of the present invention;

FIG. 50 is a cross-sectional view of the camera unit depicted in FIG. 49;

FIG. 51 is a perspective view of the image blur correction device depicted in FIG. 49;

FIG. 52 is a side view of the image blur correction device depicted in FIG. 49;

FIG. 53 is a plan view of the image blur correction device depicted in FIG. 49;

FIG. 54 is an exploded perspective view of the image blur correction device depicted in FIG. 49;

FIG. 55 is an exploded perspective view showing a part of the image blur correction device depicted in FIG. 49;

FIG. 56 is a cross-sectional view of the image blur correction device depicted in FIG. 49;

FIG. 57 is a plan view showing a part (a base, a coil, a return magnet, and others) of the image blur correction device depicted in FIG. 49;

FIG. 58 is a rear view showing a part (the base, a magnetic sensor, the return magnet, and others) of the image blur correction device depicted in FIG. 49;

FIG. 59 is a front view showing a part (a movable holding member, a yoke, and others) of the image blur correction device depicted in FIG. 49;

FIG. 60 is a rear view showing a part (the movable holding member, the drive magnet, and others) of the image blur correction device depicted in FIG. 49;

FIG. 61A is a plan view for explaining an operation of the image blur correction device depicted in FIG. 49;

FIG. 61B is a plan view for explaining an operation of the image blur correction device depicted in FIG. 49;

FIG. 61C is a plan view for explaining an operation of the image blur correction device depicted in FIG. 49;

FIG. 62A is a plan view for explaining an operation of the image blur correction device depicted in FIG. 49;

FIG. 62B is a plan view for explaining an operation of the image blur correction device depicted in FIG. 49; and

FIG. 62C is a plan view for explaining an operation of the image blur correction device depicted in FIG. 49.

### EXPLANATIONS OF LETTERS OR NUMERALS

L1, L2 optical axis
P personal digital assistance
P1 housing
P2 display unit
P3 operation button
P4 imaging window
U camera unit
10 unit case
11 protruding portion
12, 13, 14, 15 holding portion
20 prism
G1, G2, G3, G4, G5, G6 lens
30 first movable lens group
31 lens holding member
32 guided portion
33 regulated portion
34 U-shaped engagement portion
40 filter
50 CCD
60 first drive unit
   61 guide shaft
62 antirotation shaft
63 lead screw
64 motor
65 nut
66 coil spring
70 second drive unit
71 guide shaft
72 antirotation shaft
73 lead screw
74 motor
75 nut
76 coil spring
80 angular velocity sensor
90 control unit
91 controller
92, 93 motor drive circuit
94 CCD drive circuit
95 drive circuit
96 position detection circuit
97 angular velocity detection circuit
M1 image blur correction device
S1, S2, S3, S4 straight line
S3′ straight line (second direction)
S4′ straight line (first direction)
100 base
101 opening portion
102, 102′, 103, 103′ fitting hole
104 guided portion
105 regulated portion
106 U-shaped engagement portion
107, 108 fitting hole
109 fixing portion
110 movable holding member
110a cylindrical portion
111 extending portion
112, 113, 114, 115 fitting hole
116 engagement portion (support mechanism)
116a long hole
116b end face
117 second engagement portion (support mechanism)
117a long hole
121 cylindrical member (support mechanism)
121a through hole
121b two end faces
122 first guide shaft (support mechanism)
123 second guide shaft (support mechanism)
130 first drive mechanism
131, 131′ first drive magnet
131a′ first driving part
131b′ first holding part
132 first coil
133, 134 first yoke
140 second drive mechanism
141, 141′ second drive magnet
141a′ second driving part
141b′ second holding part
142 second coil
143, 144 second yoke
150 flexible wiring board
151, 152, 153, 154 connecting portion
160 cover member
160a opening portion
161, 163 fitting concave portion
162, 164 fitting hole
171 first return magnet (return means, return member)
172 second return magnet (return means, return member)
181 first magnetic sensor (position detecting means)
182 second magnetic sensor (position detecting means)
191 first yoke
192 second yoke
M2 image blur correction device
B screw
200 fixed frame (base)
201 opening portion
C1 center of an opening portion of the base
202, 202′, 203, 203′ fitting hole
204 guided portion
205 regulated portion
206 U-shaped engagement portion
207 a plurality of convex portions (support mechanism)
208 positioning hole
209 fixed portion
210 cover frame (base)
210a opening portion
211, 213 fitting concave portion
212, 214 fitting hole
215 positioning pin
216 screw hole
220 movable holding member
221 extending portion
222, 223 fitting concave portion
224, 225 fitting hole
226 a plurality of abutting surfaces (support mechanism)
230 first drive mechanism (driving means)
231 first drive magnet
P1 center of the first drive magnet
232 first coil
P3 center of the first coil
233, 234 first yoke
240 second drive mechanism (driving means)
241 second drive magnet
P2 center of the second drive magnet
242 second coil
P4 center of the second coil
243, 244 second yoke
250 flexible wiring board
251, 252, 253, 254 connecting portion
261 first return magnet (return means, return member)
P5 center of the first return magnet
262 second return magnet (return means, return member)
P6 center of the second return magnet
271 first magnetic sensor (position detecting means)
272 second magnetic sensor (position detecting means)
M3 image blur correction device
300 base
300a opening portion
C1 center of an opening portion of the base
300b, 300c, 300d, 300e, 300f, 300g fitting concave portion
301 guided portion
302 regulated portion
303 U-shaped engagement portion
304 concave portion
305 coupling pin
306 screw hole
310 movable holding member
310a cylindrical portion
311 extending portion
312, 313 fitting hole
314 abutting surface
315 coupling notch portion
316 coupling long hole portion
317 positioning protrusion
320 first drive mechanism (driving means)
321 first coil
322 first drive magnet
330 second drive mechanism (driving means)
331 second coil
332 second drive magnet
341, 342 yoke
341a notch portion
341b bent portion
341c screw hole
342a opening portion
343b fitting hole
350 sphere (support mechanism)
361 first return magnet (return means, return member)
362 second return magnet (return means, return member)
371 first magnetic sensor (position detecting means)
372 second magnetic sensor (position detecting means)
380 flexible wiring board
381, 382, 383, 384 connecting portion
M4 image blur correction device
400 base
400a opening portion
C1 center of an opening portion of the base
400b, 400c, 400d, 400e fitting concave portion
401 guided portion
402 regulated portion
403 U-shaped engagement portion
404 concave portion
405 coupling piece
405a coupling hole
406 latch piece
407 screw hole
408 wall-thickness reducing hole
410 movable holding member
410a cylindrical portion
411 extending portion
412, 413, 414, 415 fitting hole
416 abutting surface
417 coupling protrusion
420 first drive mechanism (driving means)
421 first coil
421a air core portion
422 first drive magnet
423 first yoke
430 second drive mechanism (driving means)
431 second coil
431a air core portion
432 second drive magnet
433 second yoke
440 sphere (support mechanism)
451 first return magnet (return means, return member)
452 second return magnet (return means, return member)
461 first magnetic sensor (position detecting means)
462 second magnetic sensor (position detecting means)
470 flexible wiring board
471, 472 connecting portion
473 circular hole

### BEST MODE(S) FOR CARRYING OUT THE INVENTION

The best modes for carrying out the present invention will now be described hereinafter with reference to the accompanying drawings.

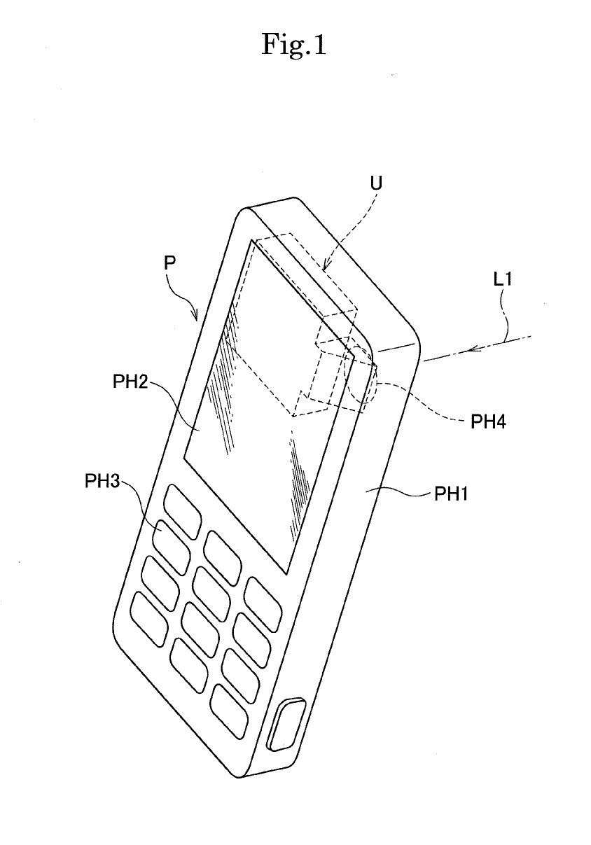

As shown in FIG. 1, a camera unit U equipped with an image blur correction device according to the present invention is mounted in a flat and small personal digital assistance P. The personal digital assistance P includes a housing P1 having a substantially rectangular and flat outline form, a display unit P2 such as a liquid crystal panel that is arranged on a surface of the housing P1 and displays various kinds of information, operation buttons P3, an imaging window P4 formed on a surface of on the opposite side of the display unit P2, and others. Further, as shown in FIG. 1, the camera unit U is accommodated in the housing P1 so as to extend in a direction vertical to an optical axis L1 of subject light that enters from the imaging window P4.

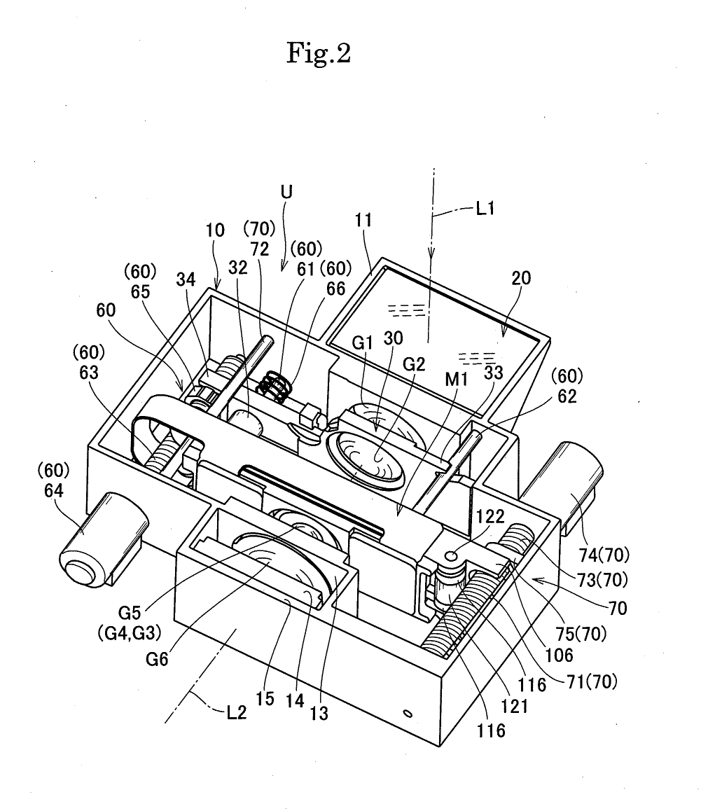

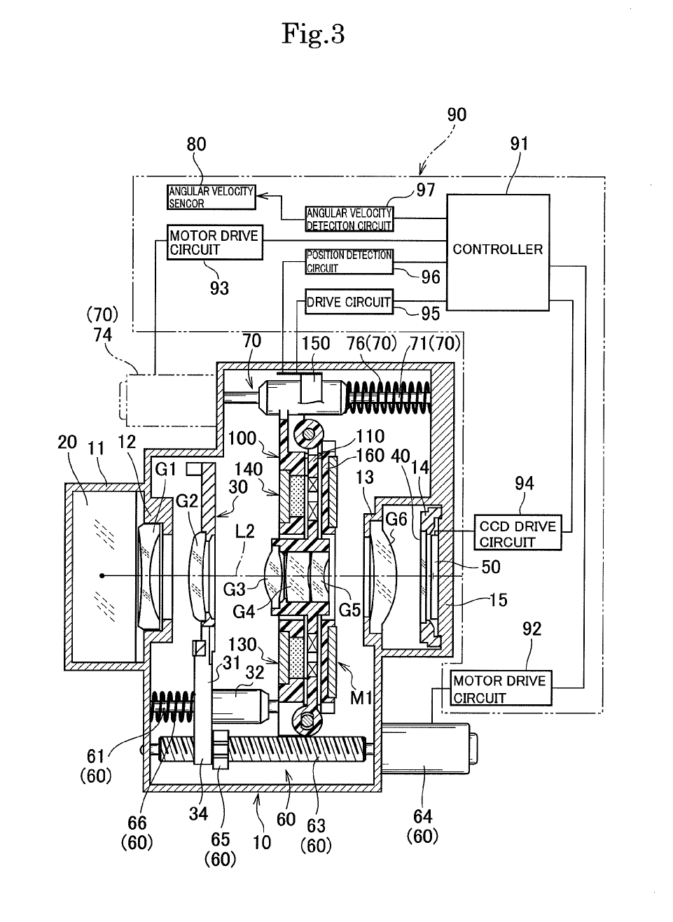

As shown in FIG. 2 and FIG. 3, the camera unit U includes a unit case 10, a prism 20, a first movable lens group 30 holding a lens G1 and a lens G2, an image blur correction device M1 as a second movable lens group holding lenses G3, G4, and G5, a lens G6, a filter 40, a CCD 50 as an imaging element, a first drive unit 60 configured to drive the first movable lens group 30 in an optical axis direction L2, a second drive unit 70 configured to drive the second movable lens group (the image blur correction device M1) in the optical axis L2 direction, an angular velocity sensor 80, a control unit 90, and others.

As shown in FIG. 2, the unit case 10 is formed into a flat and substantially rectangular shape in such a manner that a thickness dimension in the optical axis direction L1 is small and a length dimension in the optical axis direction L2 becomes small, and it includes a protruding portion 11 configured to fix the prism 20, a holding portion 12 configured to hold the lens G1, a holding portion 13 configured to hold the lens G6, a holding portion 14 configured to hold the filter 40, a holding portion 15 configured to hold the CCD 50, and others.

As shown in FIG. 2 and FIG. 3, the prism 20 is accommodated in the protruding portion 11 of the unit case and bends the optical axis L1 of the subject light entering from the imaging window P4 at a right angle to be led in the optical axis direction L2.

As shown in FIG. 2 and FIG. 3, the lens G1 is arranged at the rear of the prism 20 in the optical axis directions L1 and L2 and fixed to the holding portion 12 of the unit case 10.

As shown in FIG. 2 and FIG. 3, the first movable lens group 30 is arranged at the rear of the lens G1 in the optical axis direction L2, supported to be movable in the optical axis direction L2, and driven to reciprocate in the optical axis direction L2 by the first drive unit 60.

That is, the first movable lens group 30 includes a lens holding member 31, a guided portion 32 guided by a guide shaft 61, a regulated portion 33 that is slidably engaged with an antirotation shaft 62 to regulate its rotation on the optical axis L2, a U-shaped engagement portion 34 with which a nut 65 having a lead screw 63 screwed therein comes into contact, and others.

As shown in FIG. 2 and FIG. 3, the lens G6 is arranged at the rear of the second movable lens group (the image blur correction device M1) in the optical axis direction L2 and fixed to the holding portion 13 of the unit case 10.

The filter 40 is, e.g., an infrared cut filter or a low-pass filter, and it is arranged at the rear of the lens G6 in the optical axis direction L2 and fixed to the holding portion 14 of the unit case 10 as shown in FIG. 2 and FIG. 3.

As shown in FIG. 2 and FIG. 3, the CCD 50 is arranged at the rear of the filter 40 in the optical axis direction L2 and fixed to the holding portion 15 of the unit case 10.

As shown in FIG. 2 and FIG. 3, the first drive unit 60 includes the guide shaft 61 and the antirotation shaft 62 that extend in the optical axis direction L2 and are fixed to the unit case 10, the lead screw 63 that extends in the optical axis direction L2, a motor 64 that drives the lead screw 63 to rotate, the nut 65 that has the lead screw 63 screwed therein and comes into contact with the U-shaped engagement portion 34 of the first movable lens group 30, a coil spring 66 that exercises urging force to constantly urge the U-shaped engagement portion 34 toward the nut 64, and others.

As shown in FIG. 2 and FIG. 3, the second drive unit 70 includes a guide shaft 71 and an antirotation shaft 72 that extend in the optical axis direction L2 and are fixed to the unit case 10, a lead screw 73 that extends in the optical axis direction L2, a motor 74 that drives the lead screw 73 to rotate, a nut 75 that has the lead screw 73 screwed therein and comes into contact with a U-shaped engagement portion 106 of the base 100 included in the second movable lens group, a coil spring 76 that exercises urging force to constantly urge the U-shaped engagement portion 106 toward the nut 74, and others.

The angular velocity sensor 80 is fixed through a substrate of the unit case 10 and configured to detect vibration or movement undergone by the camera unit U.

As shown in FIG. 3, the control unit 90 is a microcomputer fixed to an outer wall of the unit case 10, and it includes a controller 91 that carries out arithmetic processing and processes various signals to generate an instruction signal, a motor drive circuit 92 that drives the motor 64 of the first drive unit 60, a motor drive circuit 93 that drives the motor 74 of the second drive unit 70, a CCD drive circuit 94 that drives the CCD 50, a drive circuit 95 that drives a first drive mechanism 130 and a second drive mechanism 140 included in the image blur correction device M1, a position detection circuit 96 connected to a first magnetic sensor 181 and a second magnetic sensor 182 configured to detect a position of the movable holding member 110 included in the image blur correction device M1, an angular velocity detection circuit 97 configured to detect vibration or movement undergone by the camera unit U through the angular velocity sensor 80, and others.

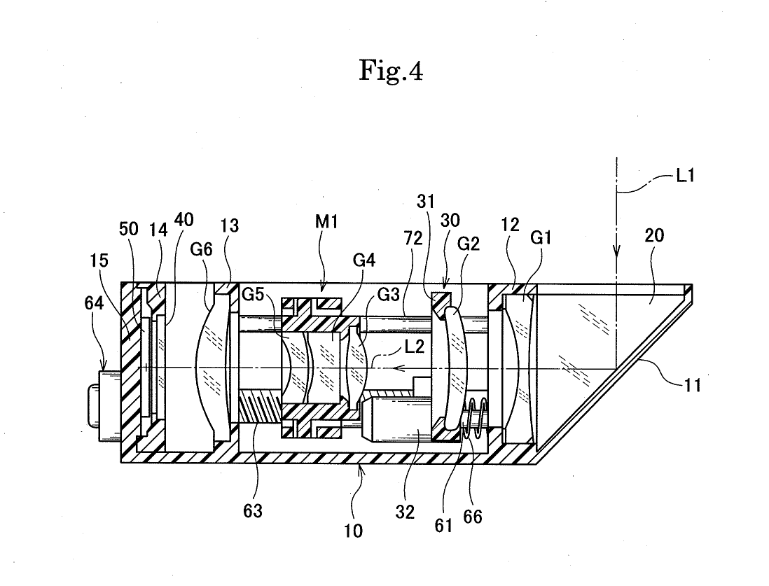

As shown in FIG. 2 to FIG. 4, the image blur correction device M1 as the second movable lens group is arranged between the first movable lens group 30 and the lens G6 in the optical axis direction L2 and supported to be movable in the optical axis direction L2.

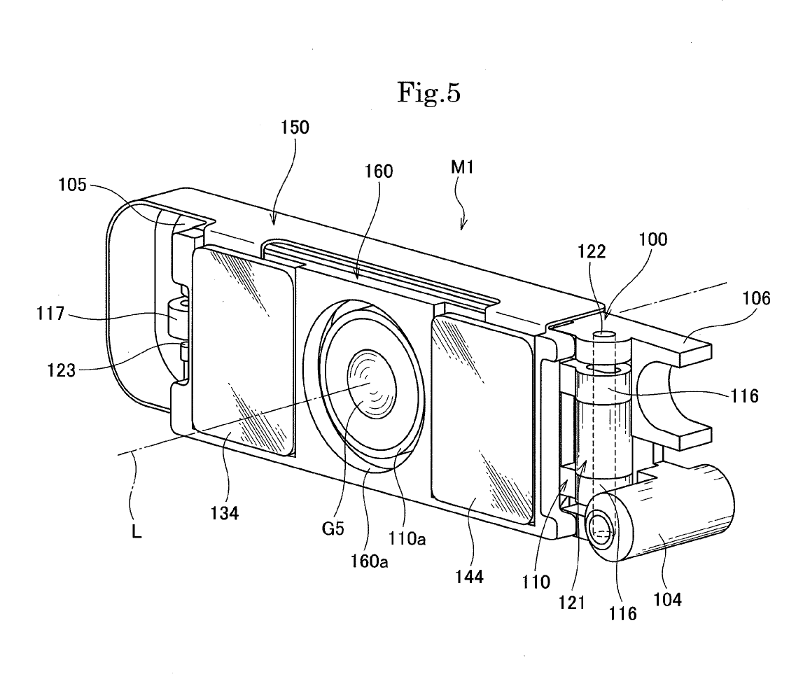

Furthermore, as shown in FIG. 5 to FIG. 7, the image blur correction device M1 includes: a base 100; a movable holding member 110; a cylindrical member 121, a first guide shaft 122, and a second guide shaft 123 as a support mechanism; the first drive mechanism 130 (including a first drive magnet 131, a first coil 132, and first yokes 133 and 134) as a driving means; the second drive mechanism 140 (including a second drive magnet 141, a second coil 142, and second yokes 143 and 144) as a driving means; a flexible wiring board 150; a cover member 160 fixed to the base 100 to function as a part of the base; a first return magnet 171 and a second return magnet 172 as a return means (a return member); the first magnetic sensor 181 and the second magnetic sensor 182 as a position detecting means; and others.

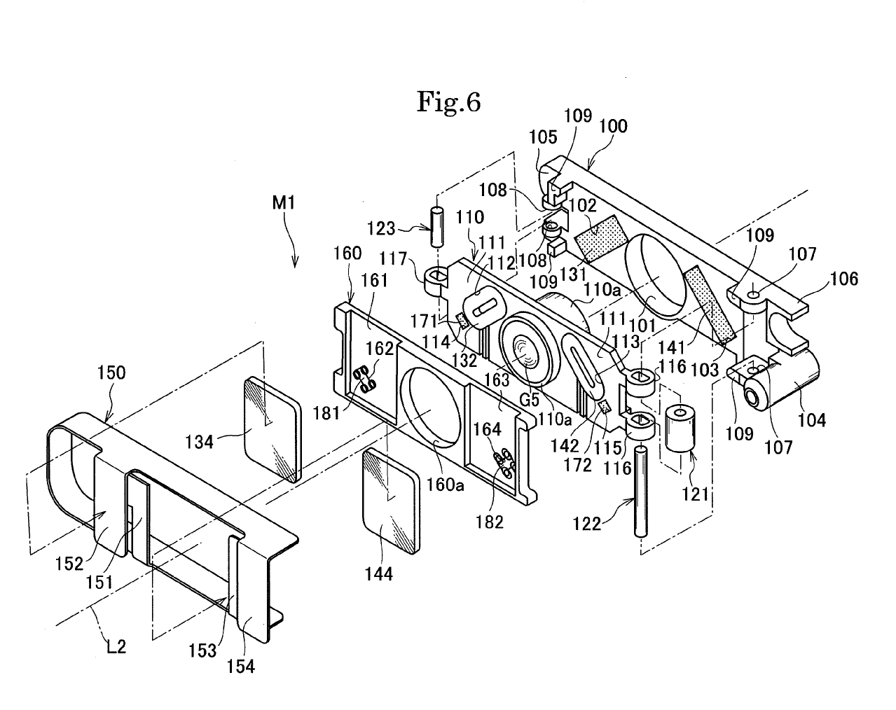

As shown in FIGS. 6 to 10 and FIG. 12, the base 100 is formed into a substantially rectangular flat plate-like shape that is substantially flat in the optical axis direction L2, narrow in a direction of a straight line S1 perpendicular to the optical axis L2 and parallel to the optical axis L1, and long is a direction of a straight line S2 perpendicular to the optical axis L2 and the straight line S1, and it includes a circular opening portion 101 with the optical axis L2 at the center, a fitting hole 102 in which the first drive magnet 131 is fitted and fixed and a fitting hole 102′ in which the first yoke 133 is fitted and fixed, a fitting hole 103 in which the second drive magnet 141 is fitted and fixed and a fitting hole 103′ in which the second yoke 143 is fitted and fixed, a guided portion 104 that is slidably engaged with and guided by the guide shaft 71, a regulated portion 105 that is slidably engaged with the antirotation shaft 72 to regulate its rotation on the optical axis L2, the U-shaped engagement portion 106 with which the nut 75 having the lead screw 73 screwed therein comes into contact, a fitting hole 107 in which the first guide shaft 122 is fitted and fixed, a fitting hole 108 in which the second guide shaft 123 is fitted and fixed, a fixing portion 109 configured to fix the cover member 160, and others.

The opening portion 101 is formed with an inner diameter dimension that allows a cylindrical portion 110a to pass therethrough in a contactless manner in the range that the movable holding member 110 is driven.

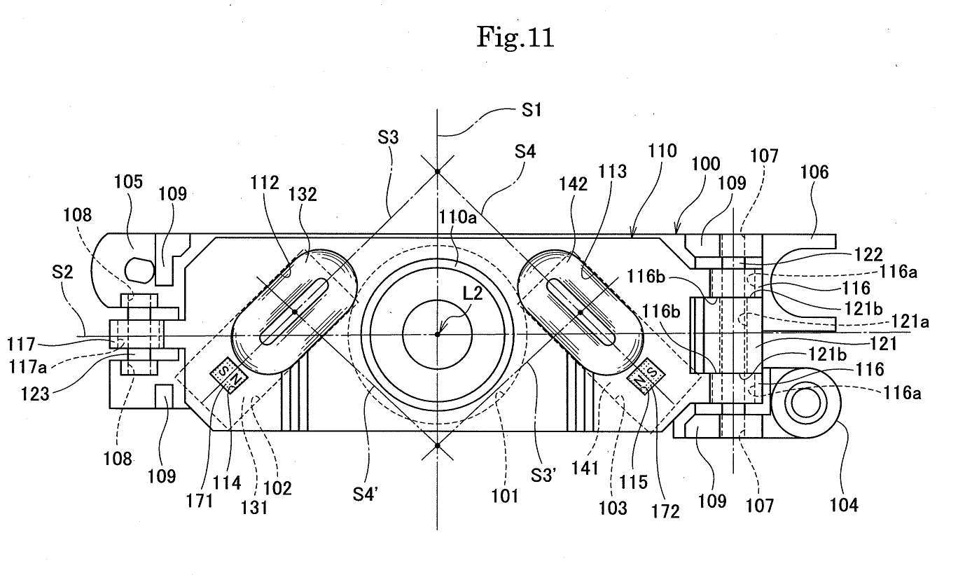

As shown in FIG. 11, the fitting hole 102 (and the fitting hole 102′) is formed into a substantially rectangular shape that is long in a direction of a straight line S3 forming 45 degrees with the straight line S2 and narrow in a direction of a straight line S4′ vertical to the straight line S3.

As shown in FIG. 11, the fitting hole 103 (and the fitting hole 103′) is formed into a substantially rectangular shape that is long in the direction of the straight line 54 forming 45 degrees with the straight line S2 and narrow in a direction of a straight line S3′ vertical to the straight line S4.

Moreover, as shown in FIG. 11, the fitting hole 102 (and the fitting hole 102′) and the fitting hole 103 (and the fitting hole 103′) are formed to be line-symmetric with respect to the straight line S1.

That is, a pair of the first drive magnet 131 and the first yoke 133 and a pair of the second drive magnet 141 and the second yoke 143 are arranged to be line-symmetric with respect to the straight line S1 on the base 100.

As shown in FIG. 6 to FIG. 11, the movable holding member 110 is formed into a substantially rectangular flat plate-like shape that is substantially flat in the optical axis L2 direction except a part, narrow in the direction of the straight line S1 that is perpendicular to the optical axis L2 and parallel to the optical axis L1, and long in the direction of the straight line S2 perpendicular to the optical axis L2 and the straight line S1, and it includes a circular cylindrical portion 110a with the optical axis L2 at the center, a flat plate-like extending portion ill extending to both sides of the direction of the straight line S2 to sandwich the cylindrical portion 110a, a fitting hole 112 in which the first coil 132 is fitted and fixed, a fitting hole 113 in which the second coil 142 is fitted and fixed, a fitting hole 114 in which the first return magnet 171 is fitted and fixed, a fitting hole 115 in which the second return magnet 172 is fitted and fixed, two engagement portions 116 forming a part of the support mechanism having the first guide shaft 122 inserted therein, a second engagement portion 117 forming a part of the support mechanism having the second guide shaft 123 inserted therein, and others.

As shown in FIG. 11, the fitting hole 112 (and the fitting hole 114) is formed into a substantially rectangular shape that is long in the direction of the straight line S3 forming 45 degrees with the straight line S2 and narrow in the direction of the straight line S4′ vertical to the straight line S3.

As shown in FIG. 11, the fitting hole 113 (and the fitting hole 115) is formed into a substantially rectangular shape that is long in the direction of the straight line S4 forming 45 degrees with the straight line S2 and narrow in the direction of the straight line S3′ vertical to the straight line S4.

Further, the fitting hole 112 (and the fitting hole 114) and the fitting hole 113 (and the fitting hole 115) are formed to be line-symmetric with respect to the straight line S1 as shown in FIG. 11.

That is, a pair of the first coil 132 and the first return magnet 171 and a pair of the second coil 142 and the second return magnet 172 are arranged to be line-symmetric with respect to the straight line S1 on the movable holding member 110.

The two engagement portions 116 are formed on one end side of the movable holding member 110 in the direction of the straight line S2 (a second guide direction) and define respective long holes 116a that are coaxially pierced in the direction of the straight line S1 (a first guide direction) and extend in the direction of the straight line S2 (the second guide direction). The long hole 116a of each engagement portion 116 is formed with a dimension that allows close contact with the first guide shaft 122 in the optical axis direction L2 and migration of the first guide shaft in the direction of the straight line S2 (the second guide direction). End faces 116b of the engagement portions 116 are formed in such a manner that they come into contact with two end faces 121b of the cylindrical member 121 to regulate their relative movement in the direction of the straight line S1 and they can relatively slide in the direction of the straight line S2 (the second guide direction).

The second engagement portion 117 is formed on the other end side of the movable holding member 110 in the direction of the straight line S2 (the second guide direction) and defines a long hole 117a that is pierced in the direction of the straight line S1 (the first guide direction) and extends in the direction of the straight line S2 (the second guide direction). The long hole 117a is formed with a dimension that allows close contact with the second guide shaft 123 in the optical axis L2 direction and migration of the second guide shaft in the direction of the straight line S2 (the second guide direction).

As shown in FIG. 5 to FIG. 9, the cylindrical member 121 is formed into a cylindrical shape extending in the direction of the straight line S1 (the first guide direction), and it defines a circular through hole 121a into which the first guide shaft 122 is slidably inserted and the two end faces 121b formed as flat surfaces.

As shown in FIG. 5 to FIG. 9, the first guide shaft 122 is formed to have a circular cross section, extend in the direction of the straight line S1, and define the first guide direction, and both end portions thereof are fitted and fixed in the fitting hole 107 formed on the one end side of the base 100 in the direction of the straight line S2 (the second guide direction).

As shown in FIG. 5 to FIG. 9, the second guide shaft 123 is formed to have a circular cross section and extend in the direction of the straight line S1, and both end portions thereof are fitted and fixed in the fitting hole 108 formed on the other end side of the base 100 in the direction of the straight line S2 (the second guide direction).

That is, the first guide shaft 122 is inserted into the two long holes 116a and the through hole 121a with the cylindrical member 121 being fitted between the two engagement portions 116, and both the end portions thereof are fitted and fixed in the fitting hole 107 of the base 100. Further, the second guide shaft 123 is inserted into the long hole 117a of the engagement portion 117, and both the ends thereof are fitted and fixed in the fitting hole 108.

As a result, the movable holding member 110 is supported to be movable in the first guide direction and the second guide direction, i.e., within a plane vertical to the optical axis L2 by the support mechanism including the first guide shaft 122, the cylindrical member 121, the two engagement portions 16, the second guide shaft 123, and the two engagement portions 117, and the movable holding member is two-dimensionally moved within the plane vertical to the optical axis L2 with respect to the base 100 by drive force of the first drive mechanism 130 and the second drive mechanism 140, thereby highly accurately correcting an image blur caused due to hand movement and the like.

Here, since the support mechanism is constituted of the first guide shaft 122 fixed to the base 100, the cylindrical member 121, the engagement portions 116 formed on the movable holding member 110, the second guide shaft 123, and the second engagement portion 117, simplification of the structure, a reduction in thickness of the device in the optical axis direction, and others can be achieved.

Furthermore, since each engagement portion 116 has the long hole 116 in which the first guide shaft 122 is inserted, for example, the movable holding member 110 can be assuredly prevented from coming off after the first guide shaft 122 is inserted into each long hole 116a to be assembled.

Moreover, since the movable holding member 110 includes the two engagement portions 116 that engage with the two end faces 121b of the cylindrical member 121, assembling can be carried out by just fitting the cylindrical member 121 into the two engagement portions 116 and inserting the first guide shaft 122 into the cylindrical member 121 and the two engagement portions 116, thus attaining simplification of the structure and an assembling operation, and others.

Here, since the second guide shaft 123 that is fixed to the base 100 and extends in parallel to the direction of the straight line S1 (the first guide direction) and the second engagement portion 117 that is formed on the movable holding member 110 to engage with the second guide shaft 123 and regulate its movement in the optical axis L2 direction are adopted, inclination of the movable holding member 110 can be regulated by just engaging the second engagement portion 117 of the movable holding member 110 with the second guide shaft 123 fixed to the base 100, namely, by just fixing the second guide shaft 123 to the base 100 while being inserted into the long hole 117a of the second engagement portion 117 in this example, thereby simplifying the structure, the assembling operation, and others.

Additionally, each of opposed regions of the base 100 and the movable holding member 110 is formed into a substantially rectangular long flat plate-like shape that is substantially flat in the optical axis L2 direction and has one end side and the other end side in the direction of the straight line S2 (the second guide direction), the first guide shaft 122 is fixed to the one end side of the base 100, the second guide shaft 123 is fixed to the other end side of the base 100, the engagement portions 116 are provided on the one end side of the movable holding member 110, and the second engagement portion 117 is provided on the other end side of the movable holding member 110, whereby a reduction in thickness (miniaturization) of the device in the direction of the straight line S1 (the first guide direction) and a reduction in thickness of the device in the optical axis L2 direction are achieved, and the movable holding member 110 is highly accurately moved within the plane vertical to the optical axis L2, thus easily and highly accurately correcting an image blur caused due to hand movement and the like.

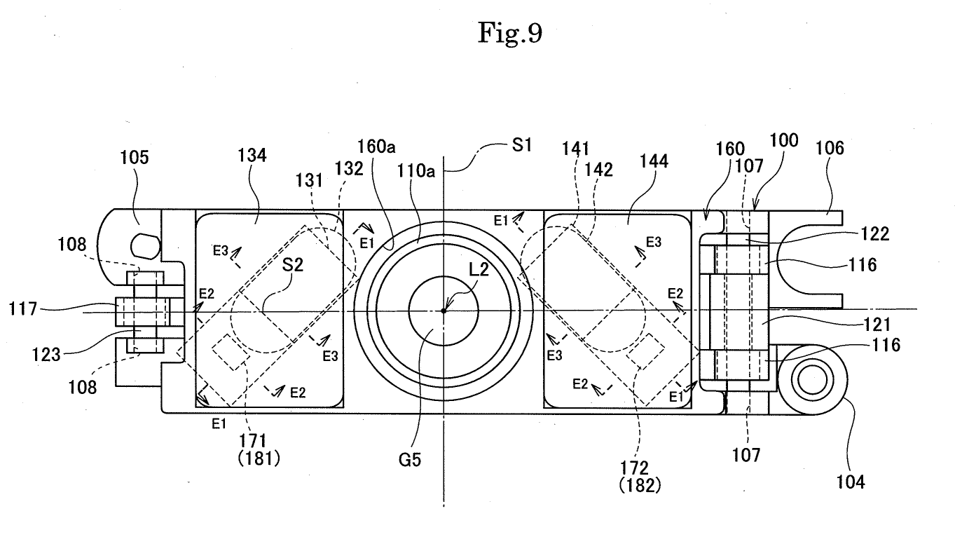

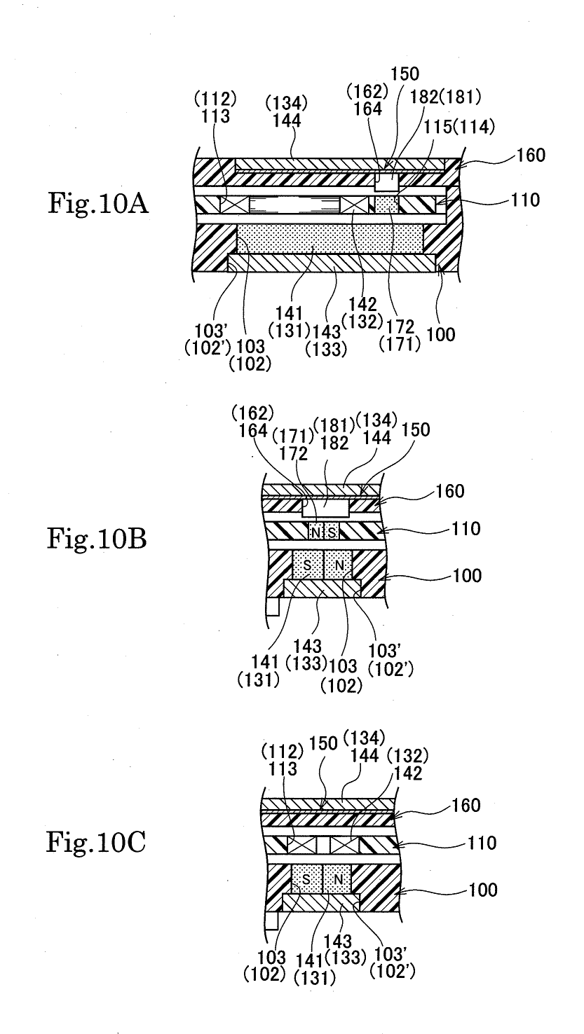

As shown in FIG. 5 to FIG. 7, FIG. 9, and FIG. 10, the cover member 160 is arranged to sandwich the movable holding member 110 in the optical axis L2 direction and fixed to the base 100, and it has a circular opening portion 160a at the center and also has a fitting concave portion 161 in which the first yoke 134 is fitted and fixed, a fitting hole 162 in which the first magnetic sensor 181 is fitted and fixed, a fitting concave portion 163 in which the second yoke 144 is fitted and fixed, a fitting hole 164 in which the second magnetic sensor 182 is fitted and fixed, and others on both sides of the opening portion 160a.

The opening portion 160a is formed with an inner diameter dimension that allows the cylindrical portion 110a to pass therethrough in a contactless manner in the range that the movable holding member 110 is driven.

The fitting hole 162 is formed at a position where the first magnetic sensor 181 faces the first return magnet 171 in a state that the cover member 160 and the movable holding member 110 are assembled to the base 100.

The fitting hole 164 is formed at a position where the second magnetic sensor 182 faces the second return magnet 172 in a state that the cover member 160 and the movable holding member 110 are assembled to the base 100.

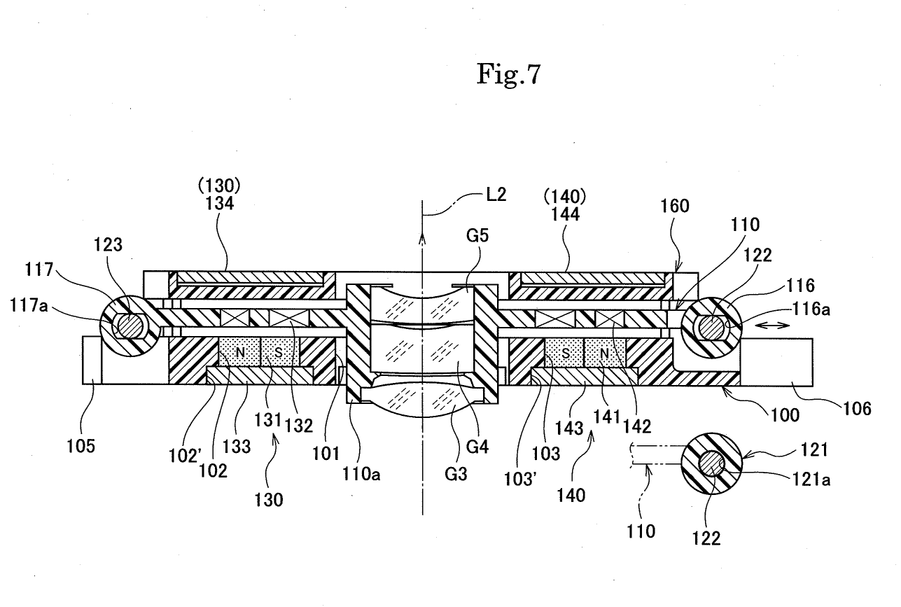

As shown in FIG. 6 and FIG. 7, the first drive mechanism 130 is formed as a voice coil motor including the first drive magnet 131, the first coil 132, and the first yokes 133 and 134.

As shown in FIG. 11, the first drive magnet 131 is formed into a rectangular shape that is long in the direction of the straight line S3, and it is fitted and fixed in the fitting hole 102 of the base 100. Further, the first drive magnet 131 is magnetized to have an N pole and an S pole with a surface running through the straight line S3 as a border.

As shown in FIG. 11, the first coil 132 is formed into a substantially elliptic annular shape having a major axis in the direction of the straight line S3 and a minor axis in the direction of the straight line S4′, and it is fitted and fixed in the fitting hole 112 of the movable holding member 110. Furthermore, the first coil 132 is arranged in such a manner that its major axis forms an inclination angle of 45 degrees with respect to the straight line S2.

The first yoke 133 is formed into a rectangular shape that has an area equal to or above that of the first magnet 131 when being in contact with the first magnet 131 and is long in the direction of the straight line S3, and it is fitted and fixed in the fitting hole 102′ of the base 100 as shown in FIG. 7.

The first yoke 134 is formed into a rectangular flat plate-like shape having an area larger than that of the first coil 132, arranged in the optical axis L2 direction to have a predetermined gap between itself and the first coil 132, and fitted and fixed in the fitting concave portion 161 of the cover member 160.

Further, the first drive mechanism 130 generates electromagnetic drive force in the first direction vertical to the optical axis L2, i.e., the direction of the straight line S4′ by turning on/off energization with respect to the first coil 132.

As shown in FIG. 6 and FIG. 7, the second drive mechanism 140 is formed as a voice coil motor including the second drive magnet 141, the second coil 142, and the second yokes 143 and 144.

As shown in FIG. 11, the second drive magnet 141 is formed into a rectangular shape that is long in the direction of the straight line S4, and it is fitted and fixed in the fitting hole 103 of the base 100. Additionally, the second drive magnet 141 is magnetized to have an N pole and an S pole with a surface running through the straight line S4 as a border.

As shown in FIG. 11, the second coil 142 is formed into a substantially elliptic annular shape having a major axis in the direction of the straight line S4 and a minor axis in the direction of the straight line S3′, and it is fitted and fixed in the fitting hole 113 of the movable holding member 110. Further, the second coil 142 is arranged in such a manner that its major axis forms an inclination angle of 45 degrees with respect to the second straight line S2.

The second yoke 143 is formed into a rectangular shape that has an area equal to or above an area of the second drive magnet 141 when being in contact with the second drive magnet 141 and is long in the direction of the straight line S4, and it is fitted and fixed in the fitting hole 103′ of the base 100 as shown in FIG. 7.

The second yoke 144 is formed into a rectangular flat plate-like shape having an area larger than that of the second coil 142, arranged to have a predetermined gap between itself and the second coil 142 in the optical axis Ls direction, and fitted and fixed in the fitting hole 163 of the yoke holding member 160.

Furthermore, the second drive mechanism 140 is configured to generate electromagnetic drive force in the second direction vertical to the optical axis L2, i.e., the direction of the straight line S3′ by turning on/off energization with respect to the second coil 142.

As shown in FIG. 11, since the first drive mechanism 130 and the second drive mechanism 140 are arranged to be line-symmetric with respect to the straight line S1 perpendicular to the optical axis L2 of the lenses G3, G4, and G5 held by the single movable holding member 110, drive loads imposed on the respective drive mechanisms are equal to each other, these drive mechanisms exercise drive force on both sides of the lenses G3, G4, and G5, whereby the movable holding member 110 can be stably and smoothly driven within a plane vertical to the optical axis L2.

Moreover, since the first coil 132 and the second coil 142 are arranged in such a manner that each of their major axes forms the predetermined inclination angle with respect to the straight line S2, when the movable holding member 110 has a shape that is long in the direction of the straight line S2, the dimension of the movable holding member 110 can be reduced in the direction of the straight line S1 by inclining the first coil 132 and the second coil 142 and, for example, a reduction in size and thickness of the device in the direction vertical to the optical axis L2 (the direction of the first straight line) can be achieved.

Further, since the movable holding member 110 is arranged in such a manner that the cylindrical portion 110a is inserted in the opening portion 101 of the base 100 and the extending portion 111 on both sides adjacently faces the base 100 in the optical axis L2 direction, the movable holding member 110 can be arranged closer to the base 100 even in case of holding the plurality of lenses G3, G4, and G5, thereby reducing the thickness of the device in the optical axis direction L2.

Furthermore, the first drive magnet 131 and the second drive magnet 141 are fixed to the base 100, and the first coil 132 and the second coil 142 are fixed to the movable holding member 110, i.e., the first coil 132 and the second coil 142 are fixed to the movable holding member 110 holding the lenses G3, G4, and G5, whereby a module can be configured in accordance with specifications when changing, e.g., the numbers of turns of the first coil 132 and the second coil 142 based on specification of the lenses (e.g., the number, weights, and others).

As shown in FIG. 2, FIG. 5, and FIG. 6, the flexible wiring board 150 has a connecting portion 151 connected with the first coil 132 of the first drive mechanism 130, a connecting portion 152 connected with the first magnetic sensor 181, a connecting portion 153 connected with the second coil 142 of the second drive mechanism 140, and a connecting portion 154 connected with the second magnetic sensor 182, and it is bent and formed to be arranged around the base 100. Moreover, as shown in FIG. 2 and FIG. 3, the flexible wiring board 150 is arranged in the unit case 10 in a bendable manner and electrically connected to the drive circuit 95 and the position detection circuit 96.

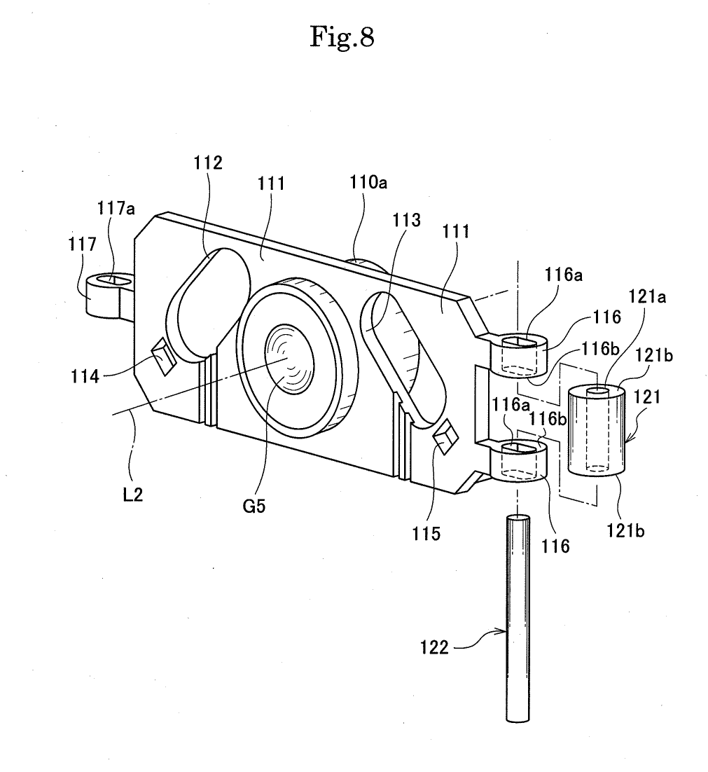

The first return magnet 171 and the second return magnet 172 function as return members, and they are fitted and fixed in the fitting holes 114 and 115 of the movable holding member 110, respectively, as shown in FIG. 6, FIG. 8, FIG. 10, and FIG. 11.

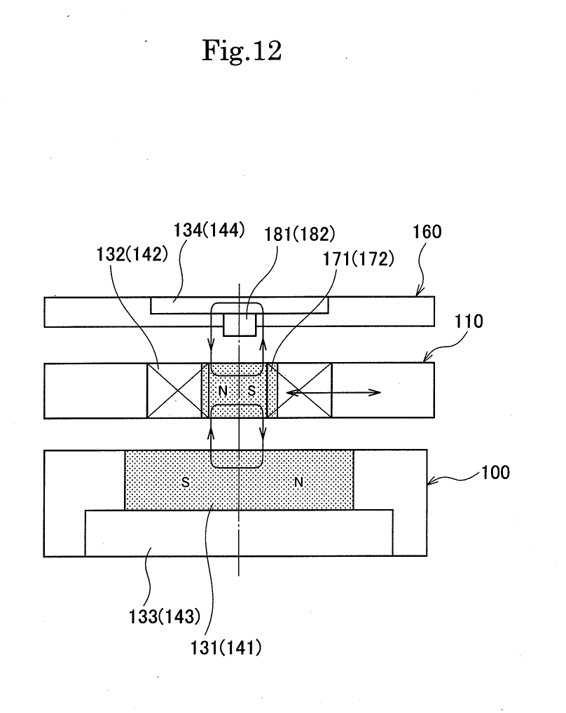

Further, as shown in FIG. 12, the first return magnet 171 is formed in such a manner that it faces the first drive magnet 131 to exercise a magnetic function, returns the movable holding member 110 to a predetermined pause position (a position at which the optical axis L2 of the lenses G3, G4, and G5 coincides with the center of the opening portion 101 of the base 100 in this example) in a pause state that the first coil 132 is not energized, and generates stable holding force.

Furthermore, as shown in FIG. 12, the second return magnet 172 is formed in such a manner that it faces the second drive magnet 141 to exercise a magnetic function, returns the movable holding member 110 to the predetermined pause position (the position at which the optical axis L2 of the lenses G3, G4, and G5 coincides with the center of the opening portion 101 of the base 100 in this example) in a pause state that the second coil 142 is not energized, and generates stable holding force.

As described above, in the pause state, the movable holding member 110 (the lenses G3, G4, and G5) is automatically returned to and stably held at the predetermined pause position (the position at which the optical axis L2 of the lenses G3, G4, and G5 coincides with the center of the opening portion 101 of the base 100) by a magnetic attractive function between the first return magnet 171 and the second return magnet 172 as the return means and the first drive magnet 131 and the second drive magnet 141 as the driving means. Therefore, drive control such as initialization is not required at the time of driving, and wobble and the like of the movable holding member 110 can be avoided in the pause state. Moreover, both the first drive magnet 131 and the second drive magnet 141 as the driving means are used in order to exert a mutual function with the first return magnet 171 and the second return magnet 172 as the return means, thereby achieving simplification of the structure, a reduction in size of the device, and others.

Each of the first magnetic sensor 181 and the second magnetic sensor 182 is, e.g., a hall element that detects a change in magnetic flux density and outputs it as an electric signal, and it is fitted and fixed in the fitting hole 162 or 164 of the cover member 160 that is coupled and fixed to the base 110 to function as a part of the base. Here, in the movement range of the movable holding member 110, the first magnetic sensor 181 is arranged at a position where it faces the first return magnet 171, and the second magnetic sensor 182 is arranged at a position where it faces the second return magnet 172.

Additionally, as shown in FIG. 12, the first magnetic sensor 181 forms a magnetic circuit between itself and the first return magnet 171 provided to the movable holding member 110, and it is configured to detect a position of the movable holding member 110 by detecting a change in magnetic flux density caused when (the first return magnet 171 of) the movable holding member 110 relatively moves with respect to the base 100 and the cover member 160.

Further, as shown in FIG. 12, the second magnetic sensor 182 forms a magnetic circuit between itself and the second return magnet 172 provided to the movable holding member 110, and it is configured to detect a position of the movable holding member 110 by detecting a change in magnetic flux density caused when (the second return magnet 172 of) the movable holding member 110 relatively moves with respect to the base 100 and the cover member 160.

As described above, since the first magnetic sensor 181 and the second magnetic sensor 182 are fixed to the base 100 through the cover member 160, wiring is easier than that in a case where these sensors are provided to the movable holding member 110, disconnection and the like involved by movement can be avoided, and simplification of the structure, a reduction in number of components an in size of the device, and others can be achieved as compared with a case where a dedicated magnet is provided since both the first return magnet 171 and the second return magnet 172 are used for positional detection.

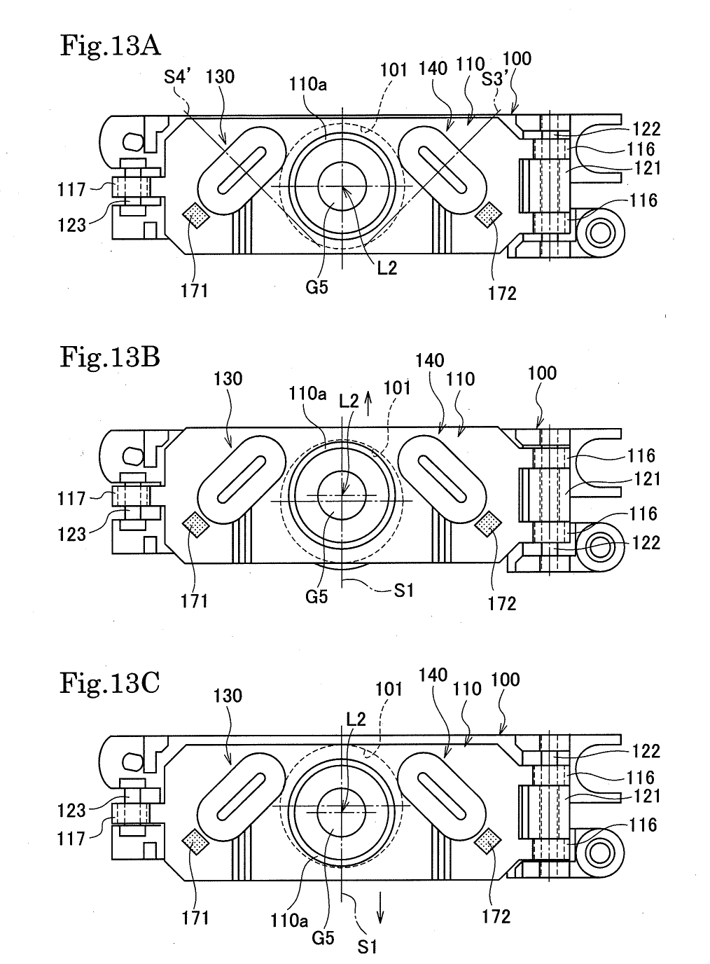

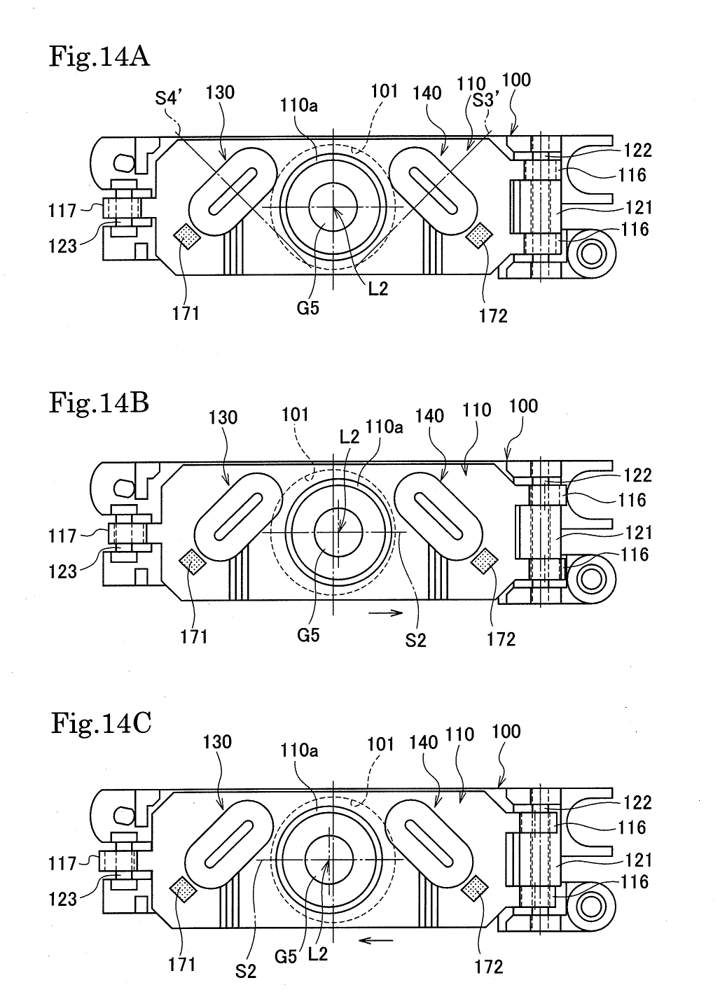

A correcting operation of the image blur correction device M1 will now be briefly described with reference to FIG. 13A to FIG. 14C.

First, as shown in FIG. 13A, in the pause state that the first coil 132 and the second coil 142 are not energized, the movable holding member 110 is returned (centered) to and held at the pause position where the optical axis L2 of the lenses G3, G4, and G5 coincides with the center of the opening portion 101 of the base 100 by a return function of the return means (the first return magnet 171 and the second return magnet 172).

Further, for example, when upwardly shifting the movable holding member 110 (the lenses G3, G4, and G5) from the pause state depicted in FIG. 13A, the first drive mechanism 130 is operated to generate drive force in an obliquely upward direction of the first direction (the direction of the straight line S4′), and the second 140 drive mechanism 130 is operated to generate drive force in an obliquely upward direction of the second direction (the direction of the straight line S3′). As a result, as shown in FIG. 13B, the movable holding member 110 is moved in an upward direction of the straight line S1.

Furthermore, for example, when downwardly shifting the movable holding member 110 (the lenses G3, G4, and G5) from the pause state depicted in FIG. 13A, the first drive mechanism 130 is operated to generate drive force in an obliquely downward direction of the first direction (the direction of the straight line S4′), and the second drive mechanism 140 is operated to generate drive force in an obliquely downward direction of the second direction (the direction of the straight line S3′). As a result, as shown in FIG. 13C, the movable holding member 110 is moved in a downward direction of the straight line S1 direction.

Subsequently, as shown in FIG. 14A, for example, when shifting the movable holding member 110 (the lenses G3, G4, and G5) toward a right-hand side from the pause state that the movable holding member 110 has been returned to the pause position at which the optical axis L2 of the lenses G3, G4, and G5 coincides with the center of the opening portion 101 of the base 100 by the return function of the return means (the first return magnet 171 and the second return magnet 172), the first drive mechanism 130 is operated to generate drive force in the obliquely downward direction of the first direction (the direction of the straight line S4′), and the second drive mechanism 140 is operated to generate drive force in the obliquely upward direction of the second direction (the direction of the straight line S3′). As a result, as shown in FIG. 14B, the movable holding member 110 is moved toward the right-hand side of the direction of the straight line S2.

Moreover, for example, when shifting the movable holding member 110 (the lenses G3, G4, and G5) toward a left-hand side from the pause state depicted in FIG. 14A, the first drive mechanism 130 is operated to generate drive force in the obliquely upward direction of the first direction (the direction of the straight line S4′), and the second drive mechanism 140 is operated to generate drive force in the obliquely downward direction of the second direction (the direction of the straight line S3′). As a result, as shown in FIG. 14C, the movable holding member 110 is moved toward the left-hand side of the direction of the straight line S2.

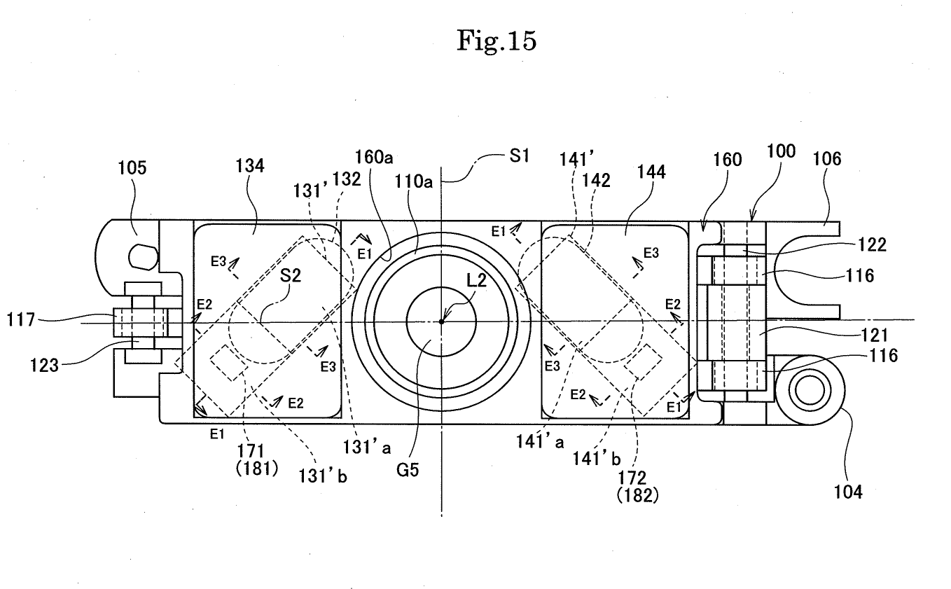

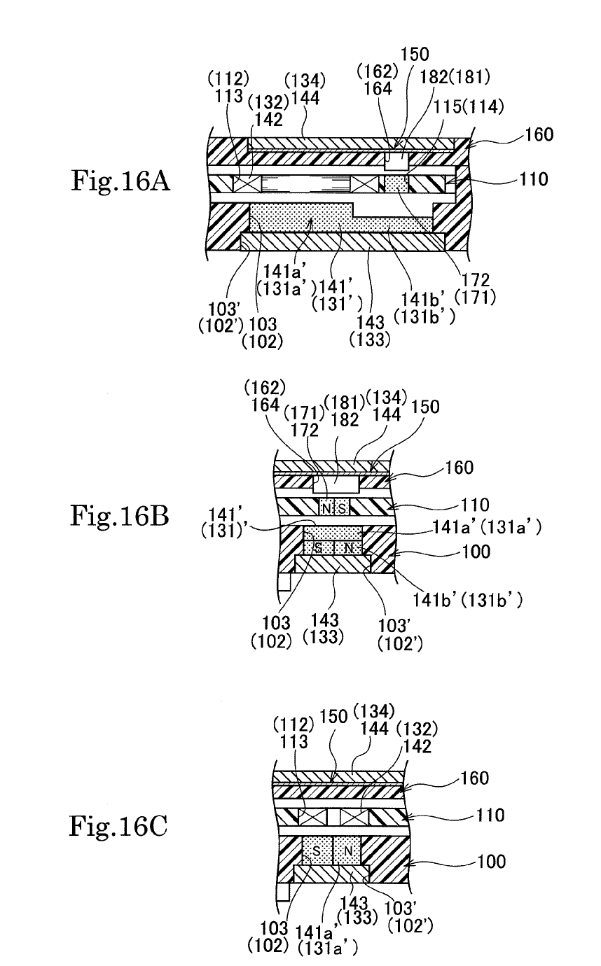

FIG. 15 and FIG. 16A to FIG. 16C show a modification of the foregoing image blur correction device, this modification is the same as the foregoing embodiment except that the conformations of the first drive magnet and the second drive magnet are changed, and hence like reference numerals denote like structures to omit a detailed explanation.

In this modification, a first drive magnet 131′ is formed to include a first driving part 131a′ facing the first coil 132 and a first holding part 131b′ that is formed with a smaller thickness than that of the first driving part 131a′ and faces the first return magnet 171 as shown in FIG. 15 and FIG. 16A to FIG. 16C.

Furthermore, a second drive magnet 141′ is formed to include a second driving part 141a′ facing the second coil 142 and a second holding part 141b′ that is formed with a smaller thickness than that of the second driving part 141a′ and faces the second return magnet 172 as shown in FIG. 15 and FIG. 16A to FIG. 16C.

As a result, since the first driving part 131a′ and the second driving part 141a′ requiring large magnetic force and the first holding part 131b′ and the second holding part 141b′ requiring optimum attractive force in the return function without producing excessive resistance force at the time of driving are formed with respect to the first drive magnet 131′ and the second drive magnet 141′ by forming a step to the first drive magnet 131′ and the second drive magnet 141′, the movable holding member 110 can be more smoothly driven, and the movable holding member 110 can be smoothly positioned and held at the predetermined pause position at the time of pausing.

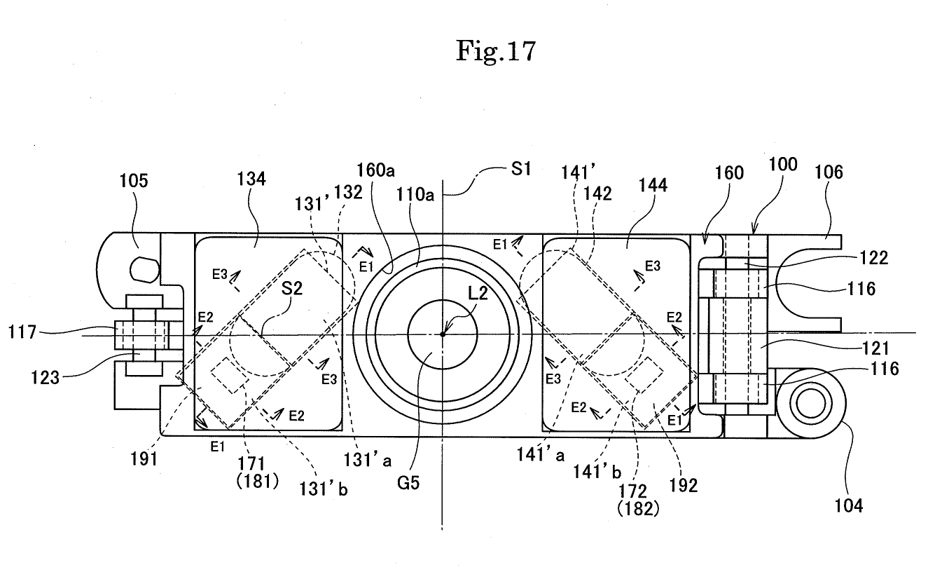

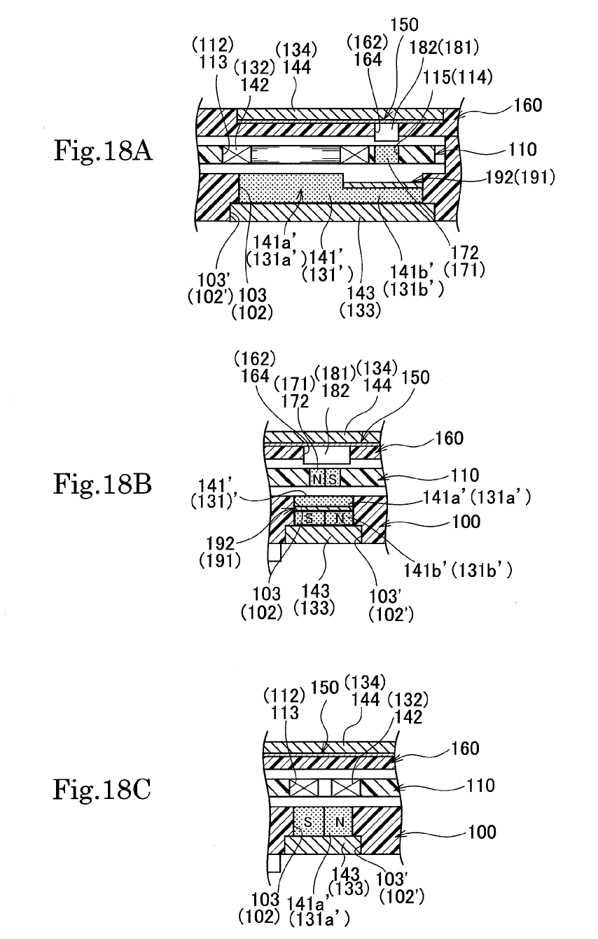

FIG. 17 and FIG. 18A to FIG. 18C show another modification of the foregoing image blur correction device, this modification is the same as the foregoing modification depicted in FIG. 15 and FIG. 16A to FIG. 16C except that a first yoke 191 and a second yoke 192 are added, and hence a like reference numerals denote like structures to omit a detailed explanation.

In this modification, as shown in FIG. 17 and FIG. 18A to FIG. 18C, the laminar first yoke 191 is arranged on a surface of the first holding part 131b′ of the first drive magnet 131′ on a side facing the first return magnet 171.

Additionally, the laminar second yoke 192 is arranged on a surface of the second holding part 141b′ of the second drive magnet 141′ on a side facing the second return magnet 172.

As a result, the first yoke 191 can adjust magnetic attractive force between the first return magnet 171 and the first holding part 131b′, and the second yoke 192 can adjust magnetic attractive force between the second return magnet 172 and the second holding part 141b′. Therefore, a mutual relationship between the drive force and the holding force can be highly accurately and finely adjusted.

In the foregoing embodiment, although the first drive mechanism 130 and the second drive mechanism 140 has been described as the driving means, the present invention is not limited thereto, and any other configuration may be adopted as long as it includes drive magnets and coils and the movable holding member 110 can be two-dimensionally driven within the plane vertical to the optical axis L2.

In the foregoing embodiment, although the configuration that each of the first coil and the second coil is formed into the substantially elliptic annular shape has been described, this “substantially elliptic annular shape” is a concept including a substantially rectangular annular shape consisting of wide sides (major axes) and narrow sides (minor axes) including straight line portions besides the elliptic annular shape.

In the foregoing embodiment, although the first return magnet 171 and the second return magnet 172 have been described as the return means, the present invention is not limited thereto, and any other number of magnets or return magnets having different conformations may be adopted.

In the foregoing embodiment, although each of the magnetic sensor 181 and the second magnetic sensor 182 consisting of the hall element has been described as the position detecting means, the present invention is not limited thereto, and any other magnetic sensor may be adopted.

In the foregoing embodiment, although the configuration that the cylindrical portion 121, the first guide shaft 122, and the second guide shaft 123, and the engagement portion 116 and the engagement portion 117 of the movable holding member 110 that constitute the support mechanism for supporting the movable holding member has been described, the present invention is not limited thereto, and the present invention may be adopted in a configuration equipped with a support mechanism including at least three balls and urging springs or any other support mechanism.

In the foregoing embodiment, although the image blur correction device has been described, a configuration including the image blur correction device having the above configuration may be adopted in an imaging lens unit including a plurality of lenses for imaging.

As a result, when the configuration where the plurality of lenses for imaging are arranged in the optical axis direction includes the above-described image blur correction device, the correction lenses G3, G4, and G5 held by the movable holding member 110 are appropriately driven, and an image blur caused due to hand movement and others can be smoothly and highly accurately corrected. That is, the imaging lens unit having the image bur correcting function in addition to the plurality of lenses for imaging can be provided.

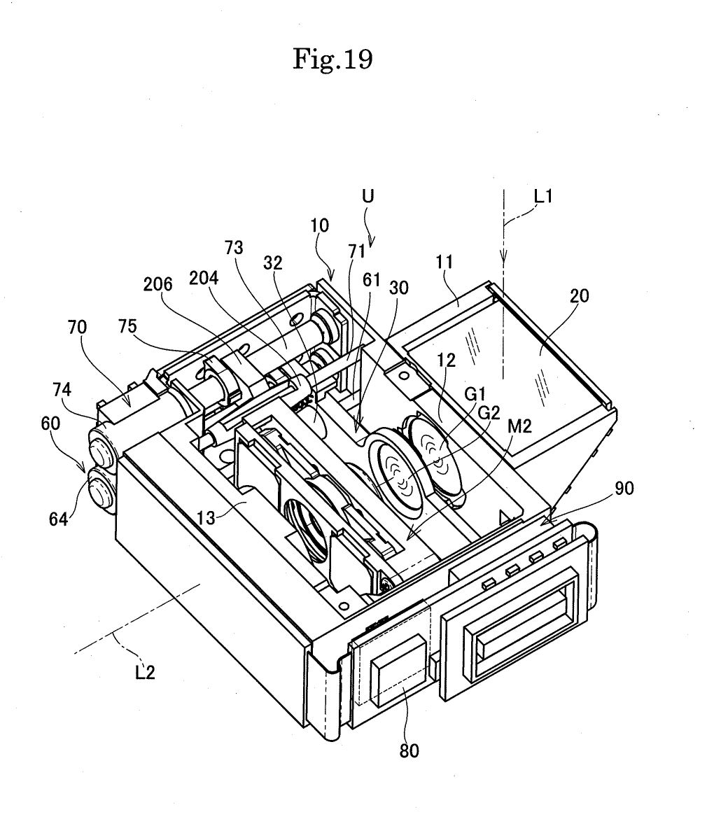

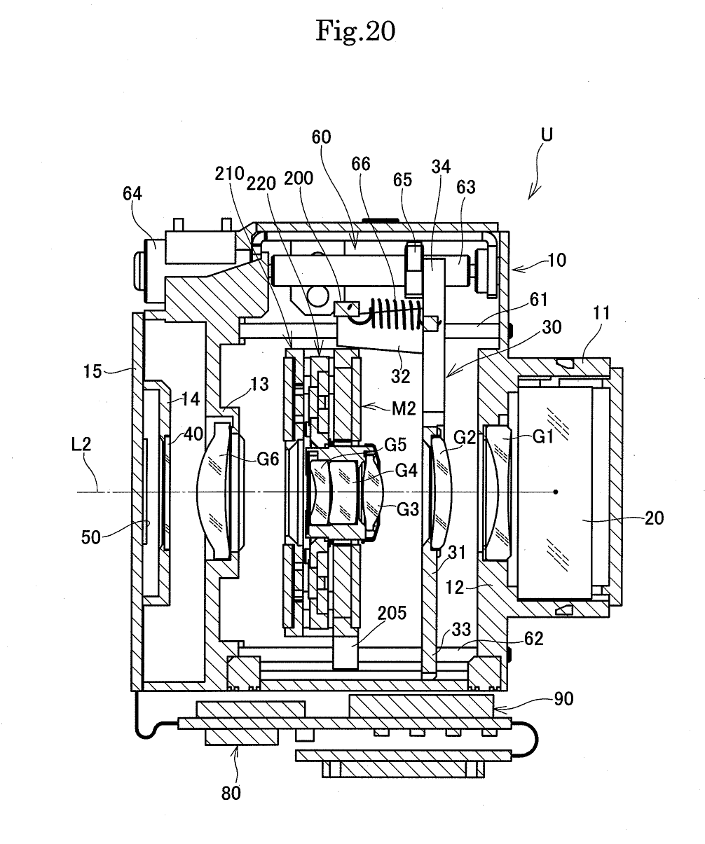

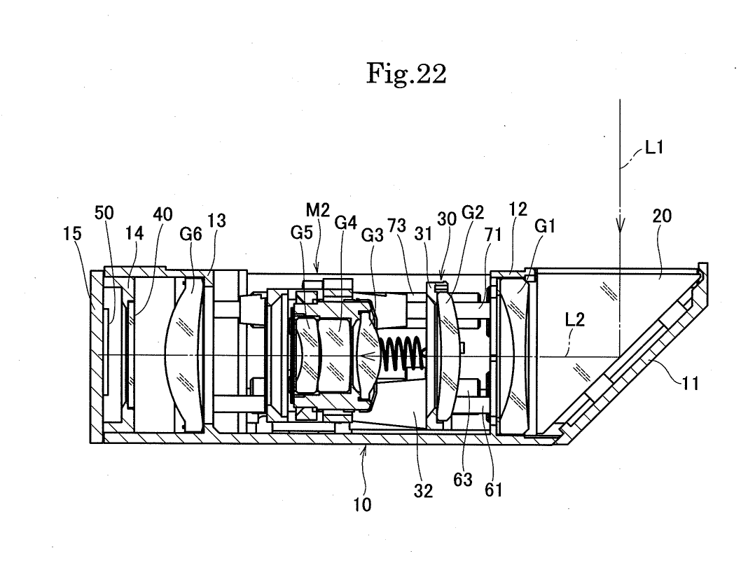

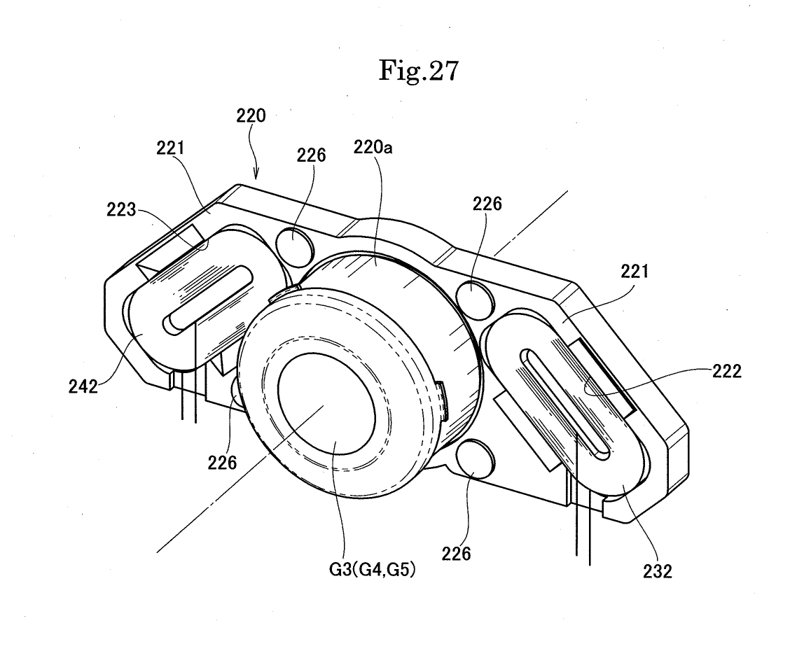

FIG. 19 to FIG. 33 show an image blur correction device M2 according to a second embodiment of the present invention. As shown in FIG. 19, FIG. 20, and FIG. 22, this image blur correction device M2 is incorporated in the same camera unit U as that described above, and it includes such a control unit 90 as depicted in FIG. 20.

As shown in FIG. 20 and FIG. 23 to FIG. 25, this image blur correction device M2 includes a fixed frame 200 and a cover frame 210 as a base, a movable holding member 220, a first drive mechanism 230 (including a first drive magnet 231, a first'coil 232, and first yokes 233 and 234) as a driving means, a second drive mechanism 240 (including a second drive magnet 241, a second coil 242, and second yokes 243 and 244) as a driving means, a flexible wiring board 250, a first return magnet 261 and a second return magnet 262 as a return means (return member), a first magnetic sensor 271 and a second magnetic sensor 272 as a position detecting means, and others.

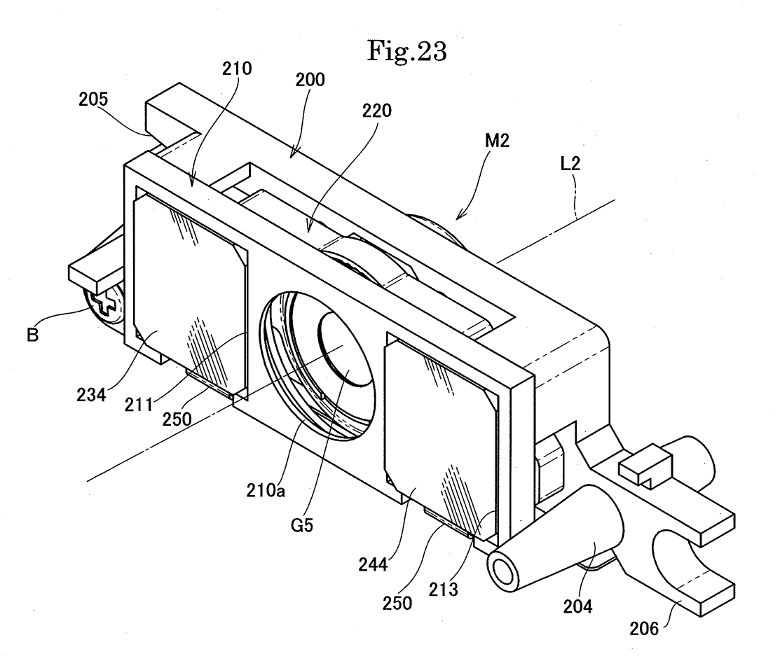

As shown in FIG. 23 to FIG. 26 and FIG. 30, the fixed frame 200 is formed into a substantially flat plate-like shape that is substantially flat in an optical axis L2 direction, narrow in a direction of a straight line S1 perpendicular to the optical axis L2 and parallel to an optical axis L1, and long in a direction of a straight line S2 perpendicular to the optical axis L2 and the straight line S1, and it includes an octagonal opening portion 201 with the optical axis L2 at the center, a fitting hole 202 in which the first drive magnet 231 is fitted and fixed and a fitting hole 202′ in which the first yoke 233 is fitted and fixed, a fitting hole 203 in which the second drive magnet 241 is fitted and fixed and a fitting hole 203′ in which the second yoke 243 is fitted and fixed, a guided portion 204 that is slidably engaged with and guided by a guide shaft 71, a regulated portion 205 that is slidably engaged with an antirotation shaft 62 to regulate its rotation on the optical axis L2, an U-shaped engagement portion 206 with which a nut 75 having a lead screw 73 screwed therein comes into contact, a plurality of (four in this example) convex portions 207 as a support mechanism, two positioning holes 208 that position the cover frame 210, a fixed portion 209 configured to fix the cover frame 210 by using a screw B, and others.

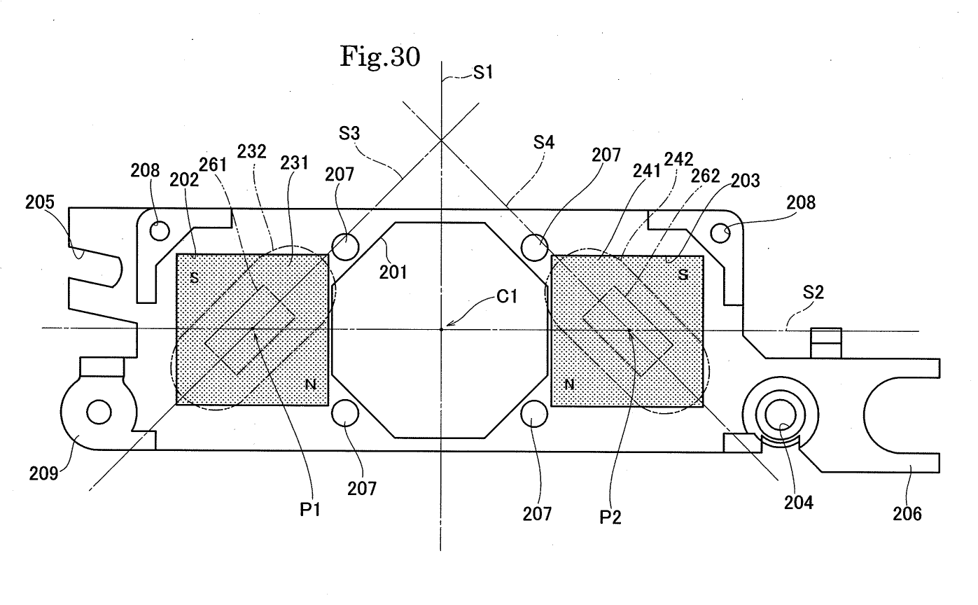

As shown in FIG. 30, the opening portion 201 is formed with an inner diameter dimension that enables defining a center C1 of an opening portion of the base at an intersection of the straight line S1 and the straight line S2 and allowing a cylindrical portion 220a of the movable holding member 220 to pass therethrough in a contactless manner in the range that the movable holding member 220 is driven.

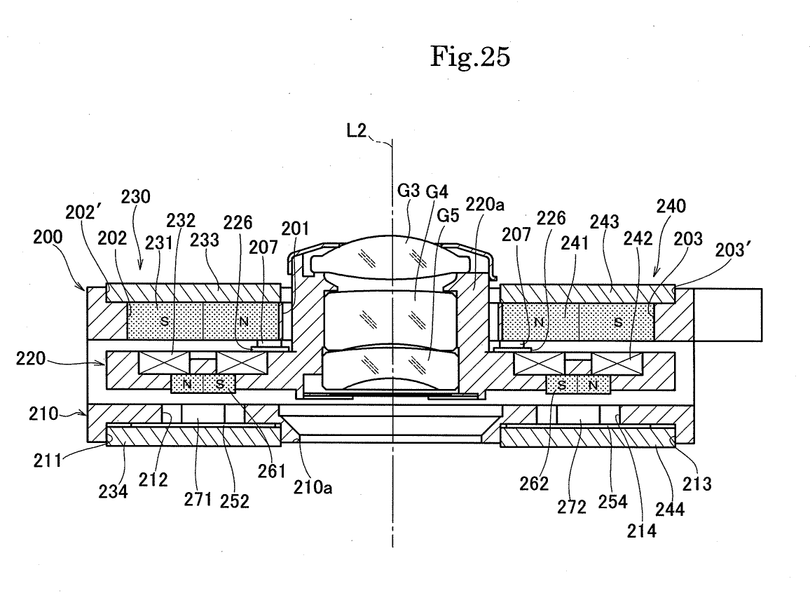

The fitting hole 202 (and the fitting hole 202′) and the fitting hole 203 (and the fitting hole 203′) are arranged to be line-symmetric with respect to the straight line S1 as shown in FIG. 25 and FIG. 30.

That is, a pair of the first drive magnet 231 and the first yoke 233 and a pair of the second drive magnet 241 and the second yoke 243 are arranged to be line-symmetric with respect to the straight line S1 on the fixed frame 200.

As shown in FIG. 23 to FIG. 26, the cover frame 210 is arranged to sandwich the movable holding member 220 in the optical axis L2 direction and fixed to the fixed frame 200, and it includes a circular opening portion 210a at the center, and at the both sides of the opening portion 210a, a fitting concave portion 211 in which the first yoke 234 is fitted and fixed, a fitting hole 212 in which the first magnetic sensor 271 is fitted and fixed, a fitting concave portion 213 in which the second yoke 244 is fitted and fixed, a fitting hole 214 in which the second magnetic sensor 272 is fitted and fixed, two positioning pins 215 inserted in the positioning holes 208 of the fixed frame 200, a screw hole 216 into which a screw B screwed into the fixed portion 209 of the fixed frame 200 is inserted, and others.

The opening portion 210a is formed with an inner diameter dimension that allows the cylindrical portion 220a to pass therethrough in a contactless manner in the range that the movable holding member 220 is driven.

The fitting hole 212 is formed at a position where the first magnetic sensor 271 faces the first return magnet 261 in a state that the cover frame 210 and the movable holding member 220 are assembled to the fixed frame 200.

The fitting hole 214 is formed at a position where the second magnetic sensor 272 faces the second return magnet 262 in a state that the cover frame 160 and the movable holding member 220 are assembled to the fixed frame 200.

As shown in FIG. 23 to FIG. 28, the movable holding member 220 is formed into a substantially rectangular flat plate-like shape that is substantially flat in the optical axis L2 direction except a part, narrow in the direction of the straight line S1 that is perpendicular to the optical axis L2 and parallel to the optical axis L1, and long in the direction of the straight line S2 perpendicular to the optical axis L2 and the straight line S1, and it includes the circular cylindrical portion 220a that holds lenses G3, G4, and G5 with the optical axis L2 at the center, two extending portions 221 extending to both sides of the direction of the straight line S2 to sandwich the cylindrical portion 220a, a fitting concave portion 222 in which the first coil 232 is fitted and fixed, a fitting concave portion 223 in which the second coil 242 is fitted and fixed, a fitting hole 224 in which the first return magnet 261 is fitted and fixed, a fitting hole 225 in which the second return magnet 262 is fitted and fixed, a plurality of (four in this example) abutting surfaces 226 abutting on the plurality of convex portions 207 as the support mechanism, a plurality of through holes 227 formed in regions of the fitting concave portions 222 and 223, and others.

That is, the movable holding member 220 is formed to define the cylindrical portion 220a and the two extending portions 221 that extend with a predetermined width from both sides in the straight line S2 direction to sandwich the cylindrical portion 220a.

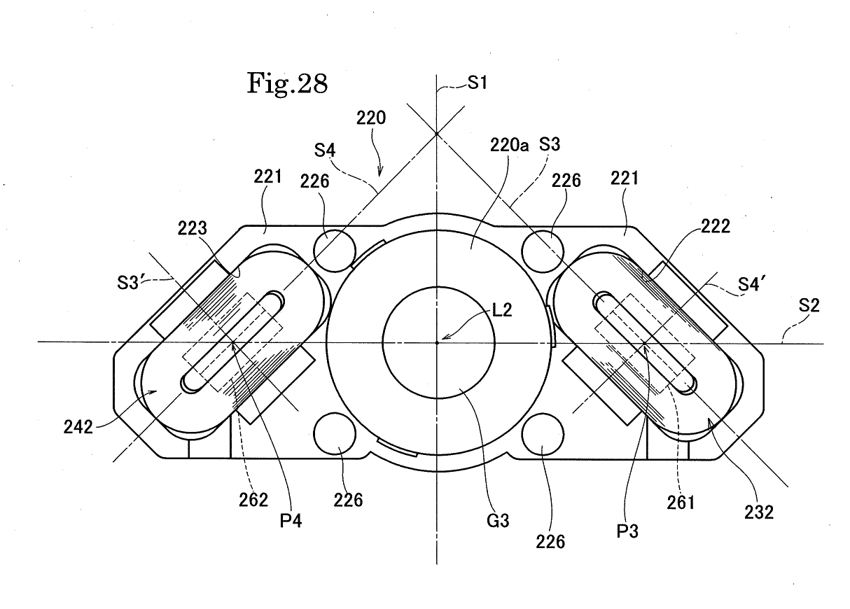

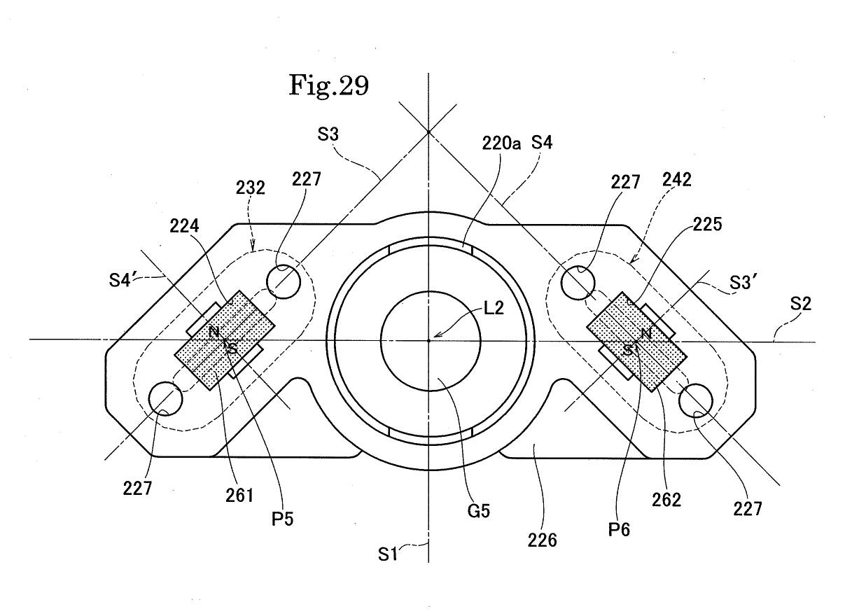

As shown in FIG. 28 and FIG. 29, the fitting concave portion 222 (and the fitting hole 224) is formed into a substantially rectangular shape that is long in a direction of a straight line S3 forming 45 degrees with the straight line S2 and narrow in a direction of a straight line S4′ vertical to the straight line S3.

As shown in FIG. 28 and FIG. 29, the fitting concave portion 223 (and the fitting hole 225) is formed into a substantially rectangular shape that is long in a direction of a straight line S4 forming 45 degrees with the straight line S2 and narrow in a direction of a straight line S3′ vertical to the straight line S4.

Further, the fitting concave portion 222 (and the fitting hole 224) and the fitting concave portion 223 (and the fitting hole 225) are formed to be line-symmetric with respect to the straight line S1 as shown in FIG. 28 and FIG. 29.

That is, a pair of the first coil 232 and the first return magnet 261 and a pair of the second coil 242 and the second return magnet 262 are arranged to be line-symmetric with respect to the straight line S1 on the movable holding member 220.

As shown in FIG. 28, the plurality of abutting surfaces 226 are arranged to be line-symmetric with respect to the straight lines S1 and S2, and they are formed into planar shapes each having a predetermined area in such a manner that they do not deviate from a state contacting with the corresponding convex portions 207 of the fixed frame 200 in the range that the movable holding member 220 two-dimensionally moves within a plane (a plane including the straight lines S1 and S2) vertical to the optical axis L2.

That is, when the movable holding member 220 is arranged to face the fixed frame 200 in such a manner that the four abutting surfaces 226 abut on the four convex portions 207, since the first drive magnet 231 fixed to the fixed frame 200 and the first return magnet 261 fixed to the movable holding member 220 magnetically attract each other and the second drive magnet 241 fixed to the fixed frame 200 and the second return magnet 262 fixed to the movable holding member 220 magnetically attract each other, the movable holding member 220 is supported to be movable within the plane vertical to the optical axis L2 without being separated from the fixed frame 200, and the movable holding member is two-dimensionally moved within the plane vertical to the optical axis L2 with respect to the fixed frame 200 by drive force of the first drive mechanism 230 and the second drive mechanism 240, thereby highly accurately correcting an image blur caused due to hand movement and the like.

Here, since the support mechanism is constituted of the plurality of convex portions 207 provided to the fixed frame 200 and the plurality of abutting surfaces 226 that are provided on the movable holding member 220 and abut on the convex portions 207 alone, simplification of the structure and a reduction in size of the device can be achieved.

Further, since the assembling can be carried out by just arranging the movable holding member 220 to face the fixed frame 200, simplification of an assembling operation and others can be achieved.

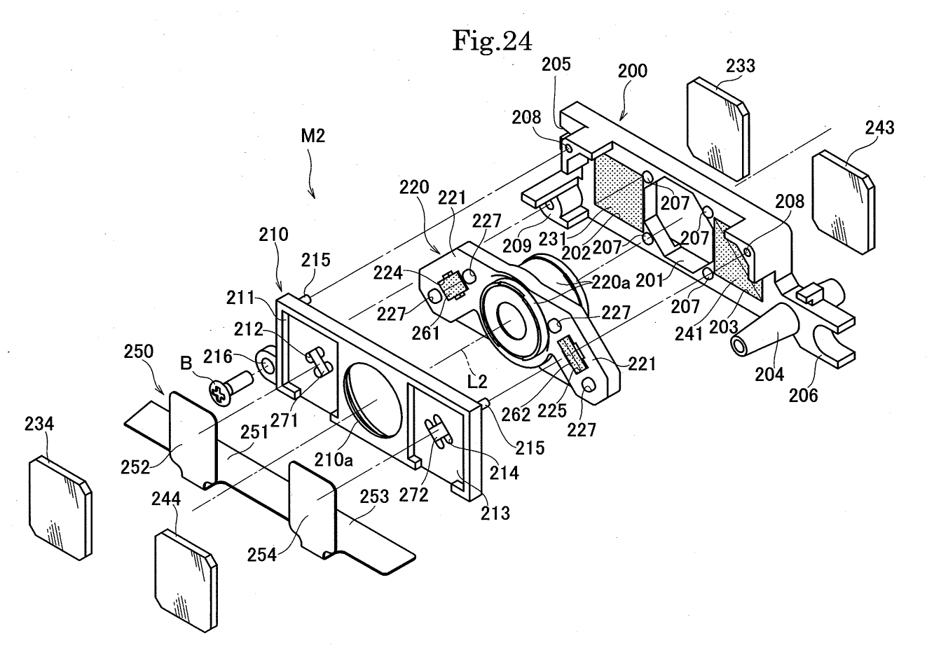

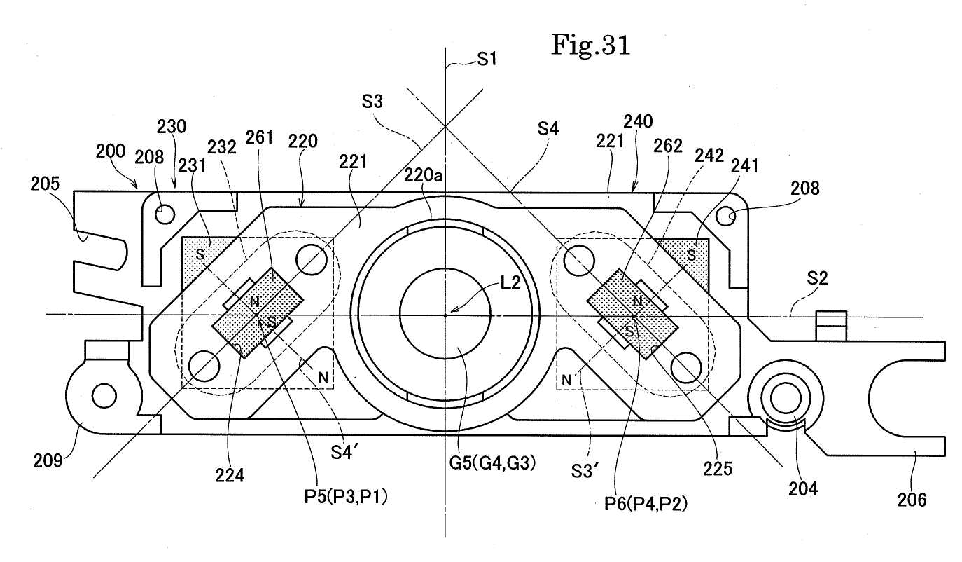

As shown in FIG. 24 to FIG. 26, FIG. 30, and FIG. 31, the first drive mechanism 230 is formed as a voice coil motor including the first drive magnet 231, the first coil 232, and the first yokes 233 and 234.

As shown in FIG. 30 and FIG. 31, the first drive magnet 231 is formed into a rectangular shape magnetized to have an N pole and an S pole with a surface running through the straight line S3 as a border, and it is fitted and fixed in the fitting concave portion 202 of the fixed frame 200. Furthermore, a center P1 of the first drive magnet 231 is arranged to be placed at an intersection of the straight line S2 and the straight line S3.

As shown in FIG. 28 to FIG. 31, the first, coil 232 is formed into a substantially elliptic annular shape having a major axis in the direction of the straight line S3 and a minor axis in the direction of the straight line S4′ as seen from the optical axis L2 direction, and it is fitted and fixed in the fitting hole 222 of the movable holding member 220 in such a manner that its center P3 overlaps the center P1 when the movable holding member, 220 is placed at a pause position.

Moreover, the first coil 232 is arranged in such a manner that its major axis forms an inclination angle of 45 degrees (its major axis becomes parallel to the straight line S3) with respect to the straight line S2 (an alignment direction of the cylindrical portion 220a and the extending portion 221).

As shown in FIG. 24 and FIG. 25, the first yoke 233 is formed into a rectangular flat plate-like shape that has an area equal to or above that of the first magnet 131, and it is fitted and fixed in the fitting hole 202′ of the fixed frame 200 while being contact with the first drive magnet 231.

The first yoke 234 is formed into a rectangular flat plate-like shape having an area equal to the first yoke 233 and fitted and fixed in the fitting concave portion 211 of the cover frame 210.

Further, the first drive mechanism 230 generates electromagnetic drive force in a first direction vertical to the optical axis L2, i.e., the direction of the straight line S4′ by turning on/off energization with respect to the first coil 232.

As shown in FIG. 24 to FIG. 26, FIG. 30, and FIG. 31, the second drive mechanism 240 is formed as a voice coil motor including the second drive magnet 241, the second coil 242, and the second yokes 243 and 244.

As shown in FIG. 30 and FIG. 31, the second drive magnet 241 is formed into a rectangular shape that is magnetized to have an N pole and an S pole with a surface running through the straight line S4 as a border, and it is fitted and fixed in the fitting concave portion 203 of the fixed frame 200. Additionally, the second drive magnet 241 is arranged in such a manner that its center P2 is placed at an intersection of the straight line S2 and the straight line S4.

As shown in FIG. 28 to FIG. 31, the second coil 242 is formed into a substantially elliptic annular shape having a major axis in the direction of the straight line S4 and a minor axis in the direction of the straight line S3′ as seen from the optical axis L2 direction, and it is fitted and fixed in the fitting hole 223 of the movable holding member 220 in such a manner that its center P4 overlaps the center P2 when the movable holding member 220 is placed at the pause position.

Further, the second coil 242 is arranged in such a manner that its major axis forms an inclination angle of 45 degrees (its major axis becomes parallel to the straight light S4) with respect to the second straight line S2 (an alignment direction of the cylindrical portion 220a and the extending portion 221).

The second yoke 243 is formed into a rectangular shape that has an area equal to or larger than an area of the second drive magnet 241, and it is fitted and fixed in the fitting hole 203′ of the fixed frame 200 while being in contact with the second drive magnet 241 as shown in FIG. 24 and FIG. 25.

The second yoke 244 is formed into a rectangular flat plate-like shape having an area equal to that of the second yoke 243, and fitted and fixed in the fitting concave portion 213 of the cover frame 210.

Furthermore, the second drive mechanism 240 is configured to generate electromagnetic drive force in the second direction vertical to the optical axis L2, i.e., the direction of the straight line S3′ by turning on/off energization with respect to the second coil 242.

As shown in FIG. 31, since the first drive mechanism 230 and the second drive mechanism 240 are arranged to be line-symmetric with respect to the straight line S1 perpendicular to the optical axis L2 of the lenses G3, G4, and G5 held by the movable holding member 220, drive loads imposed on the respective drive mechanisms are equal to each other, these drive mechanisms exercise drive forces on both sides of the lenses G3, G4, and G5, whereby the movable holding member 220 can be stably and smoothly driven within a plane vertical to the optical axis L2.

Moreover, since the first coil 232 and the second coil 242 are arranged in such a manner that each of their major axes forms a predetermined inclination angle (approximately 45 degrees) with respect to the straight line S2, when the movable holding member 220 has a shape that is long in the direction of the straight line S2, the dimension of the movable holding member 220 can be reduced in the direction of the straight line S1 by inclining the first coil 232 and the second coil 242 and, for example, a reduction in size and thickness of the device in the direction vertical to the optical axis L2 (the direction of the first straight line S1) can be achieved.

Additionally, since the movable holding member 220 is arranged in such a manner that the cylindrical portion 220a is inserted into the opening portion 201 of the fixed frame 200 and the opening portion 210a of the cover frame 210 and adjacently faces the fixed frame 200 and the cover frame 210, the thickness of the device can be reduced in the optical axis L2 direction even in case of holding the plurality of lenses G3, G4, and G5.

As shown in FIG. 24 and FIG. 25, the flexible wiring board 250 has a connecting portion 251 connected with the first coil 232 of the first drive mechanism 230, a connecting portion 252 connected with the first magnetic sensor 271, a connecting portion 253 connected with the second coil 242 of the second drive mechanism 240, and a connecting portion 254 connected with the second magnetic sensor 272, and it is bent and formed to be arranged around the fixed frame 200. Moreover, the flexible wiring board 250 is arranged in the unit case 10 in a bendable manner and electrically connected to the drive circuit 95 and the position detection circuit 96.

The first return magnet 261 functions as a return member, and it is magnetized to have an S pole and an N pole with a surface running through the straight line S3 as a border, formed into a substantially rectangular shape having a wide side in the direction of the straight line S3 and a narrow side in the direction of the straight line S4′ as seen from the optical axis L2 direction, and fitted and fixed in the fitting hole 224 of the movable holding member 220 in such a manner that its center P5 overlaps the centers P1 and P3 when the movable holding member 220 is placed at the pause position as shown in FIG. 24, FIG. 25, FIG. 29, and FIG. 31.

That is, the first return magnet 261 is arranged in such a manner that its wide side becomes substantially parallel to the major axis of the first coil 232 and forms an inclination angle of 45 degrees (the wide side becomes parallel to the straight line S3) with respect to the straight line S2 (an alignment direction of the cylindrical portion 220a and the extending portion 221).

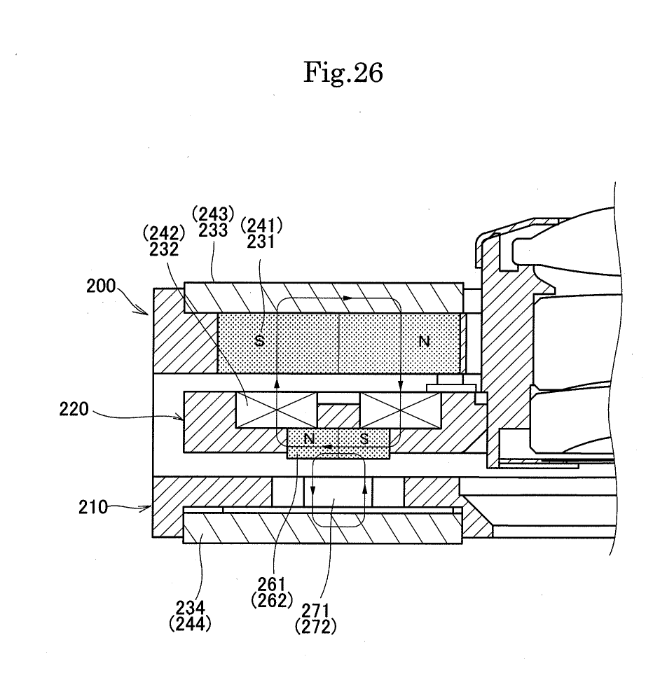

Furthermore, as shown in FIG. 26, the first return magnet 261 faces the first drive magnet 231 to form a magnetic path and exercise a magnetic function, returns the movable holding member 220 to the predetermined pause position (the position at which the optical axis L2 of the lenses G3, G4, and G5 coincides with the center of the opening portion 201 of the fixed frame 200 in this example) in a pause state that the first coil 232 is not energized, and generates stable holding force.

The second return magnet 262 functions as a return member, and it is magnetized to have an S pole and an N pole with a surface running through the straight line S4 as a border, formed into a substantially rectangular shape having a wide side in the direction of the straight line S4 and a narrow side in the direction of the straight line S3′ as seen from the optical axis L2 direction, and fitted and fixed in the fitting hole 225 of the movable holding member 220 in such a manner that its center P6 overlaps the centers P2 and P4 when the movable holding member 220 is placed at the pause position as shown in FIG. 24, FIG. 25, FIG. 29, and FIG. 31.

That is, the second return magnet 262 is arranged in such a manner that its wide side becomes substantially parallel to the major axis of the second coil 242 and forms an inclination angle of 45 degrees (the wide side becomes parallel to the straight line S4) with respect to the straight line S2 (an alignment direction of the cylindrical portion 220a and the extending portion 221).

Furthermore, as shown in FIG. 26, the second return magnet 262 faces the second drive magnet 241 to exercise a magnetic function, returns the movable holding member 220 to the predetermined pause position (the position at which the optical axis L2 of the lenses G3, G4, and G5 coincides with the center of the opening portion 201 of the fixed frame 200 in this example) in a pause state that the second coil 242 is not energized, and generates stable holding force.

As described above, in the pause state, the movable holding member 220 (the lenses G3, G4, and G5) is automatically returned (centered) to and stably held at the predetermined pause position (the position at which the optical axis L2 of the lenses G3, G4, and G5 coincides with the center of the opening portion 201 of the fixed frame 200) by a magnetic attractive function between the first return magnet 261 and the second return magnet 262 as the return means and the first drive magnet 231 and the second drive magnet 241 as the driving means. Therefore, drive control such as initialization is not required at the time of driving, and wobble and the like of the movable holding member 220 can be avoided in the pause state. Moreover, both the first drive magnet 231 and the second drive magnet 241 as the driving means are used in order to exert a mutual function with the first return magnet 261 and the second return magnet 262 as the return means, thereby achieving simplification of the structure, a reduction in size of the device, and others.

Additionally, since the wide side of the first return magnet 261 and the major axis of the first coil 232 are arranged to become substantially parallel to each other and the wide side of the second return magnet 262 and the major axis of the second coil 242 are arranged to become substantially parallel to each other, force that prevents the movable holding member 220 from rotating on the optical axis L2 is exercised by the mutual function of the magnetic force of the return magnets 261 and 262 and the magnetic force of the drive magnets 231 and 241 at the time of driving (at the time of energizing the first coil 232 and the second coil 242), a large moment that suppresses the rotation of the movable holding member 220 can be obtained by forming the return magnets 261 and 262 so as to have wide sides in a direction of a magnetizing border, and the movable holding member 220 can be rapidly moved within the plane vertical to the optical axis L2 and highly accurately positioned at a desired position.

Each of the first magnetic sensor 271 and the second magnetic sensor 272 is, e.g., a hall element that detects a change in magnetic flux density and outputs it as an electric signal, and it is fitted and fixed in the fitting hole 212 or 214 of the cover frame 210 as shown in FIG. 24 to FIG. 26. Here, in the movement range of the movable holding member 220, the first magnetic sensor 271 is arranged at a position where it faces the first return magnet 261, and the second magnetic sensor 272 is arranged at a position where it faces the second return magnet 262.

As shown in FIG. 26, the first magnetic sensor 271 forms a magnetic circuit between itself and the first return magnet 261 provided to the movable holding member 220, and it is configured to detect a position of the movable holding member 220 by detecting a change in magnetic flux density caused when (the first return magnet 261 of) the movable holding member 220 relatively moves with respect to the fixed frame 200 and the cover frame 210.

As shown in FIG. 26, the second magnetic sensor 272 forms a magnetic circuit between itself and the second return magnet 262 provided to the movable holding member 220, and it is configured to detect a position of the movable holding member 220 by detecting a change in magnetic flux density caused when (the second return magnet 262 of) the movable holding member 220 relatively moves with respect to the fixed frame 200 and the cover frame 210.

As described above, since the first magnetic sensor 271 and the second magnetic sensor 272 are fixed to the fixed frame 200 through the cover frame 210, wiring is easier than that in a case where these sensors are provided to the movable holding member 220, disconnection and the like involved by movement can be avoided, and simplification of the structure, a reduction in number of components an in size of the device, and others can be achieved as compared with a case where a dedicated magnet is provided since both the first return magnet 261 and the second return magnet 262 are used for positional detection.

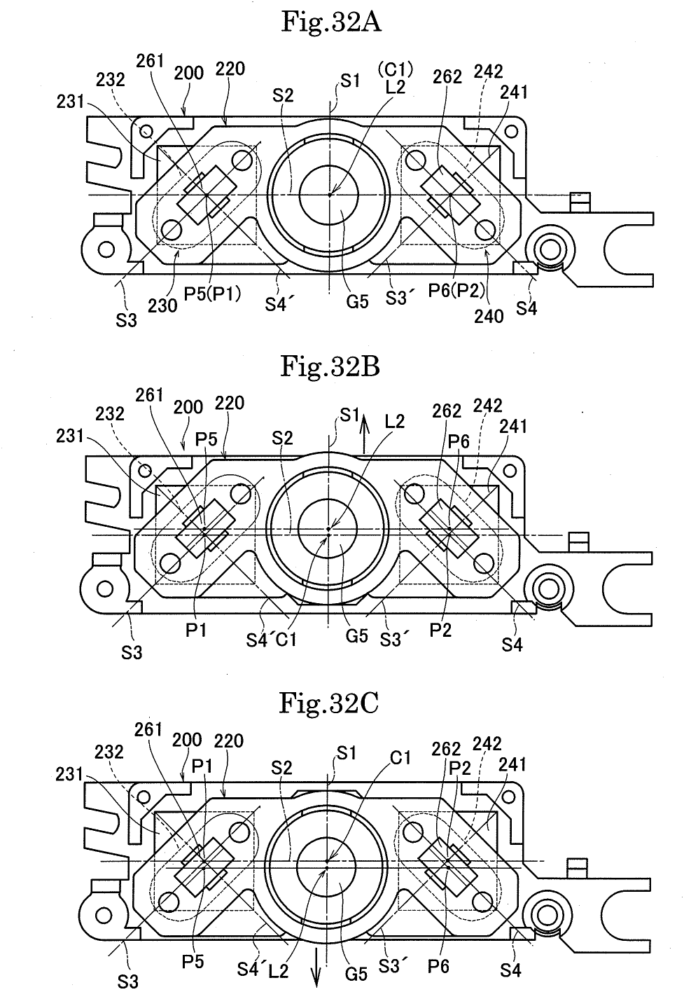

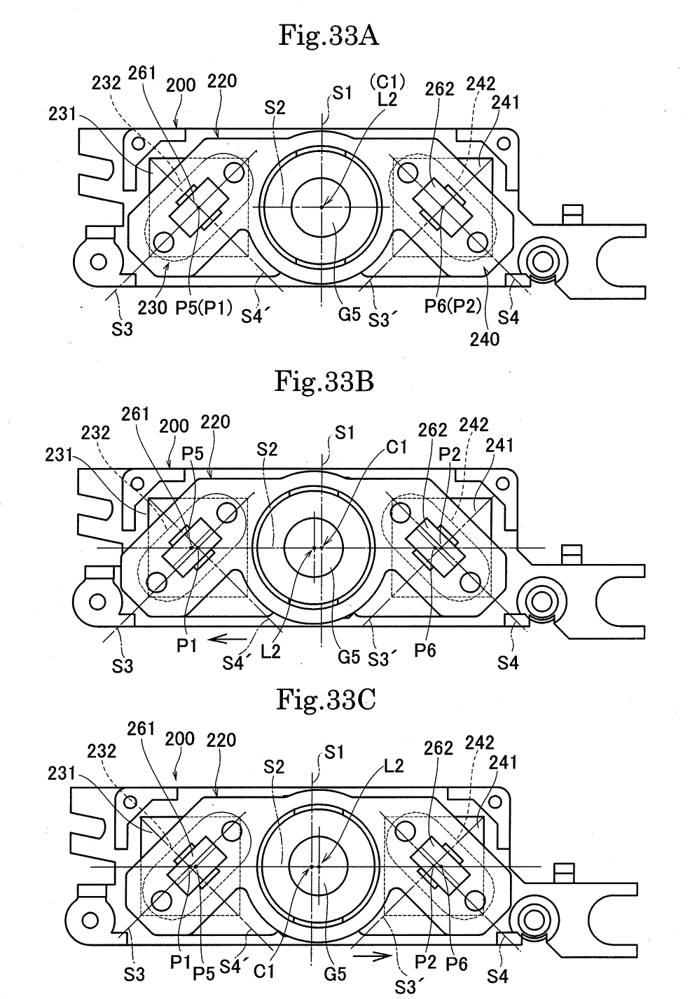

A correcting operation of the image blur correction device M2 will now be briefly described with reference to FIG. 32A to FIG. 33C.

First, as shown in FIG. 32A, in the pause state that the first coil 232 and the second coil 242 are not energized, the movable holding member 220 is returned (centered) to and held at the pause position where the optical axis L2 of the lenses G3, G4, and G5 coincides with the center C1 of the opening portion 201 of the fixed frame 200 by a return function of the return means (the first return magnet 261 and the second return magnet 262).

Further, for example, when upwardly shifting the movable holding member 220 (the lenses G3, G4, and G5) from the pause state depicted in FIG. 32A, the first drive mechanism 230 is operated to generate drive force in an obliquely upward direction of the first direction (the direction of the straight line S4′), and the second drive mechanism 240 is operated to generate drive force in an obliquely upward direction of the second direction (the direction of the straight line S3′). As a result, as shown in FIG. 32B, the movable holding member 220 is moved in an upward direction of the straight line S1.

Furthermore, for example, when downwardly shifting the movable holding member 220 (the lenses G3, G4, and G5) from the pause state depicted in FIG. 32A, the first drive mechanism 230 is operated to generate drive force in an obliquely downward direction of the first direction (the direction of the straight line S4′), and the second drive mechanism 240 is operated to generate drive force in an obliquely downward direction of the second direction (the direction of the straight line S3′). As a result, as shown in FIG. 32C, the movable holding member 220 is moved in a downward direction of the straight line S1.

Subsequently, as shown in FIG. 33A, for example, when shifting the movable holding member 220 (the lenses G3, G4, and G5) toward a left-hand side from the pause state that the movable holding member 220 has been returned to the pause position at which the optical axis L2 of the lenses G3, G4, and G5 coincides with the center C1 of the opening portion 201 of the fixed frame 200 by the return function of the return means (the first return magnet 261 and the second return magnet 262), the first drive mechanism 230 is operated to generate drive force in the obliquely upward direction of the first direction (the direction of the straight line S4′), and the second drive mechanism 240 is operated to generate drive force in the obliquely downward direction of the second direction (the direction of the straight line S3′). As a result, as shown in FIG. 33B, the movable holding member 220 is moved toward the left-hand side of the direction of the straight line S2.

Moreover, for example, when shifting the movable holding member 220 (the lenses G3, G4, and G5) toward a right-hand side from the pause state depicted in FIG. 33A, the first drive mechanism 230 is operated to generate drive force in the obliquely downward direction of the first direction (the direction of the straight line S4′), and the second drive mechanism 240 is operated to generate drive force in the obliquely upward direction of the second direction (the direction of the straight line S3′). As a result, as shown in FIG. 33C, the movable holding member 220 is moved toward the right-hand side of the direction of the straight line S2.

As described above, the movable holding member 220 is movably supported by the support mechanism (the convex portions 207 and the abutting surfaces 226), and it is two-dimensionally moved within the plane vertical to the optical axis L2 with respect to the base (the fixed frame 200 and the cover frame 210) in this state by the electromagnetic drive force generated by energization of the first coil 232 and the second coil 242 in cooperation with the first drive magnet 231 and the second drive magnet 242, thereby highly accurately correcting an image blur caused due to, e.g., hand movement.

Here, when the movable holding member 220 is placed at the pause position, since it is arranged in such a manner that the center P5 of the first return magnet 261 substantially coincides with the center P1 of the first drive magnet 231 as seen from the optical axis L2 direction and the center P6 of the second return magnet 262 substantially coincides with the center P2 of the second drive magnet 241 as seen from the optical axis L2 direction, the return magnet 261 (262) can face the drive magnet 231 (241) at well balanced positions, the intensive magnetic attractive function can be obtained between the return magnet 261 (262) and the drive magnet 231 (241), and the movable holding member 220 (the lenses G3, G4, and G5) can be thereby automatically returned to and stably held at a predetermined pause position (a position at which the optical axis L2 coincides with the center C1 of the opening portion 201.

In the foregoing embodiment, although the configuration that each of the first coil 232 and the second coil 242 is formed into the substantially elliptic annular shape has been described, this “substantially elliptic annular shape” is a concept including a substantially rectangular annular shape consisting of wide sides (major axes) and narrow sides (minor axes) including straight line portions besides the elliptic annular shape.

In the foregoing embodiment, although each of the first magnetic sensor 271 and the second magnetic sensor 272 consisting of the hall element has been described as the position detecting means, the present invention is not limited thereto, and any other magnetic sensor may be adopted.

In the foregoing embodiment, although the description has been given as to the example where the configuration that the plurality of convex portions 207 are provided on the fixed frame 200 and the plurality of abutting surfaces 226 are provided on the movable holding member 220 is adopted as the support mechanism that supports the movable holding member, the present invention is not limited thereto, and a configuration that the plurality of abutting surfaces are provided on the fixed frame and the plurality of convex portions are provided on the movable holding member may be adopted as a reverse pattern, and the present invention may be adopted in a configuration including any other support mechanism.

In the foregoing embodiment, although the image blur correction device applied to the camera unit U mounted in a personal digital assistance has been described, a configuration including the image blur correction device having the above structure may be adopted in an imaging lens unit including a plurality of lenses for imaging.

As a result, when the configuration where the plurality of lenses for imaging are arranged in the optical axis direction includes the above-described image blur correction device, the correction lenses G3, G4, and G5 held by the movable holding member 220 are appropriately driven, and an image blur caused due to hand movement and others can be smoothly and highly accurately corrected. That is, the imaging lens unit having the image bur correcting function in addition to the plurality of lenses for imaging can be provided.

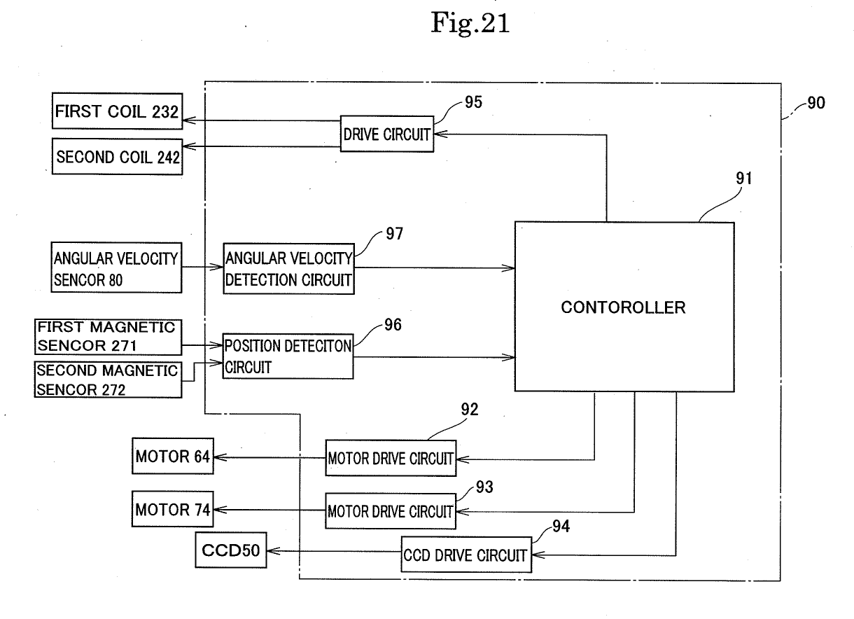

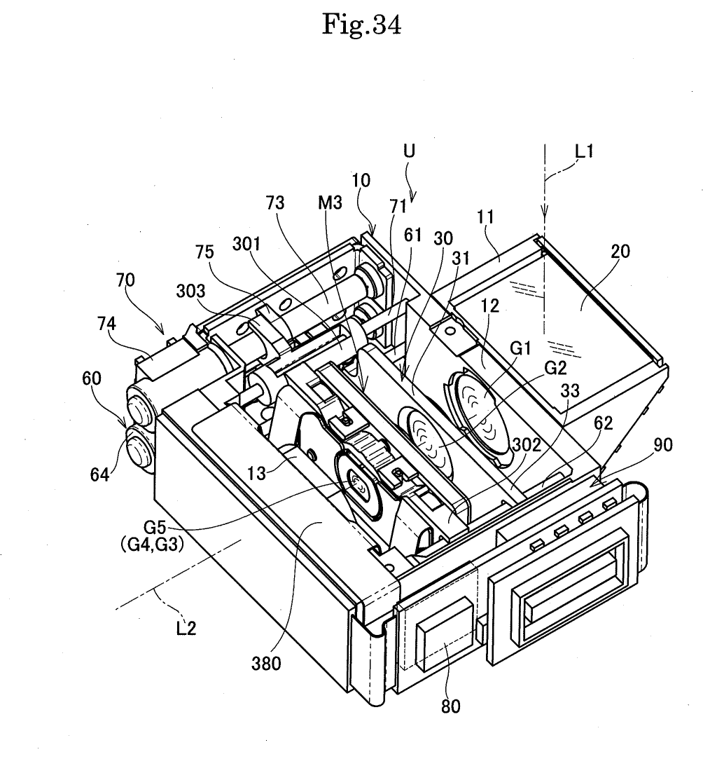

FIG. 34 to FIG. 48 show an image blur correction device M3 according to a third embodiment. As shown in FIG. 34 to FIG. 36, this image blur correction device M3 is incorporated in the same camera unit U as that described above, and it includes such a control unit 90 as depicted in FIG. 21.

As shown in FIG. 34 and FIG. 37 to FIG. 39, the image blur correction device M3 according to this embodiment includes a base 300, a movable holding member 310, a first drive mechanism 320 (including a first coil 321 and a first drive magnet 322) as a driving means, a second drive mechanism 330 (including a second coil 331 and a second drive magnet 332) as a driving means, yokes 341 and 342 included in the driving means, three spheres 350 as a support mechanism that movably supports the movable holding member 310 within a plane vertical to an optical axis L2, first return magnets 361 and second return magnets 362 as a return means (return members), a first magnetic sensor 371 and a second magnetic sensor 372 as a position detecting means, a flexible wiring board 380 that performs electrical connection, and others.

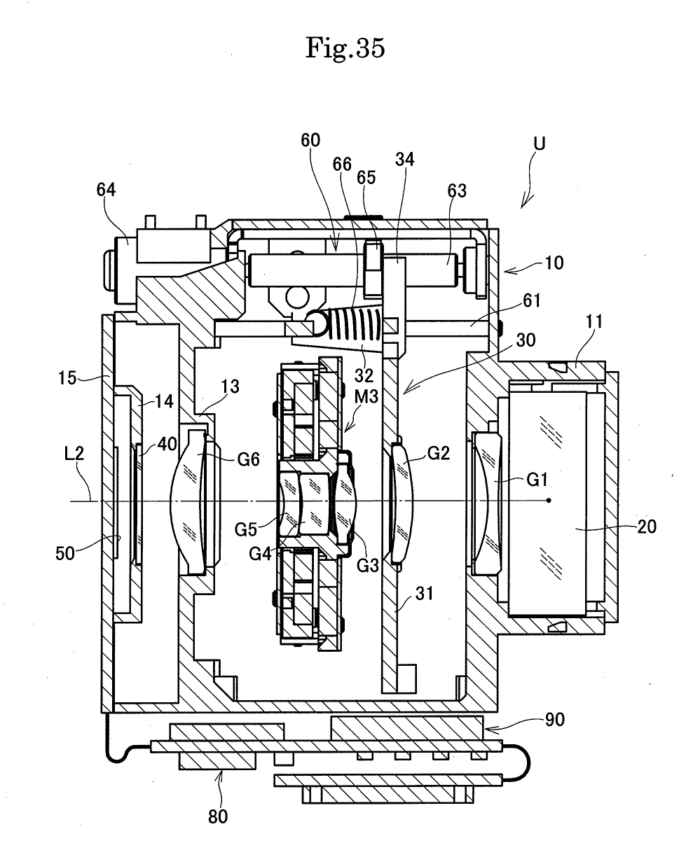

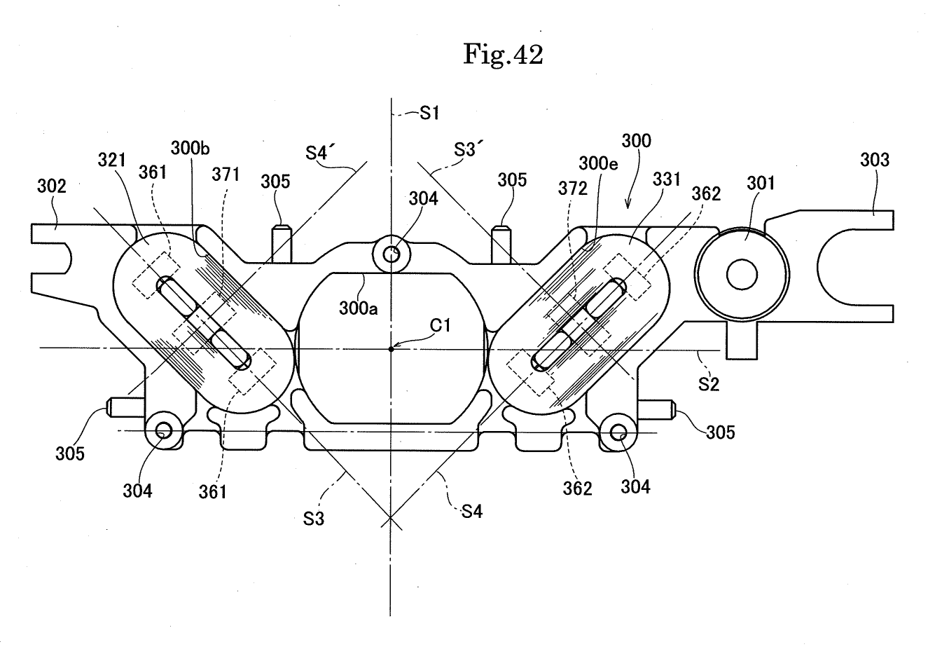

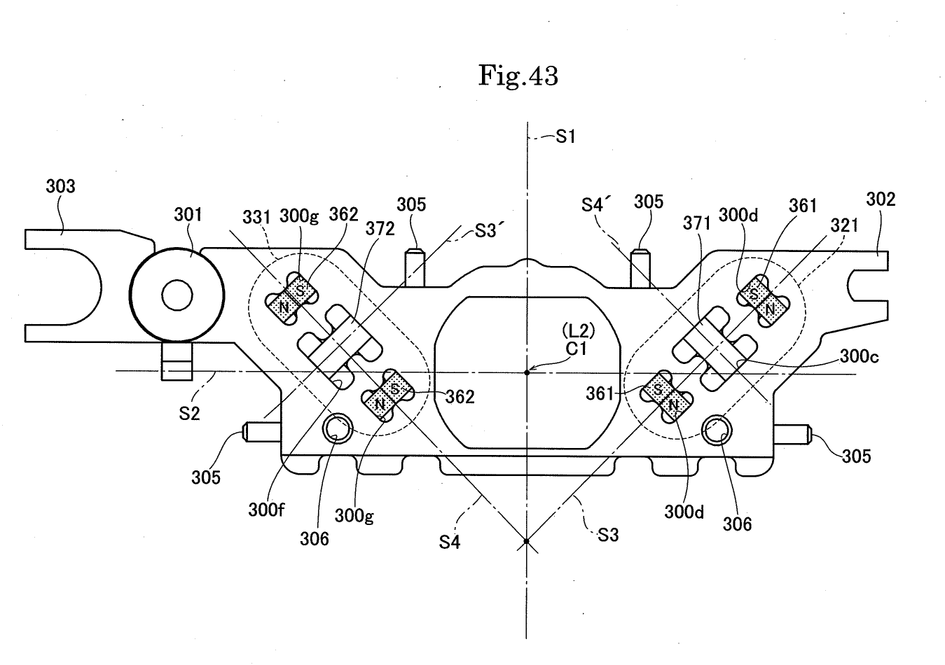

As shown in FIG. 35 to FIG. 39, FIG. 42, and FIG. 43, the base 300 is formed into a substantially rectangular flat plate-like shape that is substantially flat in an optical axis L2 direction, narrow in a direction of a straight line S1 perpendicular to the optical axis L2 and parallel to an optical axis L1, and long in a direction of a straight line S2 perpendicular to the optical axis L2 and the straight line S1, and it includes an opening portion 300a with the optical axis L2 at the center, a fitting concave portion 300b in which the first coil 321 is fitted and fixed, a fitting concave portion 300c in which the first magnetic sensor 371 is fitted and fixed, fitting concave portions 300d in which the first return magnets 361 are fitted and fixed, a fitting concave portion 300e in which the second coil 331 is fitted and fixed, a fitting concave portion 300f in which the second magnetic sensor 372 is fitted and fixed, fitting concave portions 300g in which the second return magnets 362 are fitted and fixed, a guided portion 301 that is slidably engaged with and guided by a guide shaft 71, a regulated portion 302 that is slidably engaged with an antirotation shaft 62 to regulate its rotation on the optical axis L2, an U-shaped engagement portion 303 with which a nut 75 having a lead screw 73 screwed therein comes into contact, three concave portions 304 that receives the spheres 350 as the support mechanism, four coupling pins 305 that movably couple the movable holding member 310, two screw holes 306 configured to fix the yoke 341 by using screws B.

As shown in FIG. 42 and FIG. 43, the opening portion 300a is formed with an inner diameter dimension that enables defining a center C1 at an intersection of the straight line S1 and the straight line S2 and also defining an inner wall surface parallel to the direction of the straight line S1 and allowing a cylindrical portion 310a of the movable holding member 310 to pass therethrough in a contactless manner in the range that the movable holding member 310 is driven.

The fitting concave portions 300b, 300c, and 300d and the fitting concave portions 300e, 300f, and 300g are formed to be line-symmetric with respect to the straight line S1 as shown in FIG. 42 and FIG. 43. That is, a set of the first coil 321, the first return magnets 361, and the first magnetic sensor 371 and a set of the second coil 331, the second return magnets 362, and the second magnetic sensor 372 are arranged to be line-symmetric with respect to the straight line S1 on the base 300.

The three concave portions 304 are formed to receive the spheres 350 while allowing their rolling movement in a state that the spheres 305 partially protrude in the optical axis L2 direction. Further, in regard to an arrangement configuration of the three concave portions 304, as shown in FIG. 42, one concave portion 304 is arranged on the straight line S1 near the opening portion 300a, and the other two concave portions 304 are arranged at line-symmetric positions with respect to the straight line S1. That is, the three concave portions 304 are arranged to be placed at three vertices of an isosceles triangle.

Each of the coupling pins 305 is formed into a cylindrical shape to be inserted into a coupling notch portion 315 and a coupling long hole portion 316 of the movable holding member 310. It is to be noted that the coupling pin 305 is fitted and fixed at the time of assembling.

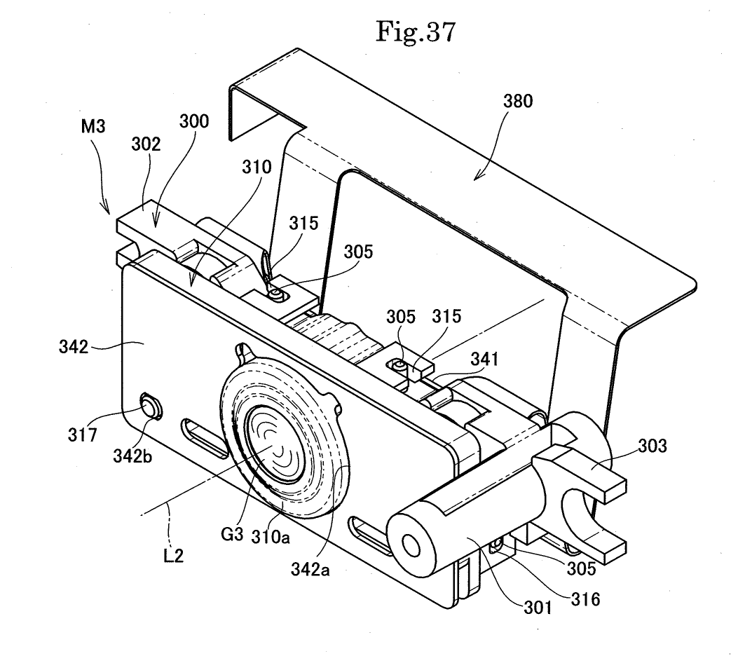

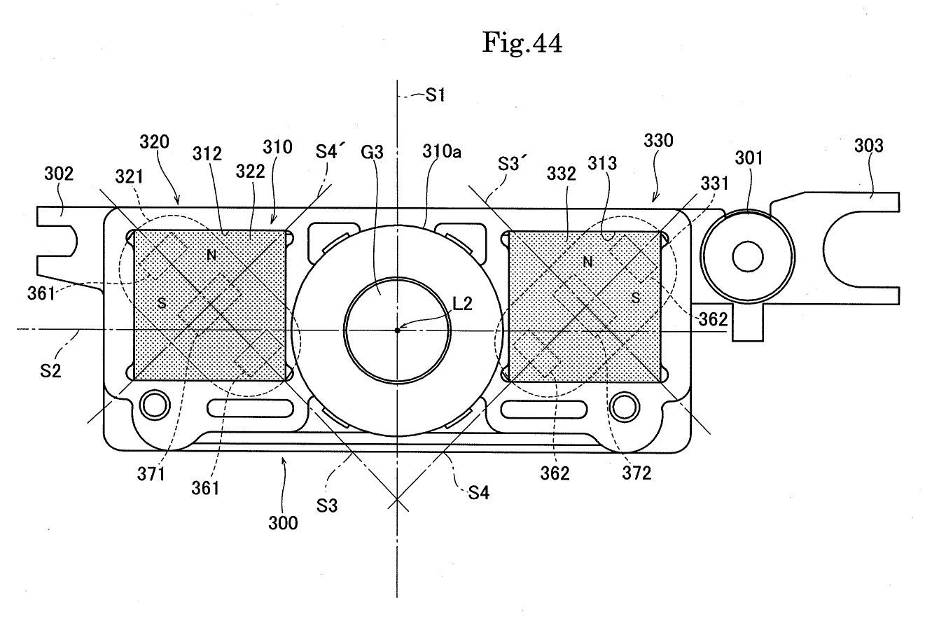

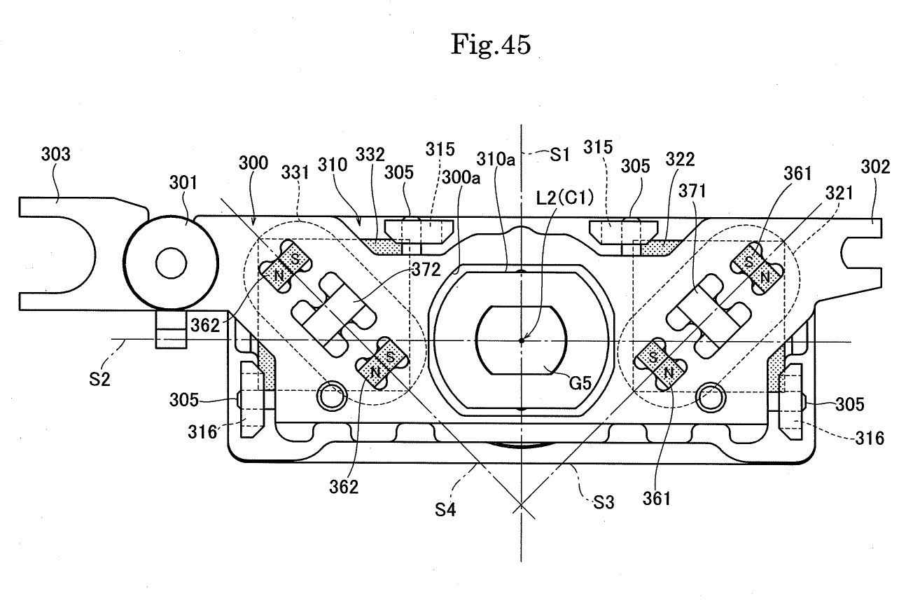

As shown in FIG. 37 to FIG. 41, FIG. 44, and FIG. 45 the movable holding member 310 is formed into a substantially rectangular flat plate-like shape that is substantially flat in the optical axis L2 direction except a part, narrow in the direction of the straight line S1, and long in the direction of the straight line S2, and it includes the cylindrical portion 310a configured to hold lenses G3, G4, and G5 with the optical axis L2 at the center, two extending portions 311 extending to both sides of the straight line S2 direction to sandwich the cylindrical portion 310a, a fitting hole 312 in which the first drive magnet 322 is fitted and fixed, a fitting hole 313 in which the second drive magnet 332 is fitted and fixed, three abutting surfaces 314 abutting on the three spheres 350 as the support mechanism, the two coupling notch portions 315 and the two coupling long hole portions 316 into which the four coupling pins 305 are inserted, respectively, two positioning protrusions 317 for positioning the yoke 342, and others.

The cylindrical portion 310a is formed into a cylindrical shape that is flat in the direction of the straight line S1 so as to hold the lenses G3, G4, and G5 having parallel cut planes in the direction of the straight line S1 therein.

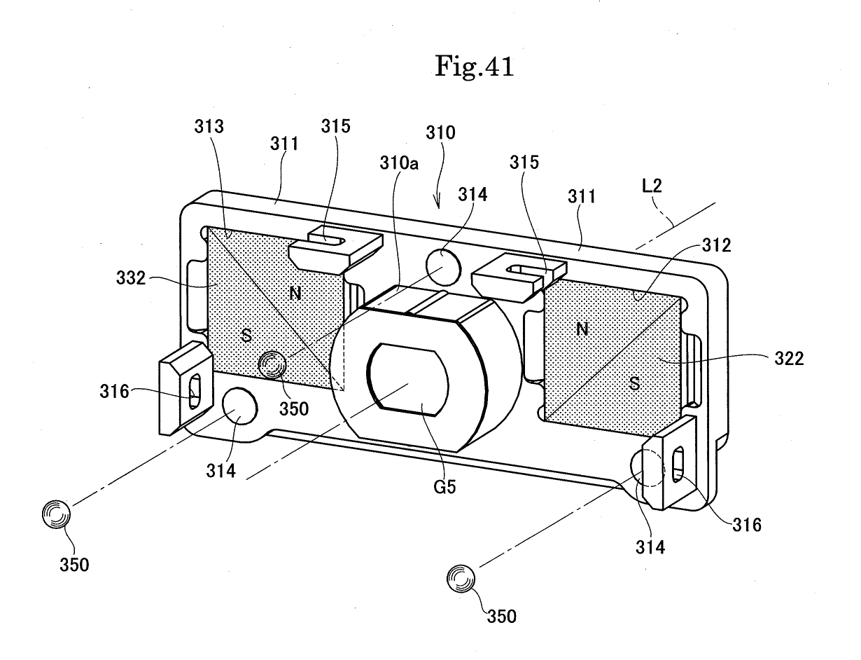

As shown in FIG. 41, the three abutting surfaces 314 are arranged to face the three concave portions 304 (the spheres 350) in the optical axis L2 direction in a state that the optical axis L2 of the lenses G3, G4, and G5 coincides with the center C1 of the opening portion 300a of the base 300, and the abutting surfaces are formed into planar shapes each having a predetermined area in such a manner that they do not deviate from a state contacting with the spheres 350 inserted in the corresponding concave portions 304 of the base 300 in the range that the movable holding member 310 two-dimensionally moves within a plane (a plane including the straight lines S1 and S2) vertical to the optical axis L2.

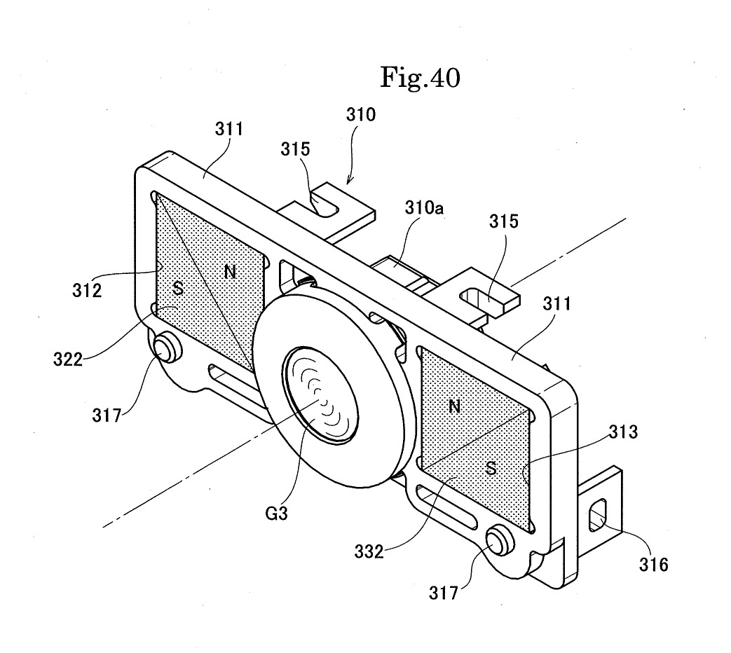

As shown in FIG. 40, FIG. 41, and FIG. 45, the coupling notch portions 315 are formed to extend in a direction parallel to the straight line S2 vertical to the optical axis L2 and to be opened toward the outside of the straight line S2 direction, and configured to slidably receive the coupling pins 305.

As shown in FIG. 41 and FIG. 45, the coupling long hole portions 316 are formed to extend in a direction parallel to the straight line S1 vertical to the optical axis L2 and configured to slidably receive the coupling pins 305.

That is, when the movable holding member 310 is arranged to face the base 300 in such a manner that the three abutting surfaces 314 abut on the three spheres 350, since the first return magnets 361 fixed to the base 300 and the first drive magnet 322 fixed to the movable holding member 310 magnetically attract each other and the second return magnets 362 fixed to the base 300 and the second drive magnet 332 fixed to the movable holding member 310 magnetically attract each other, the movable holding member 310 is supported to be movable within the plane vertical to the optical axis L2 without being separated from the base 300, and the movable holding member 310 is regulated from being separated in the optical axis L2 direction by inserting the coupling pins 305 into the coupling notch portions 315 and the coupling long hole portions 316, whereby the movable holding member 310 is supported to be movable within a plane vertical to the optical axis L2 (a plane including the straight lines S1 and S2) with respect to the base 300.

Further, the movable holding member 310 is two-dimensionally moved within the plane with respect to the base 300 by drive force of the first drive mechanism 320 and the second drive mechanism 330, thereby highly accurately correcting an image blur caused due to hand movement and others.

Here, since the support mechanism is constituted of the three spheres 350 inserted in the three concave portions 304 provided on the base 300 and the three abutting surfaces 314 that are provided on the movable holding member 310 and abut on the three spheres 350 alone, simplification of the structure and a reduction in size of the device can be achieved. Further, since the movable holding member 310 can be prevented from being separated by the mutual magnetic attractive force of the return magnets 361 and 362 and the drive magnets 322 and 332 and an engagement relationship between the coupling pins 305 and the coupling notch portions 315, wasteful drive force is not required as compared with a case that the urging force of a spring is utilized to prevent separation like conventional examples, thereby driving the movable holding member 310 in a balanced manner.

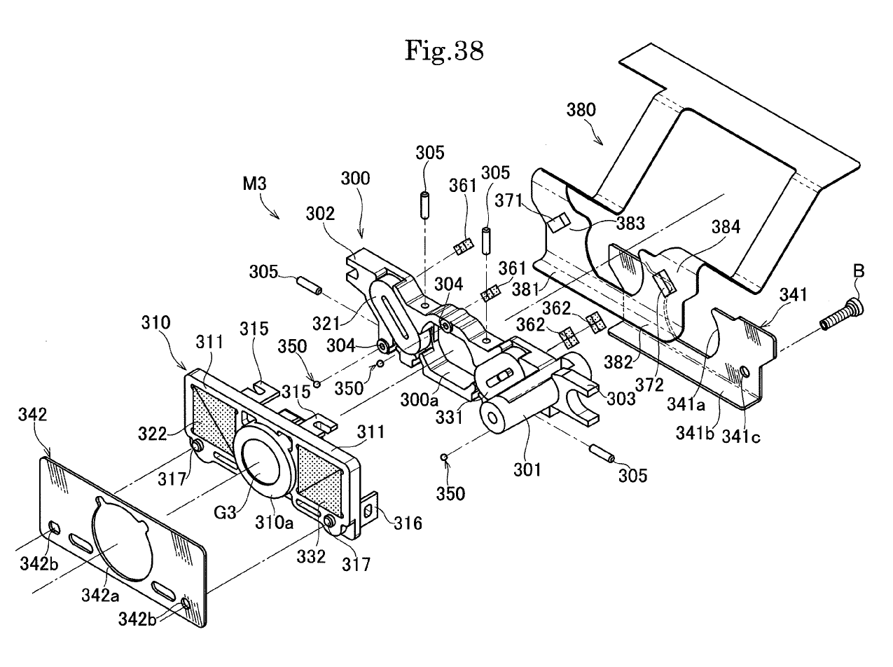

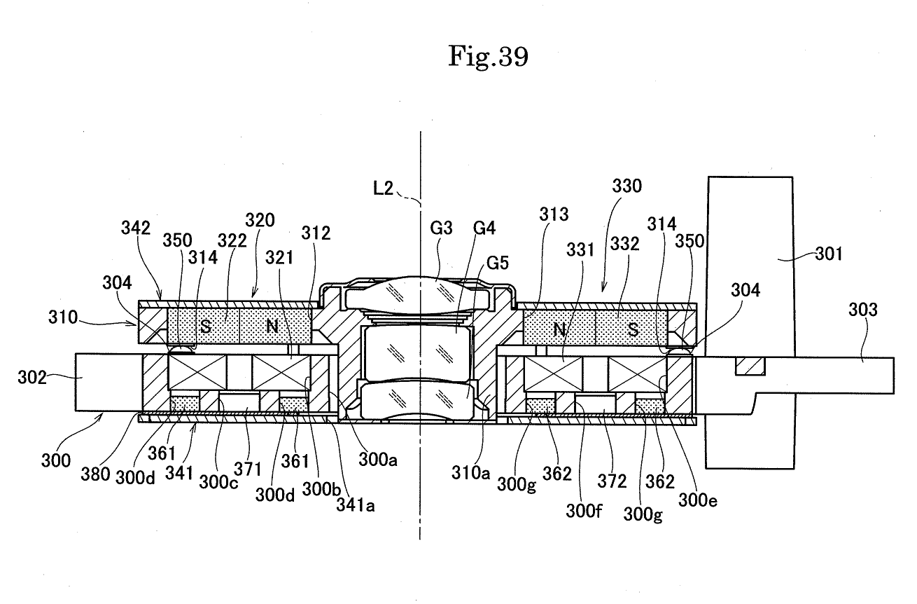

As shown in FIG. 38, FIG. 39, FIG. 44, and FIG. 45, the first drive mechanism 320 is formed as a voice coil motor including the first coil 321 and the first drive magnet 322.

As shown in FIG. 42 to FIG. 45, the first coil 321 is formed into a substantially elliptic annular shape having a major axis in the direction of the straight line S3 and a minor axis in the direction of the straight line S4′ as seen from the optical axis L2 direction, and it is fitted and fixed in the fitting concave portion 300b of the base 300.

Moreover, the first coil 321 is arranged in such a manner that its major axis forms an inclination angle of 45 degrees (its major axis becomes parallel to the straight line S3) with respect to the straight line S2.

As shown in FIG. 44 and FIG. 45, the first drive magnet 322 is formed into a rectangular shape that is magnetized to have an N pole and an S pole with a surface running through the straight line S3 as a border, and it is fitted and fixed in the fitting hole 312 of the movable holding member 310.

Additionally, the first drive mechanism 320 generates electromagnetic drive force in a first direction vertical to the optical axis L2, i.e., the direction of the straight line S4′ by turning on/off energization with respect to the first coil 321.

As shown in FIG. 38, FIG. 39, FIG. 44, and FIG. 45, the second drive mechanism 330 is formed as a voice coil motor including the second coil 331 and the second drive magnet 332.

As shown in FIG. 42 to FIG. 45, the second coil 331 is formed into a substantially elliptic annular shape having a major axis in the direction of the straight line S4 and a minor axis in the direction of the straight line S3′ as seen from the optical axis L2 direction, and it is fitted and fixed in the fitting concave portion 300e of the base 300.

Moreover, the second coil 331 is arranged in such a manner that its major axis forms an inclination angle of 45 degrees (its major axis becomes parallel to the straight line S4) with respect to the straight line S2.

As shown in FIG. 44 and FIG. 45, the second drive magnet 332 is formed into a rectangular shape that is magnetized to have an N pole and an S pole with a surface running through the straight line S4 as a border, and it is fitted and fixed in the fitting hole 313 of the movable holding member 310.

Additionally, the second drive mechanism 330 generates electromagnetic drive force in a second direction vertical to the optical axis L2, i.e., the direction of the straight line S3′ by turning on/off energization with respect to the second coil 331.

As shown in FIG. 38 and FIG. 39, the yoke 341 is formed into a substantially rectangular plate-like shape, and it is also formed to include a notch portion 341a having substantially the same shape as the opening portion 300a, a bent portion 341b, and two screw holes 341c.

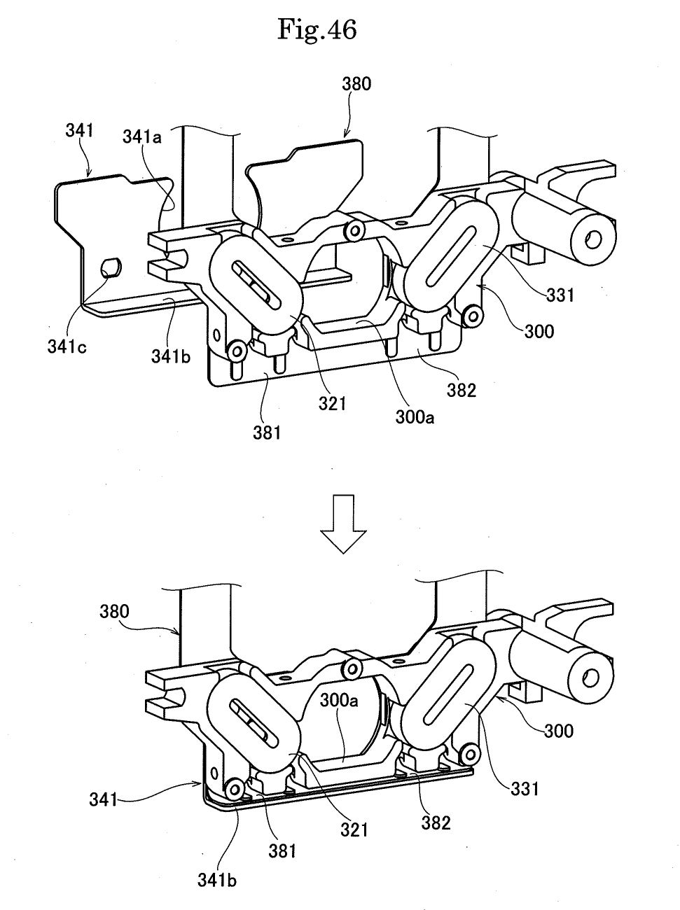

Further, as shown in FIG. 46, the yoke 341 is arranged to be adjacent to a back surface of the flexible wiring board 380 in order to sandwich, bend, and fix the flexible wiring board 380, and it is detachably fixed to the base 300 by using the screw B.

As shown in FIG. 37 to FIG. 39, the yoke 342 is formed into a substantially rectangular plate-like shape, and it is also formed to include a circular opening portion 342a that receives the cylindrical portion 310a and two fitting holes 342b in which the positioning protrusions 317 are fitted.

Furthermore, the yoke 342 is secured to a front surface of the movable holding member 310 (and the first drive magnet 322 and the second drive magnet 332) by using, e.g., an adhesive while fitting the positioning protrusions 317 into the fitting holes 342b.

As described above, providing the yokes 341 and 342 included in a part of the driving means enables preventing magnetic force lines generated by the first drive mechanism 320 and the second drive mechanism 330 from leaking to the outside, thereby improving magnetic efficiency.

As shown in FIG. 44, since the first drive mechanism 320 and the second drive mechanism 330 are arranged to be line-symmetric with respect to the straight line S1 perpendicular to the optical axis L2 of the lenses G3, G4, and G5 held by the movable holding member 310, drive loads imposed on the respective drive mechanisms are equal to each other, these drive mechanisms exercise drive forces on both sides of the lenses G3, G4, and G5, whereby the movable holding member 310 can be stably and smoothly driven within a plane vertical to the optical axis L2.

Moreover, since the first coil 321 and the second coil 331 are arranged in such a manner that each of their major axes forms the predetermined inclination angle (approximately 45 degrees) with respect to the straight line S2, when the movable holding member 310 has a shape that is long in the direction of the straight line S2, the dimension of the movable holding member 310 can be reduced in the direction of the straight line S1 by inclining the first coil 321 and the second coil 331 and, for example, a reduction in size and thickness of the device in the direction vertical to the optical axis L2 (the direction of the first straight line S1) can be achieved.

The first return magnet 361 functions as a return member, and it is formed into a substantially rectangular shape as seen from the optical axis L2 direction, magnetized to have an S pole and an N pole with a surface running through the straight line S3 as a border, and fitted and fixed in each of the two fitting concave portions 300d of the base 300 to sandwich the first magnetic sensor 371 in the direction of the straight line S3 as shown in FIG. 39 and FIG. 43.

That is, the two first return magnets 361 form an inclination angle of 45 degrees with respect to the straight line S2 and are aligned on the straight line S3 so as to become substantially parallel to the major axis of the first coil 321.

Furthermore, the first return magnets 361 face the first drive magnet 322 to form a magnetic path and exercise a magnetic function, return the movable holding member 310 to the predetermined pause position (the position at which the optical axis L2 of the lenses G3, G4, and G5 coincides with the center C1 of the opening portion 300a of the base 300 in this example) in a pause state that the first coil 321 is not energized, and generate stable holding force.

The second return magnet 362 functions as a return member, and it is formed into a substantially rectangular shape as seen from the optical axis L2 direction, magnetized to have an S pole and an N pole with a surface running: through the straight line S4 as a border, and fitted and fixed in each of the two fitting concave portions 300g of the base 300 to sandwich the second magnetic sensor 372 in the direction of the straight line S4 as shown in FIG. 39 and FIG. 43.

That is, the two second return magnets 362 form an inclination angle of 45 degrees with respect to the straight line S2 and are aligned on the straight line S4 so as to become substantially parallel to the major axis of the second coil 331.

Furthermore, the second return magnets 362 face the second drive magnet 332 to form a magnetic path and exercise a magnetic function, return the movable holding member 310 to the predetermined pause position (the position at which the optical axis L2 of the lenses G3, G4, and G5 coincides with the center C1 of the opening portion 300a of the base 300 in this example) in a pause state that the second coil 331 is not energized, and generate stable holding force.

As described above, in the pause state, the movable holding member 310 (the lenses G3, G4, and G5) is automatically returned (centered) to and stably held at the predetermined pause position (the position at which the optical axis L2 of the lenses G3, G4, and G5 coincides with the center C1 of the opening portion 300a of the base 300) by a magnetic attractive function between the first return magnets 361 and the second return magnets 362 as a return means and the first drive magnet 322 and the second drive magnet 332 as a driving means. Therefore, drive control such as initialization is not required at the time of driving, and wobble and the like of the movable holding member 310 can be avoided in the pause state. Moreover, both the first drive magnet 322 and the second drive magnet 332 as the driving means are used in order to exert a mutual function with the first return magnets 361 and the second return magnets 362 as the return means, thereby achieving simplification of the structure, a reduction in size of the device, and others.

Additionally, since the alignment direction of the two first return magnets 361 and the major axis of the first coil 321 are arranged to become substantially parallel to each other and the alignment direction of the two second return magnets 362 and the major axis of the second coil 331 are arranged to become substantially parallel to each other, force that prevents the movable holding member 310 from rotating on the optical axis L2 is exercised by the mutual function of the magnetic force of the return magnets 361 and 362 and the magnetic force of the drive magnets 322 and 332 at the time of driving (at the time of energizing the first coil 321 and the second coil 331), a large moment that suppresses the rotation can be obtained by aligning the return magnets 361 and 362 in the directions of the magnetizing borders, respectively, and the movable holding member 310 can be rapidly moved within the plane vertical to the optical axis L2 and highly accurately positioned at a desired position.

Each of the first magnetic sensor 371 and the second magnetic sensor 372 is, e.g., a hall element that detects a change in magnetic flux density and outputs it as an electric signal, and it is fitted and fixed in the fitting concave portion 300c or 300f (see FIG. 43) of the base 300 as shown in FIG. 39 and FIG. 42 to FIG. 45. Here, in the movement range of the movable holding member 310, the first magnetic sensor 371 is arranged at a position where it faces the first drive magnet 322, and the second magnetic sensor 372 is arranged at a position where it faces the second drive magnet 332.

Further, the first magnetic sensor 371 forms a magnetic circuit between itself and the first drive magnet 322 fixed to the movable holding member 310, and it is configured to detect a position of the movable holding member 310 by detecting a change in magnetic flux density caused when the movable holding member 310 relatively moves with respect to the base 300.

Furthermore, the second magnetic sensor 372 forms a magnetic circuit between itself and the second drive magnet 332 fixed to the movable holding member 310, and it is configured to detect a position of the movable holding member 310 by detecting a change in magnetic flux density caused when the movable holding member 310 relatively moves with respect to the base 300.

As described above, since the first magnetic sensor 371 and the second magnetic sensor 372 are fixed to the base 300, wiring is easier than that in a case where these sensors are provided to the movable holding member 310, disconnection and the like involved by movement can be avoided, and simplification of the structure, a reduction in number of components an in size of the device, and others can be achieved as compared with a case where a dedicated magnet is provided since both the first drive magnet 322 and the second drive magnet 332 are used for positional detection.

As shown in FIG. 38, the flexible wiring board 380 is formed to have a connecting portion 381 connected to the first coil 321 of the first drive mechanism 320, a connecting portion 382 connected to the second coil 331 of the second drive mechanism 330, a connecting portion 383 connected to the first magnetic sensor 371, and a connecting portion 384 connected to the second magnetic sensor 372.

Moreover, as shown in FIG. 46, the flexible wiring board 380 is arranged to be in contact with a back surface of the base 300, a lead-out line of the first coil 321 is connected to the connecting portion 381, a lead-out line of the second coil 331 is connected to the connecting portion 382, a terminal of the first magnetic sensor 371 is connected to the connecting portion 383, a terminal of the second magnetic sensor 372 is connected to the connecting portion 384, and regions of the connecting portions 381 and 382 are sandwiched and fixed by the yoke 341 while being bent.

As described above, since the flexible wiring board 380 is arranged and fixed to be adjacent to the base 300, which does not move in a planar direction vertical to the optical axis L2, on an opposite side of a side facing the movable holding member 310, the flexible wiring board 380 does not have to be moved in the planar direction vertical to the optical axis L2 and does not have to be arranged while being bent in the planar direction along which the movable holding member 310 moves.

Therefore, an arrangement space of the flexible wiring board 380 can be narrowed, and hence the device can be reduced in size, thus improving durability.

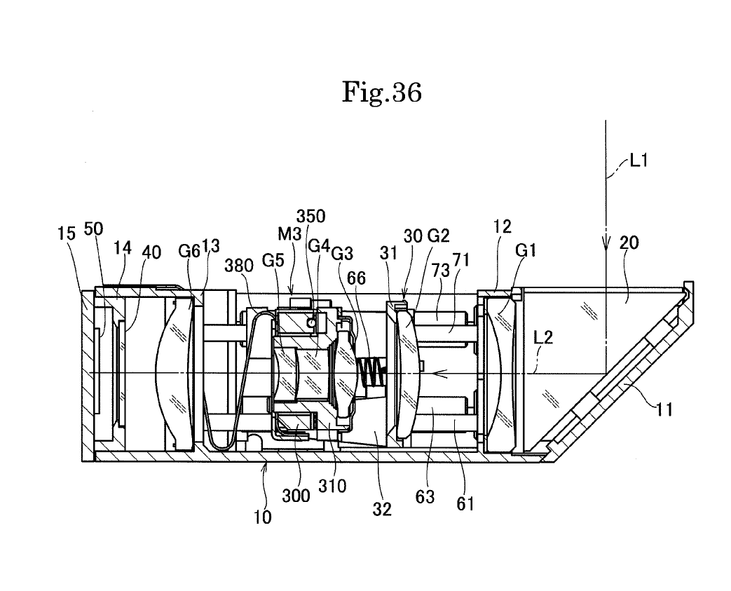

Additionally, as shown in FIG. 36 and FIG. 38, the flexible wiring board 380 is bifurcated so as not to block the optical axis L2 and arranged to expand/contract in a bellows manner in the direction of the optical axis L2, efficient accommodation is enabled, which contributes to a reduction in size and thickness of the device.

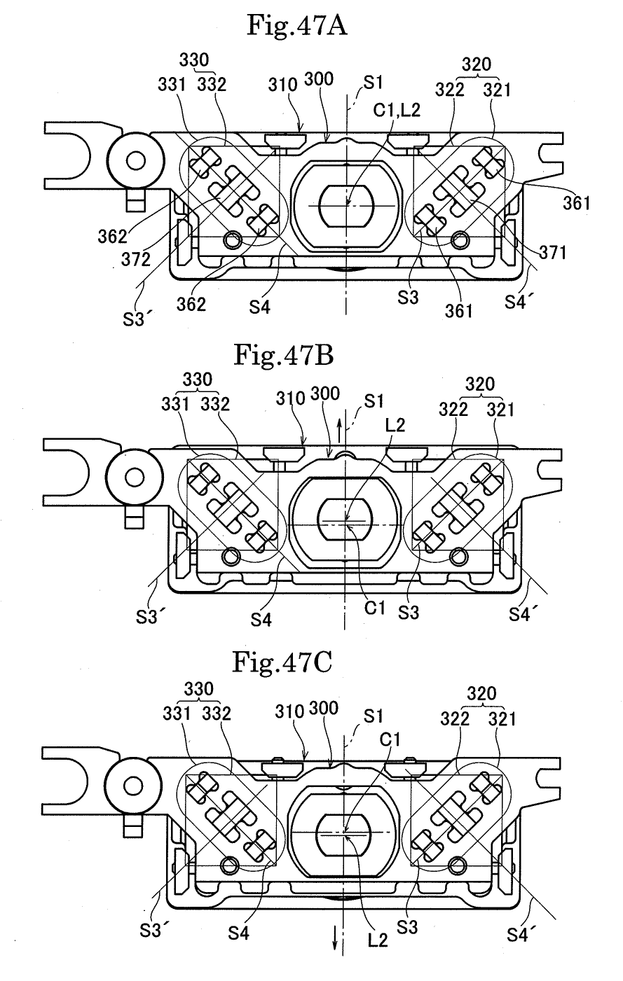

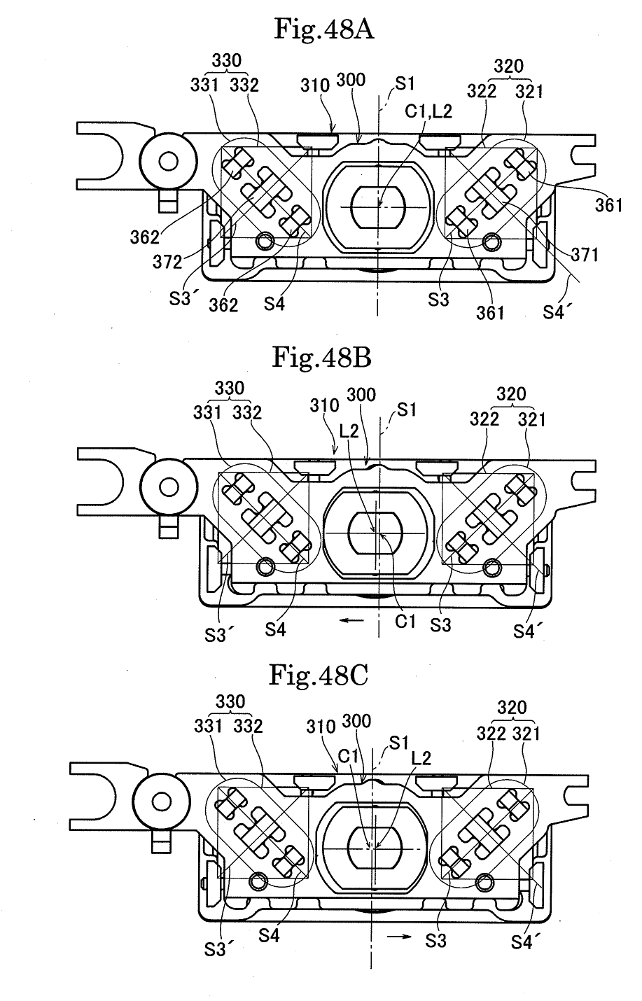

A correcting operation of the image blur correction device M3 will now be briefly described with reference to FIG. 47A to FIG. 48C.

First, as shown in FIG. 47A, in the pause state that the first coil 321 and the second coil 331 are not energized, the movable holding member 310 is returned (centered) to and held at the pause position where the optical axis L2 of the lenses G3, G4, and G5 coincides with the center C1 of the opening portion 300a of the base 300 by a return function of the return means (the first return magnets 361 and the second return magnets 362).

Further, for example, when upwardly shifting the movable holding member 310 (the lenses G3, G4, and G5) from the pause state depicted in FIG. 47A, the first drive mechanism 320 is operated to generate drive force in an obliquely upward direction of the first direction (the direction of the straight line S4′), and the second drive mechanism 330 is operated to generate drive force in an obliquely upward direction of the second direction (the direction of the straight line S3′). As a result, as shown in FIG. 47B, the movable holding member 310 is moved in an upward direction of the straight line S1.

Furthermore, for example, when downwardly shifting the movable holding member 310 (the lenses G3, G4, and G5) from the pause state depicted in FIG. 47A, the first drive mechanism 320 is operated to generate drive force in an obliquely downward direction of the first direction (the direction of the straight line S4′), and the second drive mechanism 330 is operated to generate drive force in an obliquely downward direction of the second direction (the direction of the straight line S3′). As a result, as shown in FIG. 47C, the movable holding member 310 is moved in a downward direction of the straight line S1.

Subsequently, as shown in FIG. 48A, for example, when shifting the movable holding member 310 (the lenses G3, G4, and G5) toward a left-hand side from the pause state that the movable holding member 310 has been returned to the pause position at which the optical axis L2 of the lenses G3, G4, and G5 coincides with the center C1 of the opening portion 300a of the base 300 by the return function of the return means (the first return magnets 361 and the second return magnets 362), the first drive mechanism 320 is operated to generate drive force in the obliquely upward direction of the first direction (the direction of the straight line S4′), and the second drive mechanism 330 is operated to generate drive force in the obliquely downward direction of the second direction (the direction of the straight line S3′). As a result, as shown in FIG. 48B, the movable holding member 310 is moved toward the left-hand side of the direction of the straight line S2.

Moreover, for example, when shifting the movable holding member 310 (the lenses G3, G4, and G5) toward a right-hand side from the pause state depicted in FIG. 48A, the first drive mechanism 320 is operated to generate drive force in the obliquely downward direction of the first direction (the direction of the straight line S4′), and the second drive mechanism 330 is operated to generate drive force in the obliquely upward direction of the second direction (the direction of the straight line S3′). As a result, as shown in FIG. 48C, the movable holding member 310 is moved toward the right-hand side of the direction of the straight line S2.

As described above, the movable holding member 310 is movably supported by the support mechanism (the three spheres 350), and it is two-dimensionally moved within the plane vertical to the optical axis L2 with respect to the base 300 in this state by the electromagnetic drive force generated by energization of the first coil 321 and the second coil 331 in cooperation with the first drive magnet 322 and the second drive magnet 332, thereby highly accurately correcting an image blur caused due to, e.g., hand movement.

Here, since the major axis of the first coil 321 and the alignment direction of the two first return magnets 361 are aligned to extend in the same direction and the major axis of the second coil 331 and the alignment direction of the two second return magnets 362 are aligned to extend in the same direction, force that prevents the movable holding member 310 from rotating on the optical axis L2 is exercised by the mutual function of the magnetic force of the return magnets 361 and 362 and the magnetic force of the drive magnets 322 and 332 at the time of driving (at the time of energizing the coils 321 and 331), a large moment that suppresses the rotation can be obtained by aligning the return magnets 361 and 362 in directions of the magnetizing borders, respectively, and the movable holding member 310 can be rapidly moved within the plane vertical to the optical axis L2 and highly accurately positioned at a desired position.

In the foregoing embodiment, although the configuration that each of the first coil 321 and the second coil 331 is formed into the substantially elliptic annular shape has been described, this “substantially elliptic annular shape” is a concept including a substantially rectangular annular shape consisting of wide sides (major axes) and narrow sides (minor axes) including straight line portions besides the elliptic annular shape.

In the foregoing embodiment, although each of the first magnetic sensor 371 and the second magnetic sensor 372 consisting of the hall element has been described as the position detecting means, the present invention is not limited thereto, and any other magnetic sensor may be adopted.

In the foregoing embodiment, although the description has been given as to the example where the configuration that the three spheres 350 inserted in the concave portions 304 of the base 300 are provided to abut on the three abutting surfaces 314 of the movable holding member 310 is adopted as the support mechanism that supports the movable holding member, the present invention is not limited thereto, and a configuration that the plurality of abutting surfaces are provided on the base 300 and the plurality of concave portions that receive the spheres 350 are provided on the movable holding member may be adopted as a reverse pattern, and the present invention may be adopted in a configuration including any other support mechanism.

In the foregoing embodiment, although the image blur correction device applied to the camera unit U mounted in a personal digital assistance has been described, a configuration including the image blur correction device having the above structure may be adopted in an imaging lens unit including a plurality of lenses for imaging.

As a result, when the configuration where the plurality of lenses for imaging are arranged in the optical axis direction includes the above-described image blur correction device, the correction lenses G3, G4, and G5 held by the movable holding member 310 are appropriately driven, and an image blur caused due to hand movement and others can be smoothly and highly accurately corrected. That is, the imaging lens unit having the image bur correcting function in addition to the plurality of lenses for imaging can be provided.

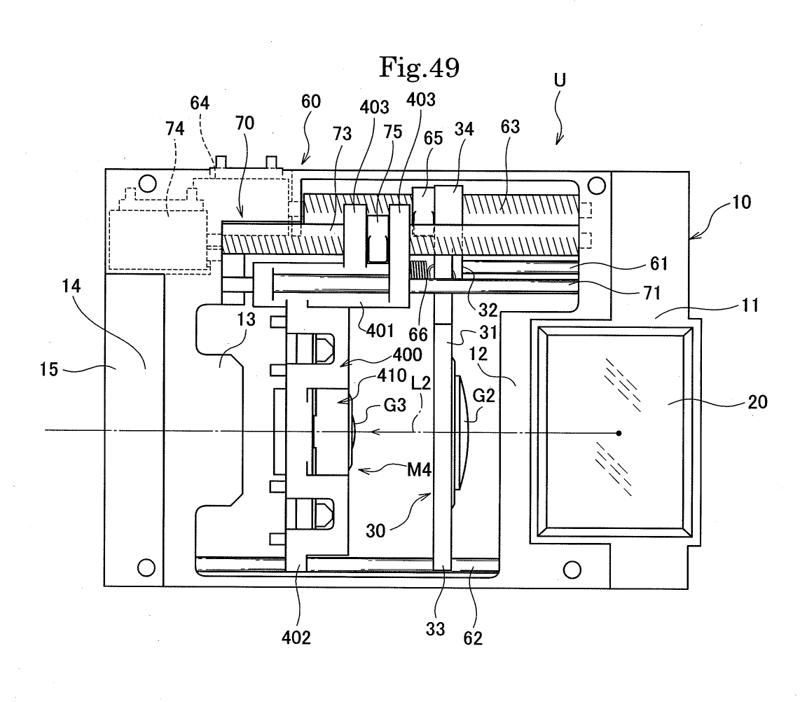

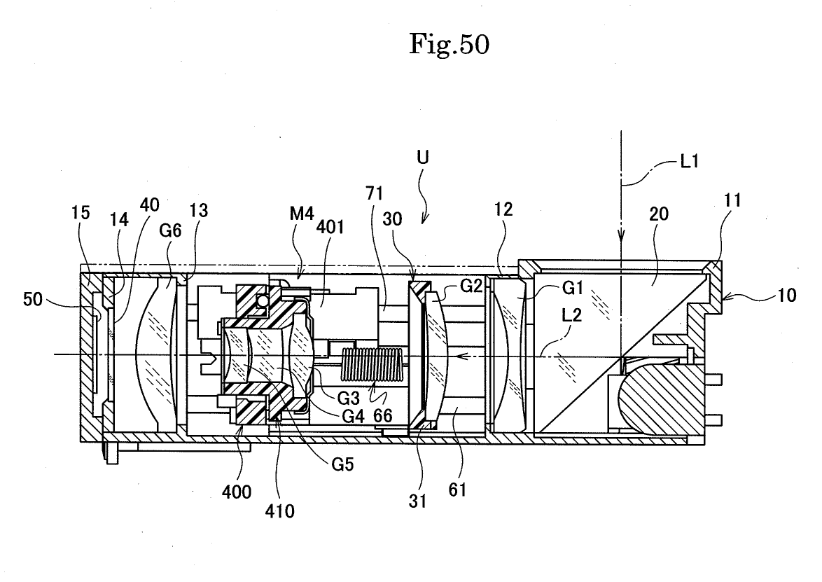

FIG. 49 to FIG. 62 show an image blur correction device M4 according to a fourth embodiment. As shown in FIG. 49 and FIG. 50, this image blur correction device M4 is incorporated in the same camera unit U as that described above, and it includes the same control unit as that described above.

As shown in FIG. 49 to FIG. 54, the image blur correction device M4 according to this embodiment is arranged between a first movable lens group 30 and a lens G6 in an optical axis L2 direction and includes a base 400, a movable holding member 410, a first drive mechanism 420 (including a first coil 421, a first drive magnet 422, and a first yoke 423) as a driving means, a second drive mechanism 430 (including a second coil 431, a second drive magnet 432, and a second yoke 433) as a driving means, three spheres 440 as a support mechanism that movably supports the movable holding member 410 within a plane vertical to the optical axis L2, a first return magnet 451 and a second return magnet 452 as a return means (return members), a first magnetic sensor 461 and a second magnetic sensor 462 as a position detecting means, a flexible wiring board 470 that performs electrical connection, and others.

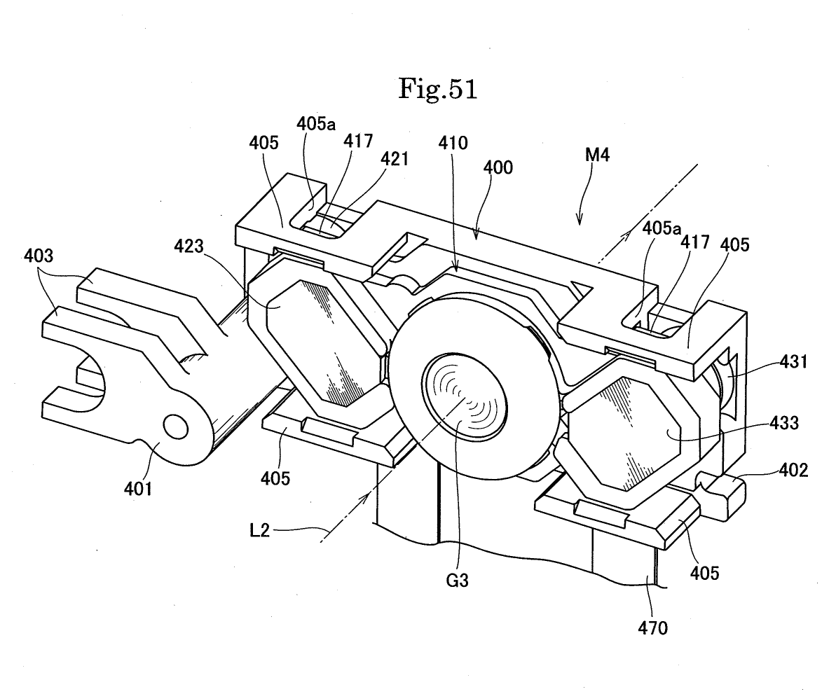

As shown in FIG. 51 to FIG. 54 and FIG. 56 to FIG. 58, the base 400 is formed into a substantially rectangular flat plate-like shape that is substantially flat in the optical axis L2 direction, narrow in a direction of a straight line S1 perpendicular to the optical axis L2 and parallel to an optical axis L1, and long in a direction of a straight line S2 perpendicular to the optical axis L2 and the straight line S1, and it includes an opening portion 400a that defines a center C1, a fitting concave portion 400b in which the first coil 421 is fitted and fixed, a fitting concave portion 400c in which the first magnetic sensor 461 is fitted and fixed, a fitting concave portion 400d in which the second coil 431 is fitted and fixed, a fitting concave portion 400e in which the second magnetic sensor 462 is fitted and fixed, a guided portion 401 that is slidably engaged with and guided by a guide shaft 71, a regulated portion 402 that is slidably engaged with an antirotation shaft 62 to regulate its rotation on the optical axis L2, a pair of U-shaped engagement portions 403 that sandwich a nut 75 having a lead screw 73 screwed therein, three concave portions 404 that receive the spheres 440 as the support mechanism, four coupling pieces 405 that movably couple the movable holding member 410, a latch piece 406 that latches and holds on one end of a coil spring 66, four screw holes 407 configured to fix the flexible wiring board 470 by using screws, four wall-thickness reducing holes 408, and others.

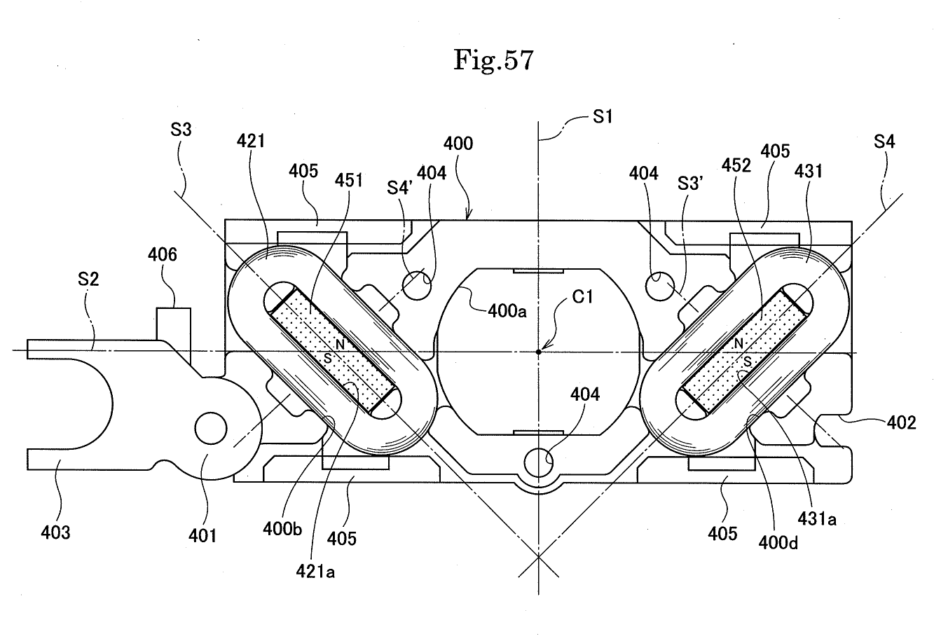

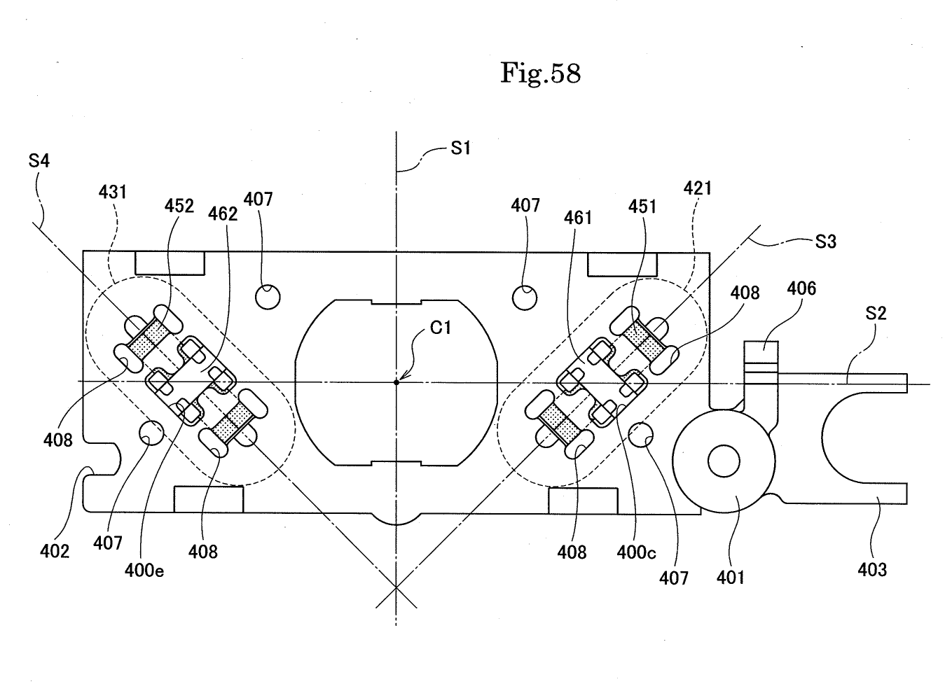

As shown in FIG. 57 and FIG. 58, the opening portion 400a is formed with an inner diameter dimension that enables defining the center C1 at an intersection of the straight line S1 and the straight line S2 and also defining an inner wall surface parallel to the direction of the straight line S1 and allowing a cylindrical portion 410a of the movable holding member 410 to pass therethrough in a contactless manner in the range that the movable holding member 410 is driven.

The fitting concave portions 400b and 400c and the fitting concave portions 400d and 400e are formed to be line-symmetric with respect to the straight line S1 as shown in FIG. 57 and FIG. 58. That is, a pair of the first coil 421 (the first return magnet 451) and the first magnetic sensor 461 and a pair of the second coil 431 (the second return magnet 452) and the second magnetic sensor 462 are arranged to be line-symmetric with respect to the straight line S1 on the base 400.

The three concave portions 404 are formed to receive the spheres 440 while allowing their rolling movement in a state that the spheres 440 partially protrude in the optical axis L2 direction. Further, in regard to an arrangement configuration of the three concave portions 404, as shown in FIG. 57, one concave portion 404 is arranged on the straight line S1 near the opening portion 400a, and the other two concave portions 404 are arranged at line-symmetric positions with respect to the straight line S1 near the opening portion 400a. That is, the three concave portions 404 are arranged to be placed at three vertices of an isosceles triangle or an equilateral triangle.

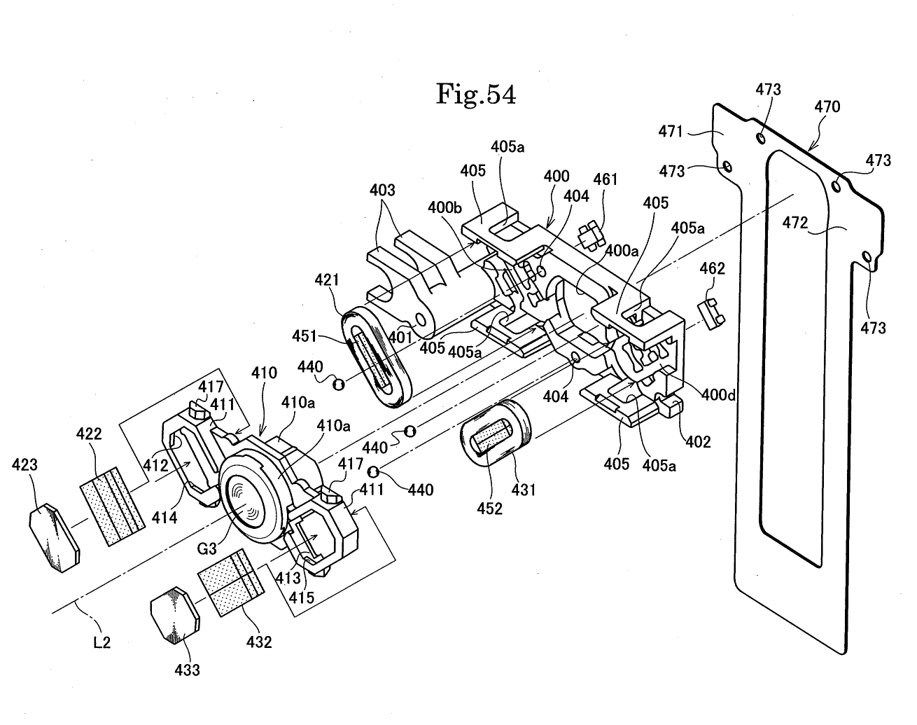

The four coupling pieces 405 function as a regulation mechanism that regulates the movable holding member 410 from being separated from the base 400 in the optical axis L2 direction, and the coupling pieces are formed to define coupling holes 405a that receive coupling protrusions 417 of the movable holding member 410 and to be bendable (elastically deformable) when receiving the coupling protrusions 417 in the coupling holes 405a as shown in FIG. 51 and FIG. 54.

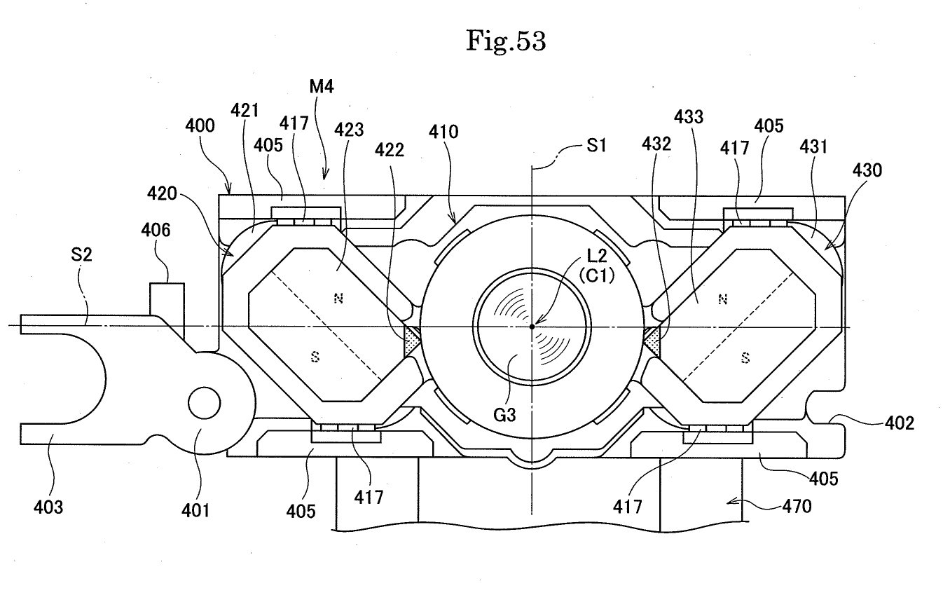

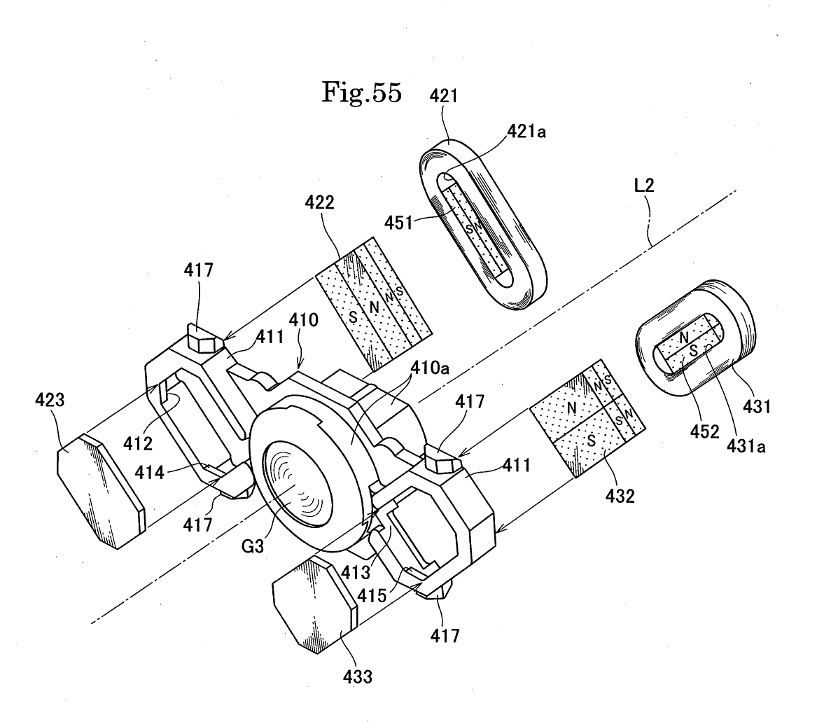

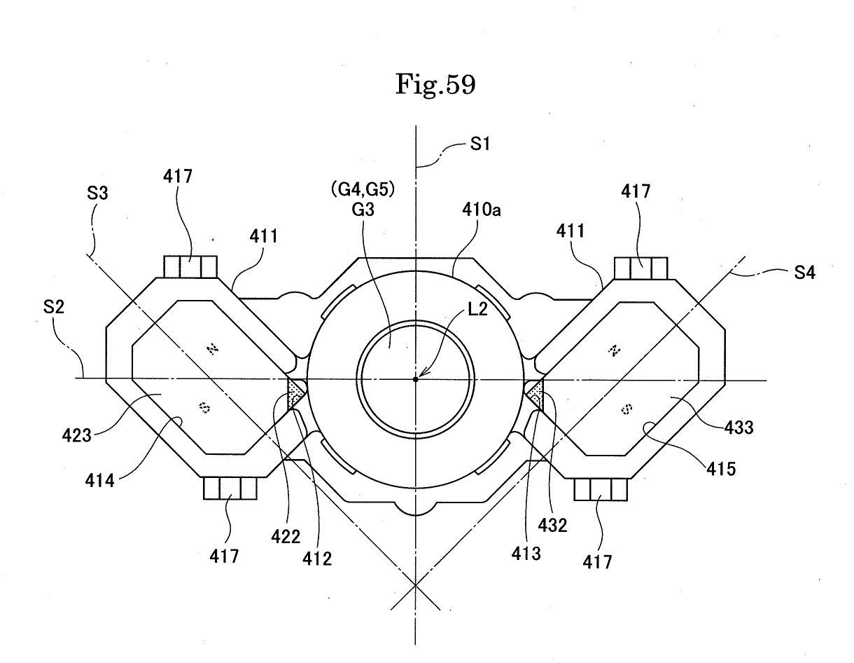

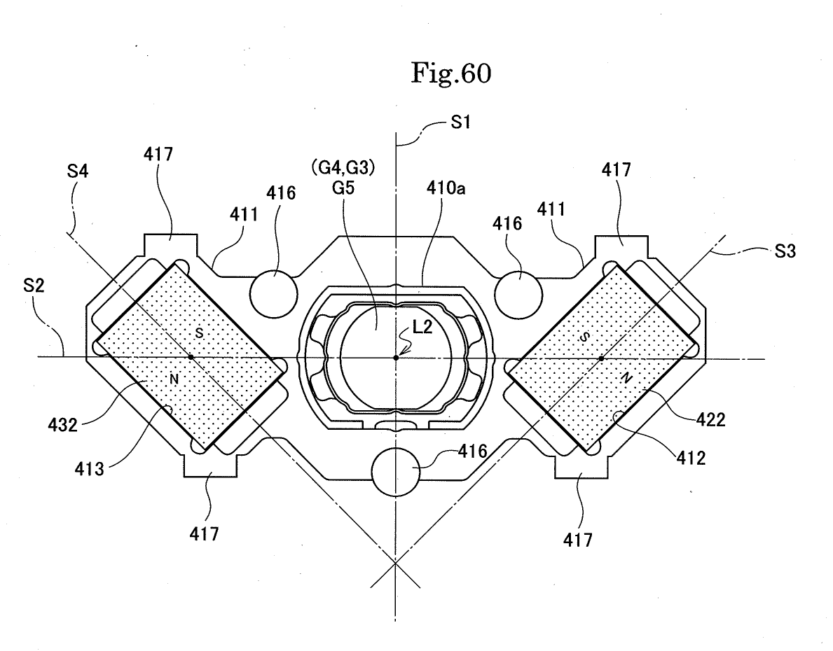

As shown in FIG. 53 to FIG. 55, FIG. 59, and FIG. 60, the movable holding member 410 is formed into a substantially rectangular flat plate-like shape that is substantially flat in the optical axis L2 direction except a part, narrow in the direction of the straight line S1, and long in the direction of the straight line S2, and it includes the cylindrical portion 410a configured to hold lenses G3, G4, and G5 with the optical axis L2 at the center, two extending portions 411 extending to both sides of the straight line S2 direction to sandwich the cylindrical portion 410a, a fitting hole 412 in which the first drive magnet 422 is fitted and fixed, a fitting hole 413 in which the second drive magnet 432 is fitted and fixed, a fitting hole 414 in which the first yoke 423 is fitted and fixed, a fitting hole 415 in which the second yoke 433 is fitted and fixed, three abutting surfaces 416 abutting on the three spheres 440 as the support mechanism, four coupling protrusions 417 that are inserted in the four coupling pieces 405 (the coupling holes 405a), respectively, and others as shown in FIG. 54, FIG. 55, FIG. 59, and FIG. 60.

The cylindrical portion 410a is formed into cylindrical shape that has parallel cut planes in the direction of the straight line S1 on a side facing the opening portion 400a of the base 400 and is flat in the direction of the straight line S1.

The three abutting surfaces 416 are arranged to face the three concave portions 404 (the spheres 440) in the optical axis L2 direction in a state that the optical axis L2 of the lenses G3, G4, and G5 coincides with the center C1 of the opening portion 400a of the base 400, and the abutting surfaces are formed into planar shapes each having a predetermined area in such a manner that they do not deviate from a state contacting with the spheres 440 inserted in the corresponding concave portions 404 of the base 400 in the range that the movable holding member 410 two-dimensionally moves within a plane (a plane including the straight lines S1 and S2) vertical to the optical axis L2.

As shown in FIG. 51, FIG. 53 to FIG. 55, FIG. 59, and FIG. 60, the coupling protrusions 417 are formed to extend in the direction of the straight line S1 vertical to the optical axis L2 and can be inserted into the coupling holes 405a of the coupling pieces 405.

Here, each coupling protrusion 417 is formed with a dimension enabling two-dimensionally moving in the coupling hole 405a within the plane (the plane including the straight lines S1 and S2) vertical to the optical axis L2 while being inserted in the coupling hole 405a and restricted from moving apart along the optical axis L2 direction.

That is, when the four coupling protrusions 417 are coupled with the corresponding four coupling pieces 405 (the coupling holes 405a) and the movable holding member 410 is thereby arranged to face the base 400 in such a manner that the three abutting surfaces 416 abut on the three spheres 440 inserted in the three concave portions 404, the movable holding member 410 is regulated from moving away from the base 400 in the optical axis L2 direction, the first return magnet 451 fixed to the base 400 and the first drive magnet 422 fixed to the movable holding member 410 magnetically attract each other, and the second return magnet 452 fixed to the base 400 and the second drive magnet 432 fixed to the movable holding member 410 magnetically attract each other, whereby the movable holding member 410 is supported with respect to the base 400 to be movable within the plane (the plane including the straight lines S1 and S2) vertical to the optical axis L2 without being separated from the base 400.

Further, the movable holding member 410 is two-dimensionally moved within the plane with respect to the base 400 by drive force of the first drive mechanism 420 and the second drive mechanism 430, thereby highly accurately correcting an image blur caused due to hand movement and others.

As shown in FIG. 54 to FIG. 57, the first drive mechanism 420 is formed as a voice coil motor including the first coil 421, the first drive magnet 422, and the first yoke 423.

As shown in FIG. 57, the first coil 421 is formed into a substantially elliptic annular shape having a major axis in the direction of the straight line S3 and a minor axis in the direction of the straight line S4′ as seen from the optical axis L2 direction, namely, formed to extend in the straight line S3 direction (extend in a direction vertical to a first direction (the direction of the straight line S4′) within the plane) so as to define an air core portion 421a inside, and it is fitted and fixed in the fitting concave portion 400b of the base 400. Moreover, the first coil 421 is arranged in such a manner that its major axis forms an inclination angle of 45 degrees (its major axis becomes parallel to the straight line S3) with respect to the straight line S2.

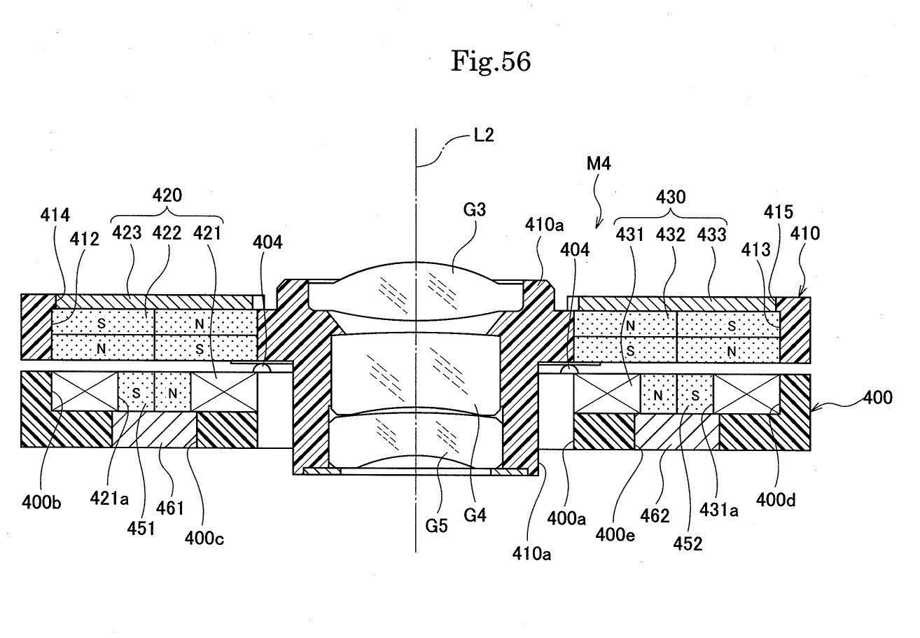

As shown in FIG. 55, FIG. 56, and FIG. 60, the first drive magnet 422 is formed into a rectangular shape that is long in the straight line S3 direction and magnetized to have an N pole and an S pole with a surface running through the straight line S3 as a border and magnetized to have an N pole and an S pole in the optical axis L2 direction (thickness direction), and it is fitted and fixed in the fitting hole 412 of the movable holding member 410.

As shown in FIG. 55, FIG. 56, and FIG. 59, the first yoke 423 is formed into a substantially rectangular plate-like shape and fitted and fixed in the fitting hole 414 of the movable holding member 410.

Additionally, the first drive mechanism 420 generates electromagnetic drive force in the first direction vertical to the optical axis L2 (namely, the direction of the straight line S4′) by turning on/off energization with respect to the first coil 421.

As shown in FIG. 54 to FIG. 57, the second drive mechanism 430 is formed as a voice coil motor including the second coil 431, the second drive magnet 432, and the second yoke 423.

As shown in FIG. 57, the second coil 431 is formed into a substantially elliptic annular shape having a major axis in the direction of the straight line S4 and a minor axis in the direction of the straight line S3′ as seen from the optical axis L2 direction, namely, formed to extend in the straight line S4 direction (extend in a direction vertical to a second direction (the direction of the straight line S3′) within the plane) so as to define an air core portion 431a inside, and it is fitted and fixed in the fitting concave portion 400d of the base 400. Moreover, the second coil 431 is arranged in such a manner that its major axis forms an inclination angle of 45 degrees (its major axis becomes parallel to the straight line S4) with respect to the straight line S2.

As shown in FIG. 55, FIG. 56, and FIG. 60, the second drive magnet 432 is formed into a rectangular shape that is long in the straight line S4 direction and magnetized to have an N pole and an S pole with a surface running through the straight line S4 as a border and magnetized to have an N pole and an S pole in the optical axis L2 direction (thickness direction), and it is fitted and fixed in the fitting hole 413 of the movable holding member 410.

As shown in FIG. 55, FIG. 56, and FIG. 59, the second yoke 433 is formed into a substantially rectangular plate-like shape and fitted and fixed in the fitting hole 415 of the movable holding member 410.

Additionally, the second drive mechanism 430 generates electromagnetic drive force in the second direction vertical to the optical axis L2 (namely, the direction of the straight line S3′) by turning on/off energization with respect to the second coil 431.

As shown in FIG. 53, since the first drive mechanism 420 and the second drive mechanism 430 are arranged to be line-symmetric with respect to the straight line S1 perpendicular to the optical axis L2 of the lenses G3, G4, and G5 held by the movable holding member 410, drive loads imposed on the respective drive mechanisms are equal to each other, these drive mechanisms exercise drive forces on both sides of the lenses G3, G4, and G5, whereby the movable holding member 410 can be stably and smoothly driven within a plane vertical to the optical axis L2.

Moreover, since the first coil 421 and the second coil 431 are arranged in such a manner that each of their major axes forms the predetermined inclination angle (approximately 45 degrees) with respect to the straight line S2, when the movable holding member 410 has a shape that is long in the direction of the straight line S2, the dimension of the movable holding member 410 can be reduced in the direction of the straight line S1 by inclining the first coil 421 and the second coil 431 and, for example, a reduction in size and thickness of the device in the direction vertical to the optical axis L2 (the direction of the first straight line S1) can be achieved.

The first return magnet 451 functions as a return member, and it is formed into a substantially rectangular shape as seen from the optical axis L2 direction, magnetized to have an S pole and an N pole with a surface running through the straight line S3 as a border, formed to extend in the straight line S3 direction (extend in a direction vertical to the first direction (the straight line S4′ direction) within the plane), and arranged to be fitted in the air core portion 421a of the first coil 421 as shown in FIG. 55 to FIG. 57.

That is, the first return magnet 451 forms an inclination angle of 45 degrees with respect to the straight line S2 and is aligned on the straight line S3 so as to become substantially parallel to the major axis of the first coil 421.

Furthermore, the first return magnet 451 faces the first drive magnet 422 to form a magnetic path and exercise a magnetic function, returns the movable holding member 410 to the predetermined pause position (the position at which the optical axis L2 of the lenses G3, G4, and G5 coincides with the center C1 of the opening portion 400a of the base 400 in this example) in a pause state that the first coil 421 is not energized, and generates stable holding force.

Here, since the first return magnet 451 is formed to extend in the straight line S3 direction (extend in the direction vertical to the straight line S4′ direction (the first direction) within the plane), the movable holding member 410 can be regulated from being rotated (on the optical axis S2) within the plane vertical to the optical axis S2, and an image blur caused due to hand movement and the like can be further highly accurately corrected. Additionally, since the first return magnet 451 is fitted in the air core portion 421a of the first coil 421, a dedicated fixing means is not required, and a thickness of the device can be reduced in the optical axis L2 direction.

The second return magnet 452 functions as a return member, and it is formed into a substantially rectangular shape as seen from the optical axis L2 direction, magnetized to have an S pole and an N pole with a surface running through the straight line S4 as a border, formed to extend in the straight line S4 direction (extend in a direction vertical to the second direction (the straight line S3′ direction) within the plane), and arranged to be fitted in the air core portion 431a of the second coil 431 as shown in FIG. 55 to FIG. 57.

That is, the second return magnet 452 forms an inclination angle of 45 degrees with respect to the straight line S2 and is aligned on the straight line S4 so as to become substantially parallel to the major axis of the second coil 431.

Furthermore, the second return magnet 452 faces the second drive magnet 432 to form a magnetic path and exercise a magnetic function, returns the movable holding member 410 to the predetermined pause position (the position at which the optical axis L2 of the lenses G3, G4, and G5 coincides with the center C1 of the opening portion 400a of the base 400 in this example) in a pause state that the second coil 431 is not energized, and generates stable holding force.

Here, since the second return magnet 452 is formed to extend in the straight line S4 direction (extend in the direction vertical to the straight line S3′ direction (the second direction) within the plane), the movable holding member 410 can be regulated from being rotated (on the optical axis S2) within the plane vertical to the optical axis S2, and an image blur caused due to hand movement and the like can be further highly accurately corrected. Additionally, since the second return magnet 452 is fitted in the air core portion 431a of the second coil 431, a dedicated fixing means is not required, and a thickness of the device can be reduced in the optical axis L2 direction.

As described above, in the pause state, the movable holding member 410 (the lenses G3, G4, and G5) is automatically returned (centered) to and stably held at the predetermined pause position (the position at which the optical axis L2 of the lenses G3, G4, and G5 coincides with the center C1 of the opening portion 400a of the base 400) by a magnetic attractive function between the first return magnet 451 and the second return magnet 452 as a return means and the first drive magnet 422 and the second drive magnet 432 as a driving means.

Therefore, drive control such as initialization is not required at the time of driving, and wobble and the like of the movable holding member 410 can be avoided in the pause state. Moreover, both the first drive magnet 422 and the second drive magnet 432 as the driving means are used in order to magnetically exert a mutual function with the first return magnet 451 and the second return magnet 452 as the return means, thereby achieving simplification of the structure, a reduction in size of the device, and others.

Additionally, since the first return magnet 451 is arranged in the air core portion 421a of the first coil 421 and the second return magnet 452 is arranged in the air core portion 431a of the second coil 431, the structure can be simplified, the components can be put together, and the device can be reduced in thickness and size in the optical axis S2 direction.

Further, since the first return magnet 451 and the first coil 421 are formed to extend in the same direction (the straight line S3 direction) and the second return magnet 452 and the second coil are formed to extend in the same direction (the straight line S4 direction), force that prevents the movable holding member 410 from rotating on the optical axis L2 (a large moment that suppresses the rotation) can be obtained by the mutual function of the magnetic force of the return magnets 451 and 452 and the magnetic force of the drive magnets 422 and 432 at the time of driving (at the time of energizing the first coil 421 and the second coil 431), and the movable holding member 410 can be rapidly moved within the plane vertical to the optical axis L2 and highly accurately positioned at a desired position.

Each of the first magnetic sensor 461 and the second magnetic sensor 462 is, e.g., a hall element that outputs a position detection signal by relative movement of itself and the magnet, e.g., detects a change in magnetic flux density and outputs it as an electric signal, and each sensor is fitted and fixed in the fitting concave portion 400c or 400e (see FIG. 58) of the base 400 as shown in FIG. 54, FIG. 56, and FIG. 58.

Here, in the movement range of the movable holding member 410, the first magnetic sensor 461 is arranged at a position where it faces the first drive magnet 422, and the second magnetic sensor 462 is arranged at a position where it faces the second drive magnet 432.

Further, the first magnetic sensor 461 forms a magnetic circuit between itself and the first drive magnet 422 fixed to the movable holding member 410, and it is configured to detect a position of the movable holding member 410 by detecting a change in magnetic flux density caused when the movable holding member 410 relatively moves with respect to the base 400.

Furthermore, the second magnetic sensor 462 forms a magnetic circuit between itself and the second drive magnet 432 fixed to the movable holding member 410, and it is configured to detect a position of the movable holding member 410 by detecting a change in magnetic flux density caused when the movable holding member 410 relatively moves with respect to the base 400.

As described above, since the first magnetic sensor. 461 and the second magnetic sensor 462 are fixed to the base 400, wiring is easier than that in a case where these sensors are provided to the movable holding member 410, disconnection and the like involved by movement can be avoided, and simplification of the structure, a reduction in number of components an in size of the device, and others can be achieved as compared with a case where a dedicated magnet is provided since both the first drive magnet 422 and the second drive magnet 432 are used for positional detection.

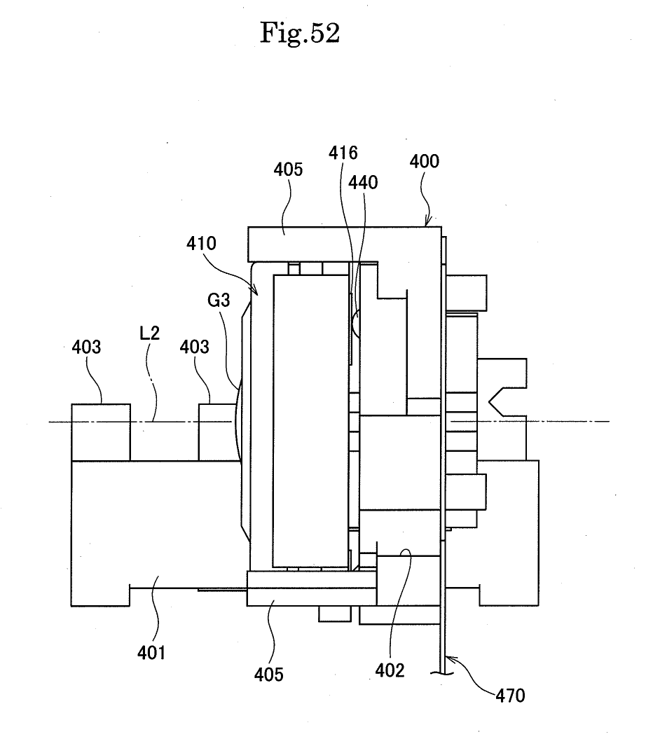

As shown in FIG. 52 and FIG. 54, the flexible wiring board 470 is formed to define a connecting portion 471 connected to the first coil 421 and the first magnetic sensor 461, a connecting portion 472 connected to the second coil 431 and the second magnetic sensor 462, circular holes 473 into which screws are inserted, and others.

Moreover, as shown in FIG. 52, the flexible wiring board 470 is arranged to be in contact with a back surface of the base 400, and it is fixed to the base 400 by screwing screws (not shown) into screw holes 407 in the base 400.

As described above, since the flexible wiring board 470 is arranged and fixed to be adjacent to the base 400, which does not move in a planar direction vertical to the optical axis L2, on an opposite side of a side facing the movable holding member 410, the flexible wiring board 470 does not have to be moved in the planar direction vertical to the optical axis L2 and does not have to be arranged while being bent in the planar direction along which the movable holding member 410 moves.

Therefore, an arrangement space of the flexible wiring board 470 can be narrowed, and hence the device can be reduced in size, thus improving durability.

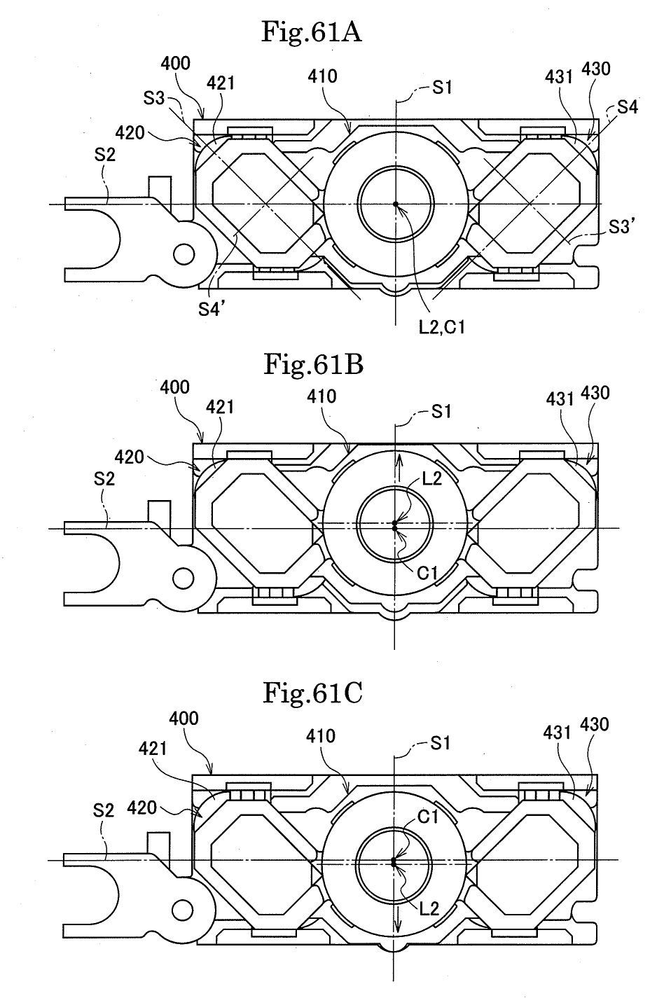

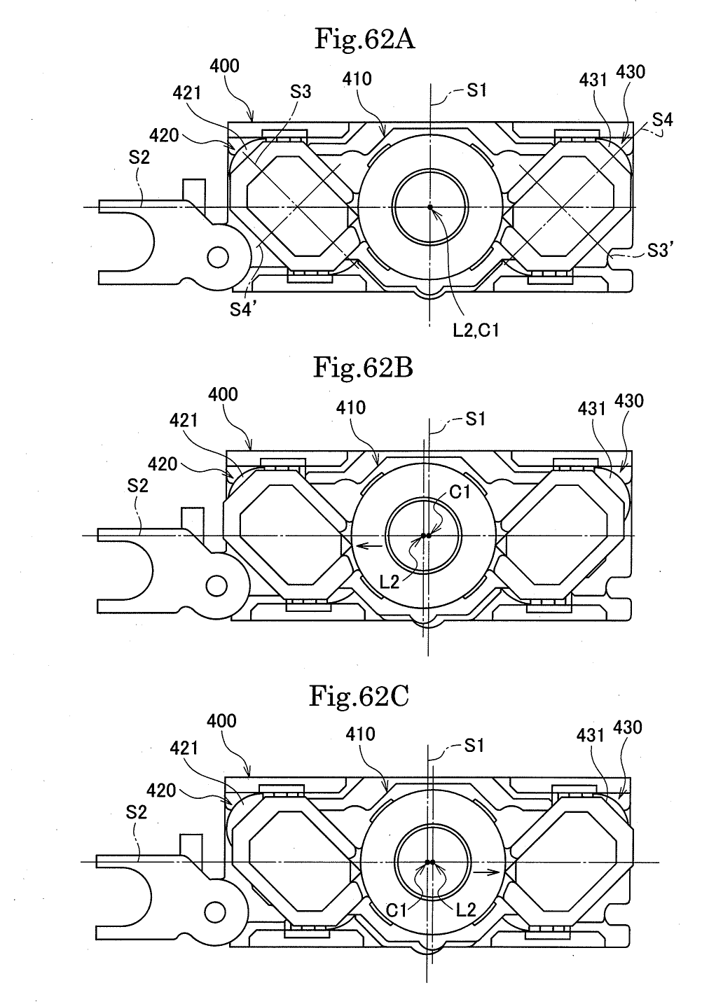

A correcting operation of the image blur correction device M4 will now be briefly described with reference to FIG. 61A to FIG. 62C.

First, as shown in FIG. 61A, in the pause state that the first coil 421 and the second coil 431 are not energized, the movable holding member 410 is returned (centered) to and held at the pause position where the optical axis L2 of the lenses G3, G4, and G5 coincides with the center C1 of the opening portion 400a of the base 400 by a return function of the return means (the first return magnet 451 and the second return magnet 452).

Further, for example, when upwardly shifting the movable holding member 410 (the lenses G3, G4, and G5) from the pause state depicted in FIG. 61A, the first drive mechanism 420 is operated to generate drive force in an obliquely upward direction of the first direction (the direction of the straight line S4′), and the second drive mechanism 430 is operated to generate drive force in an obliquely upward direction of the second direction (the direction of the straight line S3′). As a result, as shown in FIG. 61B, the movable holding member 410 is moved in an upward direction of the straight line S1.

Furthermore, for example, when downwardly shifting the movable holding member 410 (the lenses G3, G4, and G5) from the pause state depicted in FIG. 61A, the first drive mechanism 420 is operated to generate drive force in an obliquely downward direction of the first direction (the direction of the straight line S4′), and the second drive mechanism 430 is operated to generate drive force in an obliquely downward direction of the second direction (the direction of the straight line S3′). As a result, as shown in FIG. 61C, the movable holding member 410 is moved in a downward direction of the straight line S1.

Subsequently, as shown in FIG. 62A, for example, when shifting the movable holding member 410 (the lenses G3, G4, and G5) toward a left-hand side from the pause state that the movable holding member 410 has been returned to the pause position at which the optical axis L2 of the lenses G3, G4, and G5 coincides with the center C1 of the opening portion 400a of the base 400 by the return function of the return means (the first return magnet 451 and the second return magnet 452), the first drive mechanism 420 is operated to generate drive force in the obliquely downward direction of the first direction (the direction of the straight line S4′), and the second drive mechanism 430 is operated to generate drive force in the obliquely upward direction of the second direction (the direction of the straight line S3′). As a result, as shown in FIG. 62B, the movable holding member 410 is moved toward the left-hand side of the direction of the straight line S2.

Moreover, for example, when shifting the movable holding member 410 (the lenses G3, G4, and G5) toward a right-hand side from the pause state depicted in FIG. 62A, the first drive mechanism 420 is operated to generate drive force in the obliquely upward direction of the first direction (the direction of the straight line S4′), and the second drive mechanism 430 is operated to generate drive force in the obliquely downward direction of the second direction (the direction of the straight line S3′). As a result, as shown in FIG. 62C, the movable holding member 410 is moved toward the right-hand side of the direction of the straight line S2.

As described above, the movable holding member 410 is movably supported by the support mechanism (the three spheres 440), and it is two-dimensionally moved within the plane vertical to the optical axis L2 with respect to the base 400 in this state by the electromagnetic drive force generated by energization of the first coil 421 and the second coil 431 in cooperation with the first drive magnet 422 and the second drive magnet 432, thereby highly accurately correcting an image blur caused due to, e.g., hand movement.

Here, since the first coil 421 and the first return magnet 451 are aligned to extend in the same direction of the straight line S3 direction and the second coil 431 and the second return magnet 452 are aligned to extend in the same direction of the straight line S4 direction, force that prevents the movable holding member 410 from rotating on the optical axis L2, i.e., a large moment that suppresses the rotation can be obtained by the mutual function of the magnetic force of the return magnets 451 and 452 and the magnetic force of the drive magnet 422 and 432 at the time of driving (at the time of energizing the coils 421 and 431), and the movable holding member 410 can be rapidly moved within the plane vertical to the optical axis L2 and highly accurately positioned at a desired position.

In the foregoing embodiment, although the configuration that each of the first coil 421 and the second coil 431 is formed into the substantially elliptic annular shape has been described, this “substantially elliptic annular shape” is a concept including a substantially rectangular annular shape consisting of wide sides (major axes) and narrow sides (minor axes) including straight line portions besides the elliptic annular shape.

In the foregoing embodiment, although each of the first magnetic sensor 461 and the second magnetic sensor 462 consisting of the hall element has been described as the position detecting means, the present invention is not limited thereto, and any other magnetic sensor may be adopted.

In the foregoing embodiment, although the description has been given as to the example where the configuration that the three spheres 440 inserted in the concave portions 404 of the base 400 are provided to abut on the three abutting surfaces 416 of the movable holding member 410 is adopted as the support mechanism that supports the movable holding member, the present invention is not limited thereto, and a configuration that the plurality of abutting surfaces are provided on the base 400 and the plurality of concave portions that receive the spheres 440 are provided on the movable holding member may be adopted as a reverse pattern, and the present invention may be adopted in a configuration including any other support mechanism.

In the foregoing embodiment, although the example where the coils 421 and 431, the return magnets 451 and 452, and the magnetic sensors 461 and 462 are fixed to the base 400 (the base which is one of the base and the movable holding member) and the drive magnets 422 and 432 are fixed to the movable holding member 410 (the movable holding member which is the other of the base and the movable holding member) has been described, the present invention is not limited thereto, and a configuration that the coils, the return magnets, and the magnetic sensors are be fixed to the movable holding member (the movable holding member which is the other of the base and the movable holding member) and the drive magnets are fixed to the base (the base which is the one of the base and the movable holding member) may be adopted.

In the foregoing embodiment, although the example where the magnetic sensors (the first magnetic sensor 461 and the second magnetic sensor 462) constituting the position detecting means are fixed to the base 400 to face the drive magnets (the first drive magnet 422 and the second drive magnet 432) has been described, the present invention is not limited thereto, and the magnetic sensors may be fixed to the movable holding member 410 to face the return magnets (the first return magnet 451 and the second return magnet 452), the magnetic sensors may be fixed to the movable holding member to face the drive magnets (the first drive magnet and the second drive magnet) when the drive magnets (the first drive magnet and the second drive magnet) are fixed to the base, or the magnetic sensors may be fixed to the base to face the return magnets (the first return magnet and the second return magnet) when the return magnets (the first return magnet and the second return magnet) are fixed to the movable holding member.

In the foregoing embodiment, although the example where the magnets, i.e., the return magnets 451 and 452 are adopted as the return members constituting the return means has been described, the present invention is not limited thereto, and the return members consisting of metal plates or any other magnetic materials may be adopted as long as the mutual function based on magnetic force lines can be obtained.

In the foregoing embodiment, although the image blur correction device applied to the camera unit U mounted in a personal digital assistance has been described, a configuration including the image blur correction device having the above configuration may be adopted in an imaging lens unit including a plurality of lenses for imaging.

As a result, when the configuration where the plurality of lenses for imaging are arranged in the optical axis direction includes the above-described image blur correction device, the correction lenses held by the movable holding member are appropriately driven, and an image blur caused due to hand movement and others can be smoothly and highly accurately corrected. That is, the imaging lens unit having the image bur correcting function in addition to the plurality of lenses for imaging can be provided.

### INDUSTRIAL APPLICABILITY

As described above, since the image blur correction device according to the present invention can highly accurately correct an image blur caused due to hand movement and others and can automatically perform the return operation in the pause state while achieving, e.g., simplification of the structure and a reduction in size and thickness of the device in the optical axis direction of the lenses and the direction vertical to the optical axis direction, it can be of course applied to a camera unit mounted in a personal digital assistance such as a mobile phone and a portable music player that are demanded to be reduced in size and thickness, and it is also useful in a regular digital camera or any other, portable optical device.

1. An image blur correction device comprising:
a base having an opening portion;
a movable holding member configured to hold a lens;
a support mechanism configured to movably support the movable holding member within a plane vertical to an optical axis of the lens;
a driving means for driving the movable holding member within the plane vertical to the optical axis;
a position detecting means for detecting a position of the movable holding member; and
a return means for returning the movable holding member to a predetermined pause position in a pause state,
wherein the driving means includes a drive magnet fixed to one of the base and the movable holding member, and a coil fixed to an other of the base and the movable holding member at a position where the coil faces the drive magnet, and
the return means includes a return member that consists of a magnetic material or a magnet fixed to the other of the base and the movable holding member so as to face the drive magnet to form a magnetic force flow for returning to the pause position.

2. The image blur correction device according to claim 1, wherein the return member is a return magnet that faces the drive magnet and generates magnetic force for returning to the pause position, and
the position detecting means includes a magnetic sensor fixed to one of the base and the movable holding member at a position where the magnetic sensor faces the return magnet.

3. The image blur correction device according to claim 2, wherein the drive magnet includes a driving part facing the coil and a holding part that is formed with a thickness smaller than that of the driving part and faces the return magnet.

4. The image blur correction device according to claim 3, wherein a thin plate-like yoke is formed on a surface of the holding part of the drive magnet on a side where the drive magnet faces the return magnet.

5. The image blur correction device according to claim 2, wherein the driving means includes a first drive mechanism configured to drive the movable holding member in a first direction within the plane, and a second drive mechanism configured to drive the movable holding member in a second direction within the plane,
the first drive mechanism includes a first drive magnet fixed to the base, and a first coil fixed to the movable holding member at a position where the first coil faces the first drive magnet,
the second drive mechanism includes a second drive magnet fixed to the base, and a second coil fixed to the movable holing member at a position where the second coil faces the second drive magnet,
the return magnet includes a first return magnet that is fixed to the movable holding member so as to face the first drive magnet to generate magnetic force for returning to the pause position; and a second return magnet that is fixed to the movable holding member so as to face the second drive magnet to generate magnetic force for returning to the pause position, and
the magnetic sensor includes a first magnetic sensor fixed to the base at a position where the first magnetic sensor faces the first return magnet, and a second magnetic sensor fixed to the base at a position where the second magnetic sensor faces the second return magnet.

6. The image blur correction device according to claim 1, wherein the return member is arranged in such a manner that a center thereof substantially coincides with a center of the drive magnet as seen from an optical axis direction when the movable holding member is placed at the pause position.

7. The image blur correction device according to claim 6, wherein the return member is arranged to face the drive magnet to interpose the coil therebetween.

8. The image blur correction device according to claim 6, wherein the return member is a return magnet that faces the drive magnet and generates magnetic force for returning to the pause position, and
the position detecting means includes a magnetic sensor fixed to one of the base and the movable holding member at a position where the position detecting means faces the return magnet.

9. The image blur correction device according to claim 8, wherein the coil is formed into a substantially elliptic annular shape having a major axis and a minor axis as seen from the optical axis direction, and
the return magnet is formed into a substantially rectangular shape having a wide side and a narrow side as seen from the optical axis direction and arranged in such a manner that the wide side becomes substantially parallel to the major axis of the coil.

10. The image blur correction device according to claim 9, wherein the movable holding member is formed to define a cylindrical portion that holds the lens and two extending portions that extend from both sides with a predetermined width to sandwich the cylindrical portion,
the coil is arranged in such a manner that the major axis forms an inclination angle of approximately 45 degrees with respect to an alignment direction of the cylindrical portion and the extending portions, and
the return magnet is arranged in such a manner that the wide side forms an inclination angle of approximately 45 degrees with respect to the alignment direction of the cylindrical portion and the extending portions.

11. The image blur correction device according to claim 10, wherein the driving means includes a first drive mechanism configured to drive the movable holding member in a first direction within the plane, and a second drive mechanism configured to drive the movable holding member in a second direction within the plane,
the first drive mechanism includes a first drive magnet fixed to the base, and a first coil fixed to the movable holding member at a position where the first coil faces the first drive magnet,
the second drive mechanism includes a second drive magnet fixed to the base, and a second coil fixed to the movable holding member at a position where the second coil faces the second drive magnet,
the return magnet includes: a first return magnet arranged in such a manner that a center thereof substantially coincides with a center of the first drive magnet as seen from the optical axis direction, and a second return magnet arranged in such a manner that a center thereof substantially coincides with a center of the second drive magnet as seen from the optical axis direction, and
the magnetic sensor includes a first magnetic sensor fixed to the base at a position where the first magnetic sensor faces the first return magnet, and a second magnetic sensor fixed to the base at a position where the second magnetic sensor faces the second return magnet.

12. The image blur correction device according to claim 1, wherein the support mechanism includes a plurality of convex portions provided to one of the base and the movable holding member, and a plurality of abutting surfaces that are provided to the other of the base and the movable holding member and abut on the convex portions.

13. The image blur correction device according to claim 1, wherein the coil is fixed to the base,
the drive magnet is fixed to the movable holding member at a position where the drive magnet faces the coil, and
the return member is arranged to face the drive magnet to interpose the coil therebetween and fixed to the base.

14. The image blur correction device according to claim 13, wherein the position detecting means includes a magnetic sensor fixed to the base to face the drive magnet.

15. The image blur correction device according to claim 14, comprising a flexible wiring board electrically connected to the coil and the magnetic sensor,
wherein the flexible wiring board is arranged to be adjacent to the base on an opposite side of a side facing the movable holding member.

16. The image blur correction device according to claim 15, wherein the driving means includes a plate-like yoke adjacently arranged so as to bend and fix the flexible wiring, board.

17. The image blur correction device according to claim 14, wherein the driving means includes a first drive mechanism configured to drive the movable holding member in a first direction within the plane, and a second drive mechanism configured to drive the movable holding member in a second direction within the plane,
the coil includes a first coil included in the first drive mechanism, and a second coil included in the second drive mechanism,
the drive magnet includes a first drive magnet that is included in the first drive mechanism and faces the first coil, and a second drive magnet that is included in the second drive mechanism and faces the second coil,
the return member includes a first return magnet facing the first drive magnet; and a second return magnet facing the second drive magnet, and
the magnetic sensor includes a first magnetic sensor facing the first drive magnet, and a second magnetic sensor facing the second drive magnet.

18. The image blur correction device according to claim 1, wherein the coil is formed into an annular shape to define an air core portion, and
the return member is arranged in the air core portion of the coil.

19. The image blur correction device according to claim 18, wherein the driving means includes a first drive mechanism configured to drive the movable holding member in a first direction within the plane, and a second drive mechanism configured to drive the movable holding member in a second direction within the plane,
the coil includes a first coil included in the first drive mechanism, and a second coil included in the second drive mechanism,
the drive magnet includes a first drive magnet that is included in the first drive mechanism and faces the first coil, and a second drive magnet that is included in the second drive mechanism and faces the second coil, and
the return member includes a first return magnet arranged in an air core portion of the first coil, and a second return magnet arranged in an air core portion of the second coil.

20. The image blur correction device according to claim 19, wherein the position detecting means includes a magnetic sensor configured to output a position detection signal by relative movement of the magnetic sensor and a magnet,
the magnetic sensor includes a first magnetic sensor fixed to the base or the movable holding member to face the first drive magnet or the first return magnet, and a second magnetic sensor fixed to the base or the movable holding member to face the second drive magnet or the second return magnet.

21. The image blur correction device according to claim 19, wherein the first coil and the first return magnet are formed to extend in a direction vertical to the first direction within the plane, and
the second coil and the second return magnet are formed to extend in a direction vertical to the second direction within the plane.

22. An imaging lens unit including a plurality lenses for imaging,
wherein the imaging lens unit includes the image blur correction device according to claim 1.

23. A camera unit including an imaging element,
wherein the camera unit includes the image blur correction device according to claim 1.
